(19) United States
(12) Patent Application Publication
(10) Pub. No.: US 2026/0025831 A1
(43) Pub. Date: Jan. 22, 2026

(54) CONTROL INFORMATION FORMAT

(71) Applicant: QUALCOMM Incorporated, San Diego, CA (US)

(72) Inventors: Mostafa KHOSHNEVISAN, San Diego, CA (US); Yan ZHOU, San Diego, CA (US); Alberto RICO ALVARINO, San Diego, CA (US); Tao LUO, San Diego, CA (US); Jing JIANG, San Diego, CA (US); Jing SUN, San Diego, CA (US)

(21) Appl. No.: 18/780,342

(22) Filed: Jul. 22, 2024

(51) Int. Cl. H04W 72/231; H04L 1/00; H04W 68/02; H04W 72/12; H04W 74/0833

(52) U.S. Cl. CPC H04W 72/231; H04L 1/0003; H04L 1/0061; H04W 68/02; H04W 72/12; H04W 74/0833

(57) ABSTRACT

Aspects relate to formats for control information (e.g., downlink control information). A first control information format (e.g., a first downlink control information format) may be designated for a first initial access procedure associated with a system information radio network temporary identifier (SI-RNTI), a second initial access procedure associated with a paging network temporary identifier (P-RNTI), a third initial access procedure associated with a random access network temporary identifier (RA-RNTI), and a fourth initial access procedure associated with a temporary cell radio network temporary identifier (TC-RNTI). The first control information format may specify a smaller number of bits than a second control information format designated for connected mode procedures.

### TECHNICAL FIELD

The technology discussed below relates generally to wireless communication and, more particularly, to formats for communicating control information.

### INTRODUCTION

Next-generation wireless communication systems (e.g., 5GS) may include a 5G core network and a 5G radio access network (RAN), such as a New Radio (NR)-RAN. The NR-RAN supports communication via one or more cells. For example, a wireless communication device such as a user equipment (UE) may access a first cell of a first base station (BS) such as a gNB and/or access a second cell of a second base station.

A base station may schedule access to a cell to support access by multiple UEs. For example, a base station may allocate different resources (e.g., time domain and frequency domain resources) to be used by different UEs operating within the cell. Thus, each UE may transmit information to the base station via one or more of these resources and/or the base station may transmit information to one or more of the UEs via one or more of these resources.

### BRIEF SUMMARY OF SOME EXAMPLES

The following presents a summary of one or more aspects of the present disclosure in order to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In some examples, a first apparatus for communication may include a processing system. The processing system may be configured to obtain first control information (CI) formatted according to a first format. The first CI may include first scheduling information. The first format may be designated for: a first initial access procedure associated with a system information radio network temporary identifier (SI-RNTI), a second initial access procedure associated with a paging radio network temporary identifier (P-RNTI), a third initial access procedure associated with a random access radio network temporary identifier (RA-RNTI), and a fourth initial access procedure associated with a first temporary cell radio network temporary identifier (TC-RNTI). The processing system may also be configured to obtain first data according to the first scheduling information or output second data, for transmission, according to the first scheduling information.

In some examples, a method for communication at a first apparatus is disclosed. The method may include obtaining first control information (CI) formatted according to a first format. The first CI may include first scheduling information. The first format may be designated for: a first initial access procedure associated with a system information radio network temporary identifier (SI-RNTI), a second initial access procedure associated with a paging radio network temporary identifier (P-RNTI), a third initial access procedure associated with a random access radio network temporary identifier (RA-RNTI), and a fourth initial access procedure associated with a first temporary cell radio network temporary identifier (TC-RNTI). The method may also include obtaining first data according to the first scheduling information or outputting second data, for transmission, according to the first scheduling information.

In some examples, a first apparatus for communication may include means for obtaining first control information (CI) formatted according to a first format. The first CI may include first scheduling information. The first format may be designated for: a first initial access procedure associated with a system information radio network temporary identifier (SI-RNTI), a second initial access procedure associated with a paging radio network temporary identifier (P-RNTI), a third initial access procedure associated with a random access radio network temporary identifier (RA-RNTI), and a fourth initial access procedure associated with a first temporary cell radio network temporary identifier (TC-RNTI). The first apparatus may also include means for obtaining first data according to the first scheduling information or outputting second data, for transmission, according to the first scheduling information.

In some examples, a non-transitory computer-readable medium has stored therein instructions executable by a processing system of a first apparatus to obtain first control information (CI) formatted according to a first format. The first CI may include first scheduling information. The first format may be designated for: a first initial access procedure associated with a system information radio network temporary identifier (SI-RNTI), a second initial access procedure associated with a paging radio network temporary identifier (P-RNTI), a third initial access procedure associated with a random access radio network temporary identifier (RA-RNTI), and a fourth initial access procedure associated with a first temporary cell radio network temporary identifier (TC-RNTI). The computer-readable medium may also have stored therein instructions executable by the processing system of the first apparatus to obtain first data according to the first scheduling information or output second data, for transmission, according to the first scheduling information.

In some examples, a wireless node (e.g., a user equipment) may include one or more transceivers and a processing system. The processing system may be configured to obtain, via the one or more transceivers, first control information (CI) formatted according to a first format. The first CI may include first scheduling information. The first format may be designated for: a first initial access procedure associated with a system information radio network temporary identifier (SI-RNTI), a second initial access procedure associated with a paging radio network temporary identifier (P-RNTI), a third initial access procedure associated with a random access radio network temporary identifier (RA-RNTI), and a fourth initial access procedure associated with a first temporary cell radio network temporary identifier (TC-RNTI). The processing system may also be configured to obtain, via the one or more transceivers, first data according to the first scheduling information or output second data, for transmission via the one or more transceivers, according to the first scheduling information.

In some examples, a first apparatus for communication may include a processing system. The processing system may be configured to output, for transmission, first control information (CI) formatted according to a first format. The first CI may include first scheduling information. The first format may be designated for: a first initial access procedure associated with a system information radio network temporary identifier (SI-RNTI), a second initial access procedure associated with a paging radio network temporary identifier (P-RNTI), a third initial access procedure associated with a random access radio network temporary identifier (RA-RNTI), and a fourth initial access procedure associated with a first temporary cell radio network temporary identifier (TC-RNTI). The processing system may also be configured to output, for transmission, first data according to the first scheduling information, or obtain second data according to the first scheduling information.

In some examples, a method for communication at a first apparatus is disclosed. The method may include outputting, for transmission, first control information (CI) formatted according to a first format. The first CI may include first scheduling information. The first format may be designated for: a first initial access procedure associated with a system information radio network temporary identifier (SI-RNTI), a second initial access procedure associated with a paging radio network temporary identifier (P-RNTI), a third initial access procedure associated with a random access radio network temporary identifier (RA-RNTI), and a fourth initial access procedure associated with a first temporary cell radio network temporary identifier (TC-RNTI). The method may also include outputting, for transmission, first data according to the first scheduling information, or obtaining second data according to the first scheduling information.

In some examples, a first apparatus for communication may include means for outputting, for transmission, first control information (CI) formatted according to a first format. The first CI may include first scheduling information. The first format may be designated for: a first initial access procedure associated with a system information radio network temporary identifier (SI-RNTI), a second initial access procedure associated with a paging radio network temporary identifier (P-RNTI), a third initial access procedure associated with a random access radio network temporary identifier (RA-RNTI), and a fourth initial access procedure associated with a first temporary cell radio network temporary identifier (TC-RNTI). The first apparatus may also include means for outputting, for transmission, first data according to the first scheduling information, or obtaining second data according to the first scheduling information.

In some examples, a non-transitory computer-readable medium has stored therein instructions executable by a processing system of a first apparatus to output, for transmission, first control information (CI) formatted according to a first format. The first CI may include first scheduling information. The first format may be designated for: a first initial access procedure associated with a system information radio network temporary identifier (SI-RNTI), a second initial access procedure associated with a paging radio network temporary identifier (P-RNTI), a third initial access procedure associated with a random access radio network temporary identifier (RA-RNTI), and a fourth initial access procedure associated with a first temporary cell radio network temporary identifier (TC-RNTI). The computer-readable medium may also have stored therein instructions executable by the processing system of the first apparatus to output, for transmission, first data according to the first scheduling information, or obtain second data according to the first scheduling information.

In some examples, a wireless node (e.g., a network entity) may include one or more transceivers and a processing system. The processing system may be configured to output, for transmission via the one or more transceivers, first control information (CI) formatted according to a first format. The first CI may include first scheduling information. The first format may be designated for: a first initial access procedure associated with a system information radio network temporary identifier (SI-RNTI), a second initial access procedure associated with a paging radio network temporary identifier (P-RNTI), a third initial access procedure associated with a random access radio network temporary identifier (RA-RNTI), and a fourth initial access procedure associated with a first temporary cell radio network temporary identifier (TC-RNTI). The processing system may also be configured to output, for transmission via the one or more transceivers, first data according to the first scheduling information, or obtain, via the one or more transceivers, second data according to the first scheduling information.

These and other aspects of the disclosure will become more fully understood upon a review of the detailed description which follows. Other aspects, features, and examples of the present disclosure will become apparent to those of ordinary skill in the art, upon reviewing the following description of specific, example aspects of the present disclosure in conjunction with the accompanying figures. While features of the present disclosure may be discussed relative to certain examples and figures below, all examples of the present disclosure can include one or more of the advantageous features discussed herein. In other words, while one or more examples may be discussed as having certain advantageous features, one or more of such features may also be used in accordance with the various examples of the disclosure discussed herein. In similar fashion, while example aspects may be discussed below as device, system, or method examples it should be understood that such example aspects can be implemented in various devices, systems, and methods.

### BRIEF DESCRIPTION OF THE DRAWINGS

FIG. 1 is a schematic illustration of a wireless communication system according to some aspects.

FIG. 2 is a conceptual illustration of an example of a radio access network according to some aspects.

FIG. 3 is a schematic illustration of an example of an apparatus for communication according to some aspects.

FIG. 4 is a diagram providing a high-level illustration of one example of a configuration of a disaggregated base station according to some aspects.

FIG. 5 is a schematic illustration of wireless resources in an air interface utilizing orthogonal frequency divisional multiplexing (OFDM) according to some aspects.

FIG. 6A is a diagram illustrating an example of a frame structure of synchronization signals for use in a wireless communication network according to some aspects.

FIG. 6B is a diagram illustrating an example of a portion of a frame or subframe structure with various channels and associated messages for use in a wireless communication network according to some aspects.

FIG. 7 is a signaling diagram of an example of random access (RACH) related signaling according to some aspects.

FIG. 8 is a schematic illustration of an example of a downlink control region of a slot according to some aspects.

FIG. 9 is a schematic illustration of an example of a control channel element structure according to some aspects.

FIG. 10 is a schematic illustration of an example of downlink time-frequency resources according to some aspects.

FIG. 11 is a signaling diagram illustrating an example of signaling associated with scheduling an uplink transmission according to some aspects.

FIG. 12 is a signaling diagram illustrating an example of signaling associated with scheduling a downlink transmission according to some aspects.

FIG. 13 is a signaling diagram illustrating an example of downlink control information (DCI) related signaling according to some aspects.

FIG. 14 is a diagram illustrating an example of indicating a time domain resource allocation (TDRA) according to some aspects.

FIG. 15 is a signaling diagram illustrating an example of SI-related signaling with TDRA compression according to some aspects.

FIG. 16 is a signaling diagram illustrating an example of SI-related signaling with SI indicator compression according to some aspects.

FIG. 17 is a signaling diagram illustrating an example of SI-related signaling with code rate and redundancy vector (RV) compression according to some aspects.

FIG. 18 is a signaling diagram illustrating an example of paging-related signaling with short message compression according to some aspects.

FIG. 19 is a signaling diagram illustrating an example of paging or random access related signaling with modulation and coding scheme (MCS) compression according to some aspects.

FIG. 20 is a signaling diagram illustrating an example of random access related signaling with modulation and coding scheme (MCS) compression according to some aspects.

FIG. 21 is a block diagram conceptually illustrating an example of a hardware implementation for an apparatus (e.g., a user equipment) employing a processing system according to some aspects.

FIG. 22 is a flow chart illustrating an example communication method involving a compact DCI format for initial access according to some aspects.

FIG. 23 is a block diagram conceptually illustrating an example of a hardware implementation for an apparatus (e.g., a network entity) employing a processing system according to some aspects.

FIG. 24 is a flow chart illustrating an example communication method involving a compact DCI format for initial access according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While aspects and examples are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip examples and other non-module-component based devices (e.g., end-user devices, vehicles, communication devices, computing devices, industrial equipment, retail/purchasing devices, medical devices, artificial intelligence-enabled (AI-enabled) devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described examples. For example, transmission and reception of wireless signals necessarily includes a number of components for analog and digital purposes (e.g., hardware components including antenna, radio frequency (RF) chains, power amplifiers, modulators, buffer, processor(s), interleaver, adders/summers, etc.). It is intended that innovations described herein may be practiced in a wide variety of devices, chip-level components, systems, distributed arrangements, disaggregated arrangements (e.g., base station and/or UE), end-user devices, etc., of varying sizes, shapes, and constitution.

The disclosure relates in some aspects to formats for control information. A first control information format designated for initial access may specify a smaller number of bits than a second control information format designated for connected mode. For example, the first control information format may be used for sending approximately 30 or 40 bits of control information, while the second control information format may be used for sending approximately 60 bits (e.g., 61 bits) of control information.

In some examples, the first control information format is a compact format for broadcasting DCI with reduced size (approximately 30 bits including a cyclic redundancy check (CRC), with reduced CRC length) for at least a system information radio network temporary identifier (SI-RNTI), a paging network temporary identifier (P-RNTI), and a random access network temporary identifier (RA-RNTI). The DCI for the above RTNIs is a downlink DL DCI (DCI format 1_0) in 3GPP New Radio (NR).

In some examples, the first control information format is a compact format for broadcasting DCI with reduced size (approximately 30 or 40 bits including CRC, with reduced CRC length) for at least SI-RNTI, P-RNTI, RA-RNTI, and a temporary cell radio network temporary identifier (TC-RNTI). For example, a first DCI format may be designated for a first initial access procedure associated with SI-RNTI, a second initial access procedure associated with P-RNTI, a third initial access procedure associated with RA-RNTI, and a fourth initial access procedure associated with TC-RNTI.

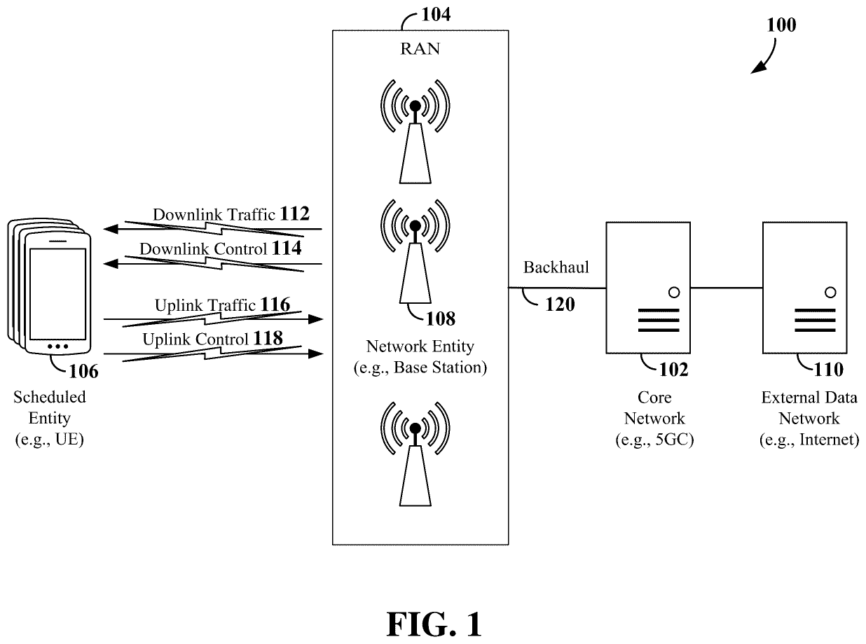

The various concepts presented throughout this disclosure may be implemented across a broad variety of telecommunication systems, network architectures, and communication standards. Referring now to FIG. 1, as an illustrative example without limitation, various aspects of the present disclosure are illustrated with reference to a wireless communication system 100. The wireless communication system 100 includes three interacting domains: a core network 102, a radio access network (RAN) 104, and a user equipment (UE) 106. By virtue of the wireless communication system 100, the UE 106 may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3rd Generation Partnership Project (3GPP) New Radio (NR) specifications, often referred to as 5G. As another example, the RAN 104 may operate under a hybrid of 5G NR and Evolved Universal Terrestrial Radio Access Network (CUTRAN) standards, often referred to as Long-Term Evolution (LTE). The 3GPP refers to this hybrid RAN as a next-generation RAN, or NG-RAN. In another example, the RAN 104 may operate according to both the LTE and 5G NR standards. Of course, many other examples may be utilized within the scope of the present disclosure.

As illustrated, the RAN 104 includes a plurality of network entities (e.g., base stations 108). Broadly, a network entity (e.g., base station) is a network element in a radio access network responsible for radio transmission and reception in one or more cells to or from a UE. In different technologies, standards, or contexts, a network entity (e.g., base station) may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (cNB), a gNode B (gNB), a transmission and reception point (TRP), or some other suitable terminology. In some examples, a network entity (e.g., base station) may include two or more TRPs that may be collocated or non-collocated. Each TRP may communicate on the same or different carrier frequency within the same or different frequency band. In examples where the RAN 104 operates according to both the LTE and 5G NR standards, one of the network entities (e.g., base stations 108) may be an LTE base station, while another network entity (e.g., base station) may be a 5G NR base station.

The radio access network 104 is further illustrated supporting wireless communication for multiple mobile apparatuses. A mobile apparatus may be referred to as user equipment (UE) 106 in 3GPP standards. A mobile apparatus (e.g., UE) may be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE 106 may be an apparatus that provides a user with access to network services. In examples where the RAN 104 operates according to both the LTE and 5G NR standards, the UE 106 may be an Evolved-Universal Terrestrial Radio Access Network-New Radio dual connectivity (EN-DC) UE that is capable of simultaneously connecting to an LTE base station and an NR base station to receive data packets from both the LTE base station and the NR base station.

Within the present document, a mobile apparatus (e.g., UE) need not necessarily have a capability to move, and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors, etc., electrically coupled to each other. For example, some non-limiting examples of a mobile apparatus (e.g., UE) include a mobile, a cellular (cell) phone, a smart phone, a session initiation protocol (SIP) phone, a laptop, a personal computer (PC), a notebook, a netbook, a smartbook, a tablet, a personal digital assistant (PDA), a vehicle (e.g., an automobile, a bus, etc.) and a broad array of embedded systems, e.g., corresponding to an Internet of Things (IoT).

A mobile apparatus (e.g., UE) may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus (e.g., UE) may additionally be a digital home or smart home device such as a home audio, video, and/or multimedia device, an appliance, a vending machine, intelligent lighting, a home security system, a smart meter, etc. A mobile apparatus (e.g., UE) may additionally be a smart energy device, a security device, a solar panel or solar array, a municipal infrastructure device controlling electric power (e.g., a smart grid), lighting, water, etc., an industrial automation and enterprise device, a logistics controller, agricultural equipment, etc. Still further, a mobile apparatus (e.g., UE) may provide for connected medicine or telemedicine support, i.e., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between a RAN 104 and a UE 106 may be described as utilizing an air interface. Transmissions over the air interface from a base station (e.g., base station 108) to one or more UEs (e.g., UE 106) may be referred to as downlink (DL) transmission. In some examples, the term downlink may refer to a point-to-multipoint transmission originating at a base station (e.g., base station 108). Another way to describe this point-to-multipoint transmission scheme may be to use the term broadcast channel multiplexing. Transmissions from a UE (e.g., UE 106) to a base station (e.g., base station 108) may be referred to as uplink (UL) transmissions. In some examples, the term uplink may refer to a point-to-point transmission originating at a UE (e.g., UE 106).

In some examples, access to the air interface may be scheduled, wherein a scheduling entity (e.g., a base station 108) of some other type of network entity allocates resources for communication among some or all devices and equipment within its service area or cell. Within the present disclosure, as discussed further below, the scheduling entity may be responsible for scheduling, assigning, reconfiguring, and releasing resources for one or more scheduled entities (e.g., UEs). That is, for scheduled communication, a plurality of UEs 106, which may be scheduled entities, may utilize resources allocated by a scheduling entity (e.g., a base station 108).

Base stations 108 are not the only entities that may function as scheduling entities. That is, in some examples, a UE may function as a scheduling entity, scheduling resources for one or more scheduled entities (e.g., one or more other UEs). For example, UEs may communicate with other UEs in a peer-to-peer or device-to-device fashion and/or in a relay configuration.

As illustrated in FIG. 1, a scheduling entity (e.g., a base station 108) may broadcast downlink traffic 112 to one or more scheduled entities (e.g., a UE 106). Broadly, the scheduling entity is a node or device responsible for scheduling traffic in a wireless communication network, including the downlink traffic 112 and, in some examples, uplink traffic 116 and/or uplink control information 118 from one or more scheduled entities to the scheduling entity. On the other hand, the scheduled entity is a node or device that receives downlink control information 114, including but not limited to scheduling information (e.g., a grant), synchronization or timing information, or other control information from another entity in the wireless communication network such as the scheduling entity.

In addition, the uplink control information 118, downlink control information 114, downlink traffic 112, and/or uplink traffic 116 may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols in some examples. A subframe may refer to a duration of 1 millisecond (ms). Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

In general, base stations 108 may include a backhaul interface for communication with a backhaul 120 of the wireless communication system. The backhaul 120 may provide a link between a base station 108 and the core network 102. Further, in some examples, a backhaul network may provide interconnection between the respective base stations 108. Various types of backhaul interfaces may be employed, such as a direct physical connection, a virtual network, or the like using any suitable transport network.

The core network 102 may be a part of the wireless communication system 100, and may be independent of the radio access technology used in the RAN 104. In some examples, the core network 102 may be configured according to 5G standards (e.g., 5GC). In other examples, the core network 102 may be configured according to a 4G evolved packet core (EPC), or any other suitable standard or configuration.

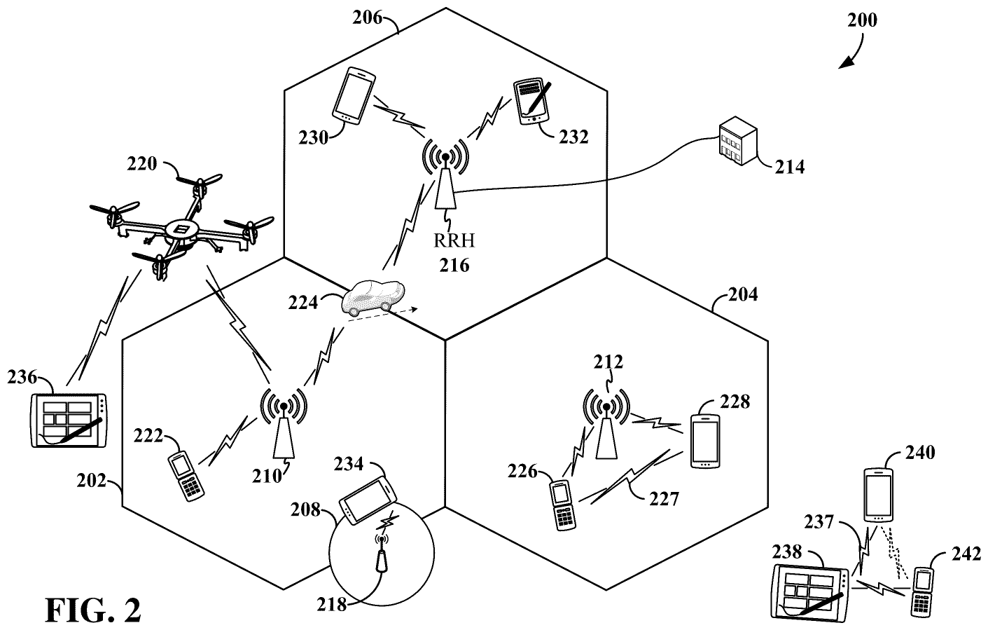

Referring now to FIG. 2, by way of example and without limitation, a schematic illustration of a radio access network (RAN) 200 is provided. In some examples, the RAN 200 may be the same as the RAN 104 described above and illustrated in FIG. 1.

The geographic area covered by the RAN 200 may be divided into cellular regions (cells) that can be uniquely identified by a user equipment (UE) based on an identification broadcasted from one access point or base station. FIG. 2 illustrates cells 202, 204, 206, and 208, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

Various base station arrangements can be utilized. For example, in FIG. 2, two base stations 210 and 212 are shown in cells 202 and 204; and a base station 214 is shown controlling a remote radio head (RRH) 216 in cell 206. That is, a base station can have an integrated antenna or can be connected to an antenna or RRH by feeder cables. In the illustrated example, the cells 202, 204, and 206 may be referred to as macrocells, as the base stations 210, 212, and 214 support cells having a large size. Further, a base station 218 is shown in the cell 208, which may overlap with one or more macrocells. In this example, the cell 208 may be referred to as a small cell (e.g., a microcell, picocell, femtocell, home base station, home Node B, home eNode B, etc.), as the base station 218 supports a cell having a relatively small size. Cell sizing can be done according to system design as well as component constraints.

It is to be understood that the RAN 200 may include any number of wireless base stations and cells. Further, a relay node may be deployed to extend the size or coverage area of a given cell. The base stations 210, 212, 214, 218 provide wireless access points to a core network for any number of mobile apparatuses. In some examples, the base stations 210, 212, 214, and/or 218 may be the same as the base station/scheduling entity described above and illustrated in FIG. 1.

FIG. 2 further includes an unmanned aerial vehicle (UAV) 220, which may be a drone or quadcopter. The UAV 220 may be configured to function as a base station, or more specifically as a mobile base station. That is, in some examples, a cell may not necessarily be stationary, and the geographic area of the cell may move according to the location of a mobile base station, such as the UAV 220.

Within the RAN 200, the cells may include UEs that may be in communication with one or more sectors of each cell. Further, each base station 210, 212, 214, and 218 may be configured to provide an access point to a core network 102 (see FIG. 1) for all the UEs in the respective cells. For example, UEs 222 and 224 may be in communication with base station 210; UEs 226 and 228 may be in communication with base station 212; UEs 230 and 232 may be in communication with base station 214 by way of RRH 216; and UE 234 may be in communication with base station 218. In some examples, the UEs 222, 224, 226, 228, 230, 232, 234, 236, 238, 240, and/or 242 may be the same as the UE/scheduled entity described above and illustrated in FIG. 1. In some examples, the UAV 220 (e.g., the quadcopter) can be a mobile network node and may be configured to function as a UE. For example, the UAV 220 may operate within cell 202 by communicating with base station 210.

In a further aspect of the RAN 200, sidelink signals may be used between UEs without necessarily relying on scheduling or control information from a base station. Sidelink communication may be utilized, for example, in a device-to-device (D2D) network, peer-to-peer (P2P) network, vehicle-to-vehicle (V2V) network, vehicle-to-everything (V2X) network, and/or other suitable sidelink network. For example, two or more UEs (e.g., UEs 238, 240, and 242) may communicate with each other using sidelink signals 237 without relaying that communication through a base station. In some examples, the UEs 238, 240, and 242 may each function as a scheduling entity or transmitting sidelink device and/or a scheduled entity or a receiving sidelink device to schedule resources and communicate sidelink signals 237 therebetween without relying on scheduling or control information from a base station. In other examples, two or more UEs (e.g., UEs 226 and 228) within the coverage area of a base station (e.g., base station 212) may also communicate sidelink signals 227 over a direct link (sidelink) without conveying that communication through the base station 212. In this example, the base station 212 may allocate resources to the UEs 226 and 228 for the sidelink communication.

In the RAN 200, the ability for a UE to communicate while moving, independent of its location, is referred to as mobility. The various physical channels between the UE and the radio access network are generally set up, maintained, and released under the control of an access and mobility management function (AMF, not illustrated, part of the core network 102 in FIG. 1), which may include a security context management function (SCMF) that manages the security context for both the control plane and the user plane functionality, and a security anchor function (SEAF) that performs authentication.

A RAN 200 may utilize DL-based mobility or UL-based mobility to enable mobility and handovers (i.e., the transfer of a UE's connection from one radio channel to another). In a network configured for DL-based mobility, during a call with a scheduling entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE may undertake a handoff or handover from the serving cell to the neighboring (target) cell. For example, UE 224 (illustrated as a vehicle, although any suitable form of UE may be used) may move from the geographic area corresponding to its serving cell (e.g., the cell 202) to the geographic area corresponding to a neighbor cell (e.g., the cell 206). When the signal strength or quality from the neighbor cell exceeds that of the serving cell for a given amount of time, the UE 224 may transmit a reporting message to its serving base station (e.g., the base station 210) indicating this condition. In response, the UE 224 may receive a handover command, and the UE may undergo a handover to the cell 206.

In a network configured for UL-based mobility, UL reference signals from each UE may be utilized by the network to select a serving cell for each UE. In some examples, the base stations 210, 212, and 214/216 may broadcast unified synchronization signals (e.g., unified Primary Synchronization Signals (PSSs), unified Secondary Synchronization Signals (SSSs) and unified Physical Broadcast Channels (PBCH)). The UEs 222, 224, 226, 228, 230, and 232 may receive the unified synchronization signals, derive the carrier frequency and slot timing from the synchronization signals, and in response to deriving timing, transmit an uplink pilot or reference signal. The uplink pilot signal transmitted by a UE (e.g., UE 224) may be concurrently received by two or more cells (e.g., base stations 210 and 214/216) within the RAN 200. Each of the cells may measure a strength of the pilot signal, and the radio access network (e.g., one or more of the base stations 210 and 214/216 and/or a central node within the core network) may determine a serving cell for the UE 224. As the UE 224 moves through the RAN 200, the network may continue to monitor the uplink pilot signal transmitted by the UE 224. When the signal strength or quality of the pilot signal measured by a neighboring cell exceeds that of the signal strength or quality measured by the serving cell, the RAN 200 may handover the UE 224 from the serving cell to the neighboring cell, with or without informing the UE 224.

Although the synchronization signal transmitted by the base stations 210, 212, and 214/216 may be unified, the synchronization signal may not identify a particular cell, but rather may identify a zone of multiple cells operating on the same frequency and/or with the same timing. The use of zones in 5G networks or other next generation communication networks enables the uplink-based mobility framework and improves the efficiency of both the UE and the network, since the number of mobility messages that need to be exchanged between the UE and the network may be reduced.

In various implementations, the air interface in the RAN 200 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without the need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple radio access technologies (RATs). For example, the holder of a license for a portion of licensed spectrum may provide licensed shared access (LSA) to share that spectrum with other parties, e.g., with suitable licensee-determined conditions to gain access.

The air interface in the RAN 200 may utilize one or more multiplexing and multiple access algorithms to enable simultaneous communication of the various devices. For example, 5G NR specifications provide multiple access for UL transmissions from UEs 222 and 224 to base station 210, and for multiplexing for DL transmissions from base station 210 to one or more UEs 222 and 224, utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 210 to UEs 222 and 224 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

The air interface in the RAN 200 may further utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancelation technologies. Full-duplex emulation is frequently implemented for wireless links by utilizing frequency division duplex (FDD) or spatial division duplex (SDD). In FDD, transmissions in different directions operate at different carrier frequencies. In SDD, transmissions in different directions on a given channel are separate from one another using spatial division multiplexing (SDM). In other examples, full-duplex communication may be implemented within unpaired spectrum (e.g., within a single carrier bandwidth), where transmissions in different directions occur within different sub-bands of the carrier bandwidth. This type of full-duplex communication may be referred to as sub-band full-duplex (SBFD), cross-division duplex (xDD), or flexible duplex.

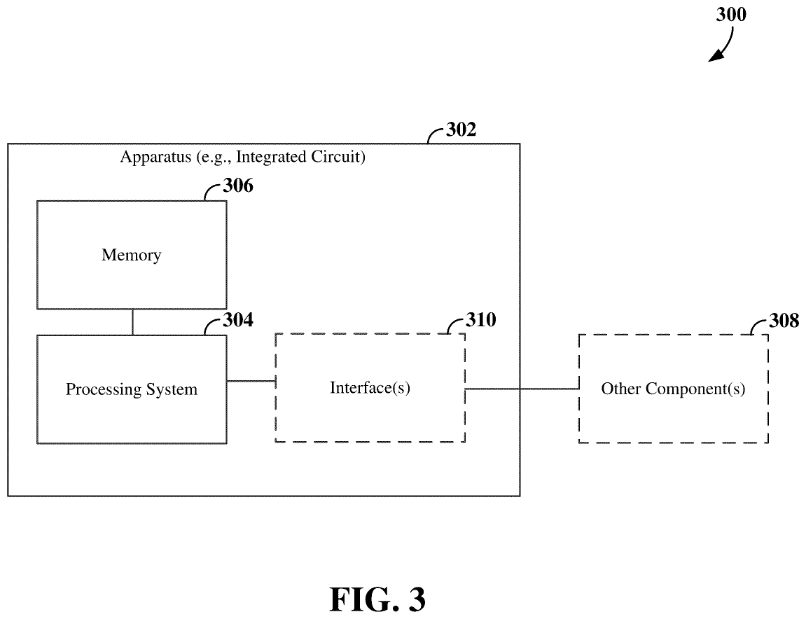

FIG. 3 illustrates an example apparatus 300 according to certain aspects of the disclosure. In some examples, the apparatus 300 may be a network entity (e.g., a BS), a UE, or some other type of wireless node (e.g., a node that utilizes wireless spectrum (e.g., a particular RF spectrum) to communicate with another node or entity). In some examples, the apparatus 300 may correspond to any of the apparatuses, UEs, scheduled entities, network entities, base stations (e.g., gNBs), scheduling entities, DUs, CUs, RAN nodes, or CN entities shown in any of FIGS. 1, 2, 4, 7, 11, 12, 13, 15, 16, 17, 18, 19, 20, 21, and 23.

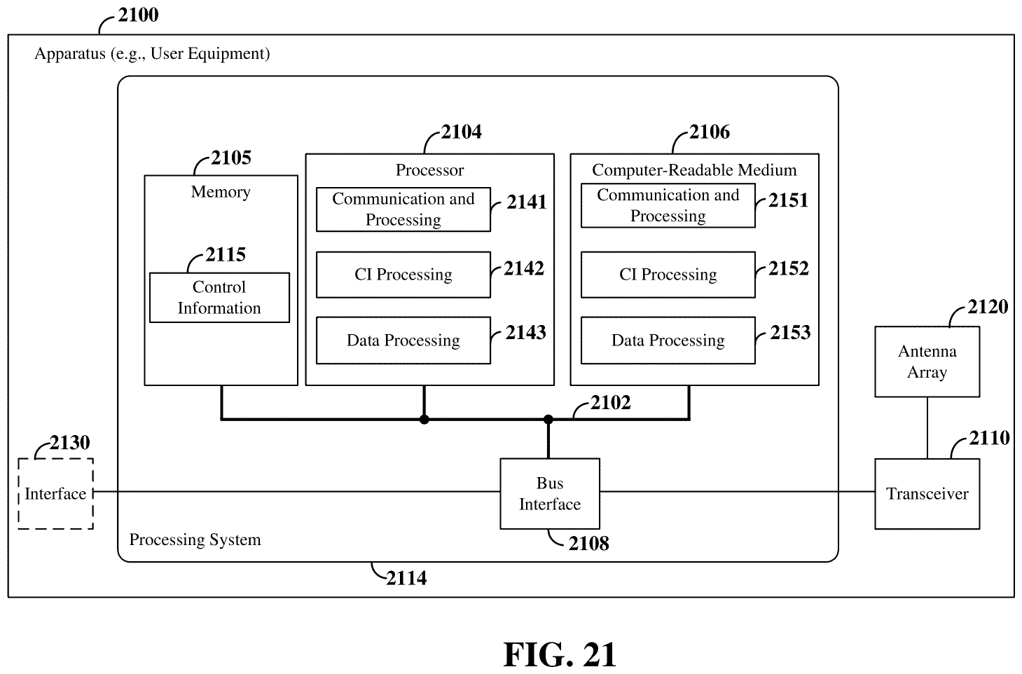

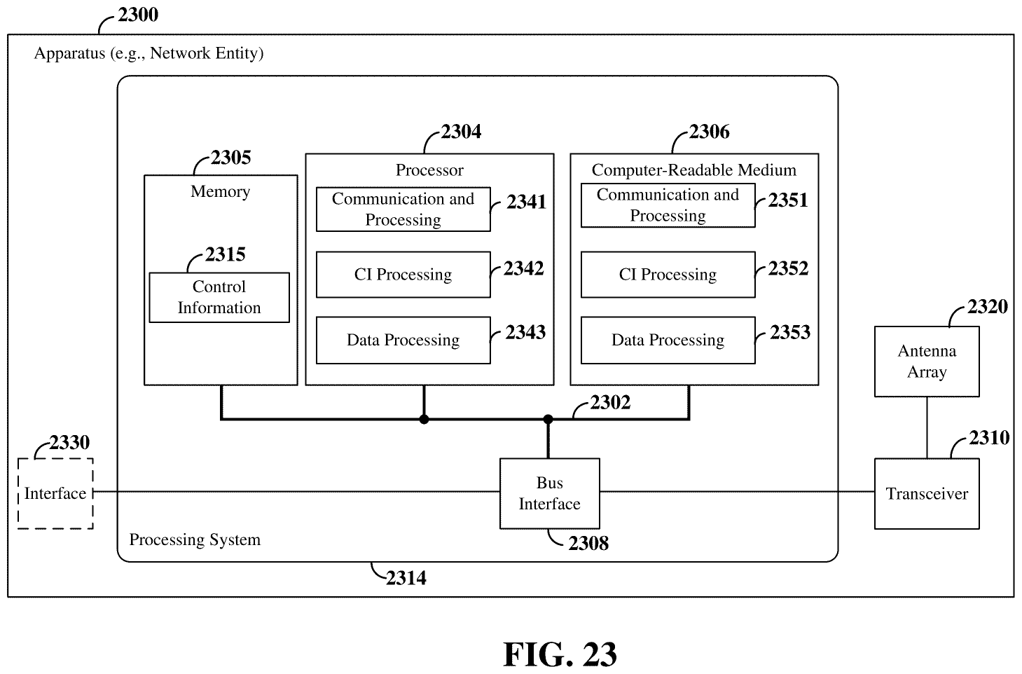

The apparatus 300 includes an apparatus 302 (e.g., an integrated circuit) and, optionally, at least one other component 308. In some aspects, the apparatus 302 may be configured to operate in a wireless communication device (e.g., a UE, a BS, etc.) and to perform one or more of the operations described herein. The apparatus 302 includes a processing system 304 (e.g., including one or more processors), and a memory 306 (e.g., representative of one or more memories) coupled to the processing system 304. Example implementations of the processing system 304 are provided herein. In some examples, the processing system 304 of FIG. 3 may correspond to the processing system 2114 of FIG. 21. In some examples, the processing system 304 of FIG. 3 may correspond to the processing system 2314 of FIG. 23.

The processing system 304 is generally adapted for processing, including the execution of programming (e.g., processor-executable code) stored on the memory 306. For example, the memory 306 may store instructions that, when executed by the processing system 304, cause the processing system 304 to perform one or more of the operations described herein.

In some implementations, the apparatus 302 communicates with at least one other component (e.g., a component 308 external to the apparatus 302) of the apparatus 300. To this end, in some implementations, the apparatus 302 may include at least one interface 310 (e.g., a send and/or receive interface) coupled to the processing system 304 for outputting and/or obtaining (e.g., sending and/or receiving) information (e.g., received information, generated information, decoded information, messages, etc.) between the processing system 304 and the other component(s) 308. In some implementations, the interface 310 may include an interface bus, bus drivers, bus receivers, buffers, other suitable circuitry, or a combination thereof. In some implementations, the interface 310 may include radio frequency (RF) circuitry (e.g., an RF transmitter and/or an RF receiver). In some implementations, the interface 310 may be configured to interface the apparatus 302 to one or more other components of the apparatus 300 (other components not shown in FIG. 3). For example, the interface 310 may be configured to interface the processing system 304 to a radio frequency (RF) front end (e.g., an RF transmitter and/or an RF receiver).

The apparatus 302 may communicate with other apparatuses in various ways. In cases where the apparatus 302 includes an RF transceiver (not shown in FIG. 3), the apparatus may transmit and receive information (e.g., a frame, a message, bits, etc.) via RF signaling. In some cases, rather than transmitting information via RF signaling, the apparatus 302 may have an interface to provide (e.g., output, send, transmit, etc.) information for RF transmission. For example, the processing system 304 may output information, via a bus interface, to an RF front end for RF transmission. Similarly, rather than receiving information via RF signaling, the apparatus 302 may have an interface to obtain information that is received by another apparatus. For example, the processing system 304 may obtain (e.g., receive) information, via a bus interface, from an RF receiver that received the information via RF signaling. In some implementations, an interface may include multiple interfaces. For example, a bidirectional interface may include a first interface for obtaining and a second interface for outputting.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (cNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CUs, the DUs, and the RUs also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

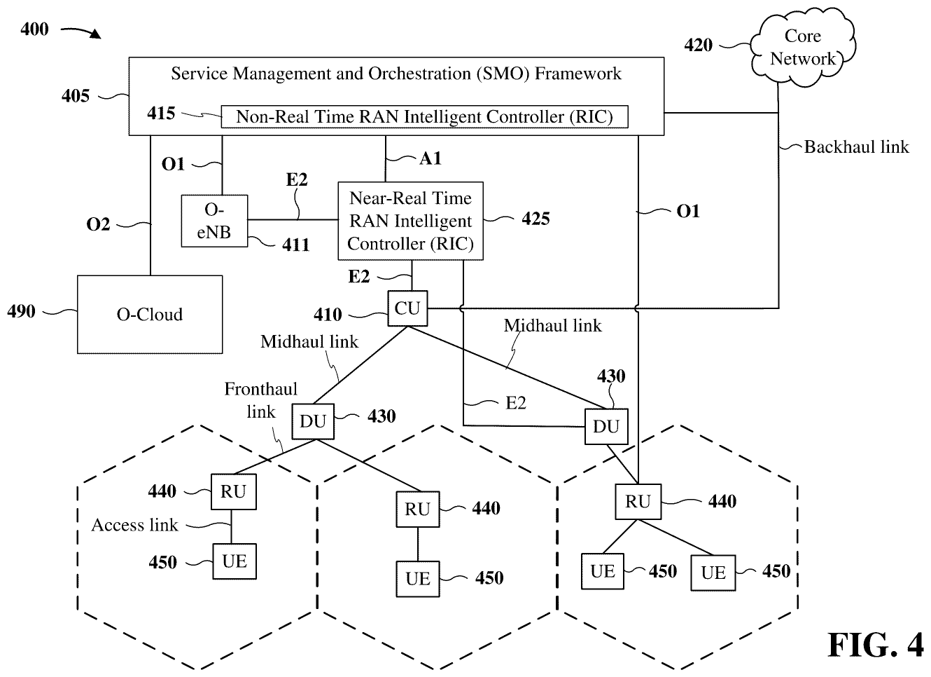

FIG. 4 shows a diagram illustrating an example disaggregated base station 400 architecture. The disaggregated base station 400 architecture may include one or more central units (CUs) 410 that can communicate directly with a core network 420 via a backhaul link, or indirectly with the core network 420 through one or more disaggregated base station units (such as a Near-Real Time (Near-RT) RAN Intelligent Controller (RIC) 425 via an E2 link, or a Non-Real Time (Non-RT) RIC 415 associated with a Service Management and Orchestration (SMO) Framework 405, or both). A CU 410 may communicate with one or more distributed units (DUs) 430 via respective midhaul links, such as an F1 interface. The DUs 430 may communicate with one or more radio units (RUs) 440 via respective fronthaul links. The RUs 440 may communicate with respective UEs 450 via one or more radio frequency (RF) access links. In some implementations, the UE 450 may be simultaneously served by multiple RUs 440.

Each of the units, i.e., the CUS 410, the DUs 430, the RUs 440, as well as the Near-RT RICs 425, the Non-RT RICs 415 and the SMO Framework 405, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 410 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 410. The CU 410 may be configured to handle user plane functionality (i.e., Central Unit-User Plane (CU-UP)), control plane functionality (i.e., Central Unit-Control Plane (CU-CP)), or a combination thereof. In some implementations, the CU 410 can be logically split into one or more CU-UP units and one or more CU-CP units. The CU-UP unit can communicate bidirectionally with the CU-CP unit via an interface, such as the E1 interface when implemented in an O-RAN configuration. The CU 410 can be implemented to communicate with the distributed unit (DU) 430, as necessary, for network control and signaling.

The DU 430 may correspond to a logical unit that includes one or more base station functions to control the operation of one or more RUs 440. In some aspects, the DU 430 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 430 may further host one or more low PHY layers. Each layer (or module) can be implemented with an interface configured to communicate signals with other layers (and modules) hosted by the DU 430, or with the control functions hosted by the CU 410.

Lower-layer functionality can be implemented by one or more RUs 440. In some deployments, an RU 440, controlled by a DU 430, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 440 can be implemented to handle over the air (OTA) communication with one or more UEs 450. In some implementations, real-time and non-real-time aspects of control and user plane communication with the RU(s) 440 can be controlled by the corresponding DU 430. In some scenarios, this configuration can enable the DU(s) 430 and the CU 410 to be implemented in a cloud-based RAN architecture, such as a vRAN architecture.

The SMO Framework 405 may be configured to support RAN deployment and provisioning of non-virtualized and virtualized network elements. For non-virtualized network elements, the SMO Framework 405 may be configured to support the deployment of dedicated physical resources for RAN coverage requirements which may be managed via an operations and maintenance interface (such as an O1 interface). For virtualized network elements, the SMO Framework 405 may be configured to interact with a cloud computing platform (such as an open cloud (O-Cloud) 490) to perform network element life cycle management (such as to instantiate virtualized network elements) via a cloud computing platform interface (such as an O2 interface). Such virtualized network elements can include, but are not limited to, CUs 410, DUs 430, RUS 440 and Near-RT RICs 425. In some implementations, the SMO Framework 405 can communicate with a hardware aspect of a 4G RAN, such as an open eNB (O-cNB) 411, via an O1 interface. Additionally, in some implementations, the SMO Framework 405 can communicate directly with one or more RUs 440 via an O1 interface. The SMO Framework 405 also may include a Non-RT RIC 415 configured to support functionality of the SMO Framework 405.

The Non-RT RIC 415 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 425. The Non-RT RIC 415 may be coupled to or communicate with (such as via an A1 interface) the Near-RT RIC 425. The Near-RT RIC 425 may be configured to include a logical function that enables near-real-time control and optimization of RAN elements and resources via data collection and actions over an interface (such as via an E2 interface) connecting one or more CUs 410, one or more DUs 430, or both, as well as an O-cNB, with the Near-RT RIC 425.

In some implementations, to generate AI/ML models to be deployed in the Near-RT RIC 425, the Non-RT RIC 415 may receive parameters or external enrichment information from external servers. Such information may be utilized by the Near-RT RIC 425 and may be received at the SMO Framework 405 or the Non-RT RIC 415 from non-network data sources or from network functions. In some examples, the Non-RT RIC 415 or the Near-RT RIC 425 may be configured to tune RAN behavior or performance. For example, the Non-RT RIC 415 may monitor long-term trends and patterns for performance and employ AI/ML models to perform corrective actions through the SMO Framework 405 (such as reconfiguration via O1) or via creation of RAN management policies (such as A1 policies).

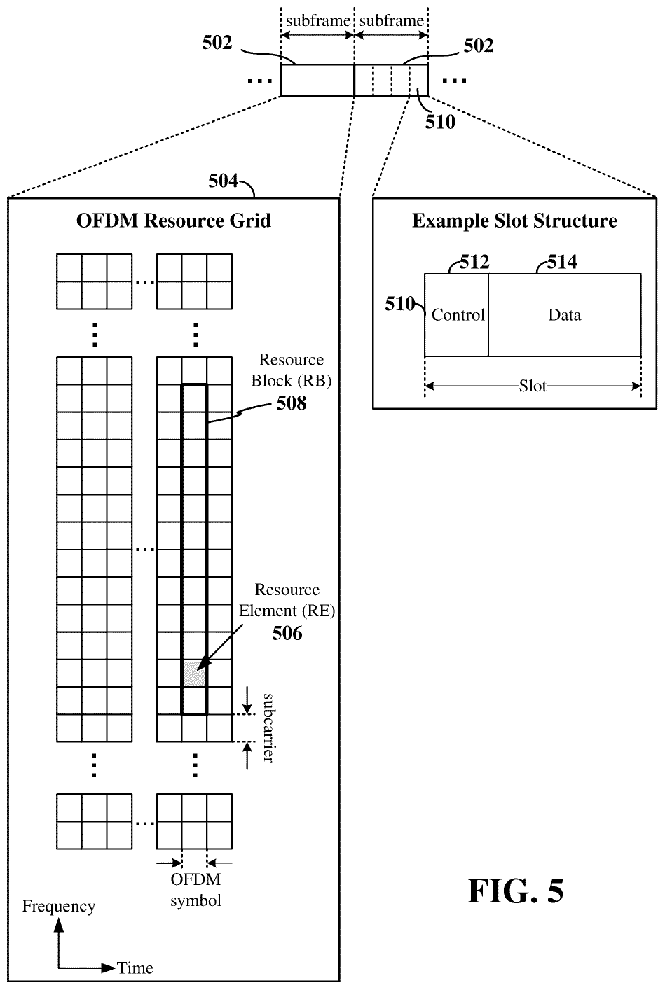

Various aspects of the present disclosure will be described with reference to an OFDM waveform, an example of which is schematically illustrated in FIG. 5. It should be understood by those of ordinary skill in the art that the various aspects of the present disclosure may be applied to an SC-FDMA waveform in substantially the same way as described herein below. That is, while some examples of the present disclosure may focus on an OFDM link for clarity, it should be understood that the same principles may be applied as well to SC-FDMA waveforms.

Referring now to FIG. 5, an expanded view of an example subframe 502 is illustrated, showing an OFDM resource grid. However, as those skilled in the art will readily appreciate, the physical (PHY) layer transmission structure for any particular application may vary from the example described here, depending on any number of factors. Here, time is in the horizontal direction with units of OFDM symbols; and frequency is in the vertical direction with units of subcarriers of the carrier.

The resource grid 504 may be used to schematically represent time-frequency resources for a given antenna port. In some examples, an antenna port is a logical entity used to map data streams to one or more antennas. Each antenna port may be associated with a reference signal (e.g., which may allow a receiver to distinguish data streams associated with the different antenna ports in a received transmission). An antenna port may be defined such that the channel over which a symbol on the antenna port is conveyed can be inferred from the channel over which another symbol on the same antenna port is conveyed. Thus, a given antenna port may represent a specific channel model associated with a particular reference signal. In some examples, a given antenna port and sub-carrier spacing (SCS) may be associated with a corresponding resource grid (including REs as discussed above). Here, modulated data symbols from multiple-input-multiple-output (MIMO) layers may be combined and re-distributed to each of the antenna ports, then precoding is applied, and the precoded data symbols are applied to corresponding REs for OFDM signal generation and transmission via one or more physical antenna elements. In some examples, the mapping of an antenna port to a physical antenna may be based on beamforming (e.g., a signal may be transmitted on certain antenna ports to form a desired beam). Thus, a given antenna port may correspond to a particular set of beamforming parameters (e.g., signal phases and/or amplitudes).

In a MIMO implementation with multiple antenna ports available, a corresponding multiple number of resource grids 504 may be available for communication. The resource grid 504 is divided into multiple resource elements (REs) 506. An RE, which is 1 subcarrier×1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 508, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. Within the present disclosure, it is assumed that a single RB such as the RB 508 entirely corresponds to a single direction of communication (either transmission or reception for a given device).

A set of continuous or discontinuous resource blocks may be referred to herein as a Resource Block Group (RBG), sub-band, or bandwidth part (BWP). A set of sub-bands or BWPs may span the entire bandwidth. Scheduling of scheduled entities (e.g., UEs) for downlink, uplink, or sidelink transmissions typically involves scheduling one or more resource elements 506 within one or more sub-bands or bandwidth parts (BWPs). Thus, a UE generally utilizes only a subset of the resource grid 504. In some examples, an RB may be the smallest unit of resources that can be allocated to a UE. Thus, the more RBs scheduled for a UE, and the higher the modulation scheme chosen for the air interface, the higher the data rate for the UE. The RBs may be scheduled by a scheduling entity, such as a base station (e.g., gNB, eNB, etc.), or may be self-scheduled by a UE implementing D2D sidelink communication.

In this illustration, the RB 508 is shown as occupying less than the entire bandwidth of the subframe 502, with some subcarriers illustrated above and below the RB 508. In a given implementation, the subframe 502 may have a bandwidth corresponding to any number of one or more RBs 508. Further, in this illustration, the RB 508 is shown as occupying less than the entire duration of the subframe 502, although this is merely one possible example.

Each 1 ms subframe 502 may consist of one or multiple adjacent slots. In the example shown in FIG. 5, one subframe 502 includes four slots 510, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots, sometimes referred to as shortened transmission time intervals (TTIs), having a shorter duration (e.g., one to three OFDM symbols). These mini-slots or shortened transmission time intervals (TTIs) may in some cases be transmitted occupying resources scheduled for ongoing slot transmissions for the same or for different UEs. Any number of resource blocks may be utilized within a subframe or slot.

An expanded view of one of the slots 510 illustrates the slot 510 including a control region 512 and a data region 514. In general, the control region 512 may carry control channels, and the data region 514 may carry data channels. Of course, a slot may contain all DL, all UL, or at least one DL portion and at least one UL portion. The structure illustrated in FIG. 5 is merely an example, and different slot structures may be utilized, and may include one or more of each of the control region(s) and data region(s).

Although not illustrated in FIG. 5, the various REs 506 within an RB 508 may be scheduled to carry one or more physical channels, including control channels, shared channels, data channels, etc. Other REs 506 within the RB 508 may also carry pilots or reference signals. These pilots or reference signals may provide for a receiving device to perform channel estimation of the corresponding channel, which may enable coherent demodulation/detection of the control and/or data channels within the RB 508.

In some examples, the slot 510 may be utilized for broadcast, multicast, groupcast, or unicast communication. For example, a broadcast, multicast, or groupcast communication may refer to a point-to-multipoint transmission by one device (e.g., a base station, UE, or other similar device) to other devices. Here, a broadcast communication is delivered to all devices, whereas a multicast or groupcast communication is delivered to multiple intended recipient devices. A unicast communication may refer to a point-to-point transmission by a one device to a single other device.

In an example of cellular communication over a cellular carrier via a Uu interface, for a DL transmission, the scheduling entity (e.g., a base station) may allocate one or more REs 506 (e.g., within the control region 512) to carry DL control information including one or more DL control channels, such as a physical downlink control channel (PDCCH), to one or more scheduled entities (e.g., UEs). The PDCCH carries downlink control information (DCI) including but not limited to power control commands (e.g., one or more open loop power control parameters and/or one or more closed loop power control parameters), scheduling information, a grant, and/or an assignment of REs for DL and UL transmissions. The PDCCH may further carry hybrid automatic repeat request (HARQ) feedback transmissions such as an acknowledgment (ACK) or negative acknowledgment (NACK). HARQ is a technique well-known to those of ordinary skill in the art, wherein the integrity of packet transmissions may be checked at the receiving side for accuracy, e.g., utilizing any suitable integrity checking mechanism, such as a checksum or a cyclic redundancy check (CRC). If the integrity of the transmission is confirmed, an ACK may be transmitted, whereas if not confirmed, a NACK may be transmitted. In response to a NACK, the transmitting device may send a HARQ retransmission, which may implement chase combining, incremental redundancy, etc.

The base station may further allocate one or more REs 506 (e.g., in the control region 512 or the data region 514) to carry other DL signals, such as a demodulation reference signal (DMRS); a phase-tracking reference signal (PT-RS); a channel state information (CSI) reference signal (CSI-RS); and a synchronization signal block (SSB). SSBs may be broadcast at regular intervals based on a periodicity (e.g., 5, 10, 20, 30, 80, or 130 ms). An SSB includes a primary synchronization signal (PSS), a secondary synchronization signal (SSS), and a physical broadcast control channel (PBCH). A UE may utilize the PSS and SSS to achieve radio frame, subframe, slot, and symbol synchronization in the time domain, identify the center of the channel (system) bandwidth in the frequency domain, and identify the physical cell identity (PCI) of the cell.

The PBCH in the SSB may further include a master information block (MIB) that includes various system information, along with parameters for decoding a system information block (SIB). The SIB may be, for example, a SystemInformationType 1 (SIB1) that may include various additional (remaining) system information. The MIB and SIB1 together provide the minimum system information (SI) for initial access. Examples of system information transmitted in the MIB may include, but are not limited to, a subcarrier spacing (e.g., default downlink numerology), system frame number, a configuration of a PDCCH control resource set (CORESET) (e.g., PDCCH CORESET0), a cell barred indicator, a cell reselection indicator, a raster offset, and a search space for SIB1. Examples of remaining minimum system information (RMSI) transmitted in the SIB1 may include, but are not limited to, a random access search space, a paging search space, downlink configuration information, and uplink configuration information. A base station may transmit other system information (OSI) as well.

In an UL transmission, the UE may utilize one or more REs 506 to carry UL control information (UCI) including one or more UL control channels, such as a physical uplink control channel (PUCCH), to the scheduling entity. UCI may include a variety of packet types and categories, including pilots, reference signals, and information configured to enable or assist in decoding uplink data transmissions. Examples of uplink reference signals may include a sounding reference signal (SRS) and an uplink DMRS. In some examples, the UCI may include a scheduling request (SR), i.e., request for the scheduling entity to schedule uplink transmissions. Here, in response to the SR transmitted on the UCI, the scheduling entity may transmit downlink control information (DCI) that may schedule resources for uplink packet transmissions. UCI may also include HARQ feedback, channel state feedback (CSF), such as a CSI report, or any other suitable UCI.

In addition to control information, one or more REs 506 (e.g., within the data region 514) may be allocated for data traffic. Such data traffic may be carried on one or more traffic channels, such as, for a DL transmission, a physical downlink shared channel (PDSCH); or for an UL transmission, a physical uplink shared channel (PUSCH). In some examples, one or more REs 506 within the data region 514 may be configured to carry other signals, such as one or more SIBs and DMRSs.

In an example of sidelink communication over a sidelink carrier via a proximity service (ProSe) PC5 interface, the control region 512 of the slot 510 may include a physical sidelink control channel (PSCCH) including sidelink control information (SCI) transmitted by an initiating (transmitting) sidelink device (e.g., a transmitting (Tx) V2X device or other Tx UE) towards a set of one or more other receiving sidelink devices (e.g., a receiving (Rx) V2X device or some other Rx UE). The data region 514 of the slot 510 may include a physical sidelink shared channel (PSSCH) including sidelink data traffic transmitted by the initiating (transmitting) sidelink device within resources reserved over the sidelink carrier by the transmitting sidelink device via the SCI. Other information may further be transmitted over various REs 506 within slot 510. For example, HARQ feedback information may be transmitted in a physical sidelink feedback channel (PSFCH) within the slot 510 from the receiving sidelink device to the transmitting sidelink device. In addition, one or more reference signals, such as a sidelink SSB, a sidelink CSI-RS, a sidelink SRS, and/or a sidelink positioning reference signal (PRS) may be transmitted within the slot 510.

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

The channels or carriers described above with reference to FIGS. 1-5 are not necessarily all of the channels or carriers that may be utilized between a scheduling entity and scheduled entities, and those of ordinary skill in the art will recognize that other channels or carriers may be utilized in addition to those illustrated, such as other traffic, control, and feedback channels.

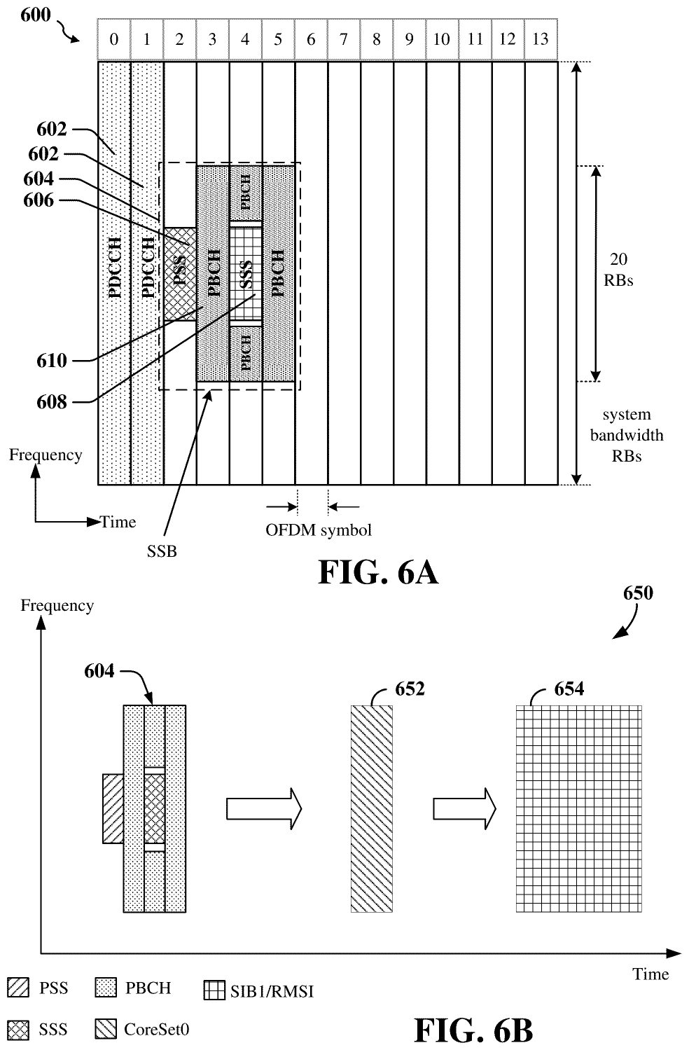

FIG. 6A illustrates an example 600 of various downlink channels within a subframe of a frame including channels used for initial access and synchronization. As shown in FIG. 6A, a physical downlink control channel (PDCCH) 602 is transmitted in at least two symbols (e.g., symbol 0 and symbol 1) and may carry DCI within at least one control channel element (CCE), with each CCE including nine RE groups (REGs), and each RE group (REG) including four consecutive REs in an OFDM symbol. Additionally, FIG. 6A illustrates an exemplary synchronization signal block (SSB) 604 that may be periodically transmitted by a base station or gNB. The SSB 604 carries synchronization signals PSS 606 and SSS 608 and broadcast channels (PBCH) 610. In this example, the SSB 604 contains one PSS symbol (shown in symbol 2), one SSS symbol (shown in symbol 6) and two PBCH symbols (shown in symbols 3 and 5). The PSS and SSS combination may be used to identify physical cell identities. A UE uses the PSS to determine subframe/symbol timing and a physical layer identity. The SSS is used by a UE to determine a physical layer cell identity group number and radio frame timing. Based on the physical layer identity and the physical layer cell identity group number, the UE can determine a physical cell identifier (PCI). Also, based on the PCI, the UE can determine the locations of the aforementioned DMRS. The physical broadcast channel (PBCH), which carries a master information block (MIB), is logically grouped with the PSS and SSS to form the synchronization signal; i.e., the SSB 604. The MIB provides a number of RBs in the system bandwidth and a system frame number (SFN).

FIG. 6B is a diagram illustrating various broadcast information 650 related to initial cell access according to some examples. The broadcast information 650 may be transmitted by a RAN node (e.g., a base station, such as an eNB or gNB) on resources (e.g., time-frequency resources) allocated for the transmission of the broadcast information 650 in a cell. The broadcast information 650 includes the SSB 604 illustrated in FIG. 6A. It is noted that the PBCH in the SSB 604 includes the MIB carrying various system information (SI) including, for example, a cell barred indication, the subcarrier spacing, the system frame number, and scheduling information for a CORESET0 652. For example, the PBCH in the SSB 604 may include scheduling information indicating time-frequency resources allocated for the CORESET0 652. In some examples, the CORESET0 652 may be transmitted within the first four symbols (e.g., within a control region) of a slot. In addition, the CORESET0 652 carries a PDCCH with DCI that contains scheduling information for scheduling the SIB1 654. The SIB1 654 is carried within a physical downlink shared channel (PDSCH) within a data region of a slot. In addition, the SIB1 654 may be referred to as RMSI and includes, for example, a set of radio resource parameters providing network identification and configuration. For example, the set of radio resource parameters may include a bandwidth (e.g., number of BWPs) on which a UE may communicate with a base station.

The MIB in the PBCH may include system information (SI), along with parameters for decoding a SIB (e.g., SIB1). Examples of SI transmitted in the MIB may include, but are not limited to, a subcarrier spacing, a system frame number, a configuration of a PDCCH control resource set (CORESET) (e.g., PDCCH CORESET0), and a search space for SIB1. Examples of SI transmitted in the SIB1 may include, but are not limited to, a random access search space, downlink configuration information, and uplink configuration information. The MIB and SIB1 together provide the minimum SI for initial access.

A brief discussion of an initial access procedure for a UE using the above information follows. As discussed above, a base station (BS) may transmit synchronization signals (e.g., including PSS and SSS) in the network to enable UEs to synchronize with the BS, as well as SI (e.g., including a MIB, RMSI, and OSI) to facilitate initial network access. The BS may transmit the PSS, the SSS, and/or the MIB via SSBs over the PBCH and may broadcast the RMSI and/or the OSI over the PDSCH.

A UE attempting to access a RAN (e.g., the RAN 200 of FIG. 2) may perform an initial cell search by detecting a PSS from a BS (e.g., the PSS of a cell of the BS) of the RAN. The PSS may enable the UE to synchronize to period timing of the BS and may indicate a physical layer identity value assigned to the cell. The UE may also receive an SSS from the BS that enables the UE to synchronize on the radio frame level with the cell. The SSS may also provide a cell identity value, which the UE may combine with the physical layer identity value to identify the cell.

After receiving the PSS and SSS, the UE may receive the SI from the BS. The system information may take the form of the MIB and SIBs discussed above. The system information may include information that a UE can use to access the network such as downlink (DL) channel configuration information, uplink (UL) channel configuration information, access class information, and cell barring information, as well as other information. The MIB may include SI for initial network access and scheduling information for RMSI and/or OSI. After decoding the MIB, the UE may receive the RMSI and/or the OSI.

The SI includes information that enables a UE to determine how to conduct an initial access to a RAN. In some examples, the SIB2 includes random access configuration information (e.g., a random access channel (RACH) configuration) that indicates the resources that the UE is to use to communicate with the RAN during initial access. The random access configuration information may indicate, for example, the resources allocated by the RAN for a random access (RA) procedure (e.g., a RACH procedure). For example, the RACH configuration may indicate the resources allocated by the network for the UE to transmit a physical random access channel (PRACH) preamble and to receive a random access response. In some examples, the RACH configuration identifies RACH occasions (ROs) that specify a set of symbols (e.g., in a PRACH slot) that are scheduled by a base station for the PRACH procedure. The RACH configuration may also indicate the size of a random access response window during which the UE is to monitor for a response to a PRACH preamble. The RACH configuration may further specify that the random access response window starts a certain number of sub-frames after the end of the PRACH preamble in some examples. After obtaining the MIB, the RMSI and/or the OSI, the UE may thus perform a random access procedure for initial access to the RAN.

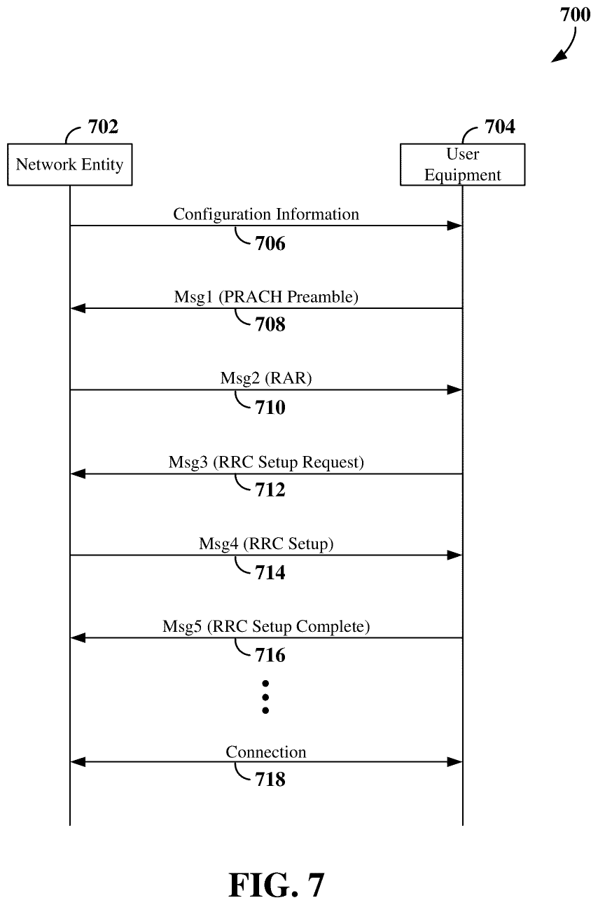

FIG. 7 is a signaling diagram 700 illustrating an example of signaling associated with a contention-based random access procedure in a wireless communication system including a network entity (e.g., a base station) 702 and a user equipment 704. In some examples, the network entity 702 may correspond to any of the network entities, base stations, CUs, DUs, RUs, or scheduling entities shown in any of FIGS. 1, 2, 3, 4, 11, 12, 13, 15, 16, 17, 18, 19, 20, and 23. In some examples, the user equipment 704 may correspond to any of the UEs or scheduled entities shown in any of FIGS. 1, 2, 3, 4, 11, 12, 13, 15, 16, 17, 18, 19, 20, and 21.

At #706 of FIG. 7, the network entity 702 broadcasts configuration information that nearby devices (e.g., the user equipment 704) may use for an RA procedure directed to the network entity 702. For example, the network entity 702 may broadcast the random access-related SI discussed above.

At #708 of FIG. 7, the user equipment 704 transmits a message 1 (which may be referred to as RACH Msg1 or simply Msg1) of the RA procedure to the network entity 702. In some examples, the Msg1 is a PRACH preamble. Msg1 may be referred to as PRACH. As mentioned above, the user equipment 704 may transmit the PRACH preamble on resources specified by a RACH configuration included in SIB2.

At #710, the network entity 702 responds to the PRACH preamble with a message 2 (which may be referred to as Msg2) of the RA procedure. The Msg2 may be referred to informally as a random access response (RAR). In some examples of 710, the network entity 702 transmits a DCI on a PDCCH, where the DCI schedules a PDSCH (e.g., the DCI specifies the resources for the PDSCH transmission). The network entity 702 then transmits the PDSCH which includes the RAR data such as, for example, an UL grant for the user equipment to transmit a message 3 PUSCH of the RA procedure (which may be referred to as Msg3). Here, a random access RNTI (RA-RNTI) may be used to schedule the PDSCH with the random access response (RAR), where the PDSCH contains the UL grant for Msg3.

In some examples, the user equipment 704 monitors for the Msg2 on resources specified by the RACH configuration during the RAR window specified by the RACH configuration. For example, the user equipment 704 may decode the DCI carried on the PDCCH and then decode the RAR carried on the PDSCH.

At #712, upon receiving all of the RAR information, the user equipment 704 transmits the Msg3 PUSCH of the RA procedure. In some examples, the Msg3 is a radio resource control (RRC) Setup Request message.

At #714, the network entity 702 responds with a message 4 (which may be referred to as Msg4) of the RA procedure. In some examples, the Msg4 is an RRC Setup message (e.g., a contention resolution message).

At #716, the user equipment 704 responds with a message 5 (which may be referred to as Msg5) of the RA procedure. In some examples, the Msg5 is an RRC Setup Complete message. In some examples, if the user equipment 704 successfully decodes the Msg 4, the transmission of Msg5 may involve transmitting a PUCCH including a HARQ-ACK for the PDSCH data of Msg4. In some examples, PUCCH frequency hopping may be used for this transmission of the Msg5.

As indicated by 718, the network entity 702 and the user equipment 704 ultimately establish a connection and enter an active operational phase where data may be exchanged. For example, the network entity 702 may schedule the user equipment 704 for UL communication and/or DL communication.

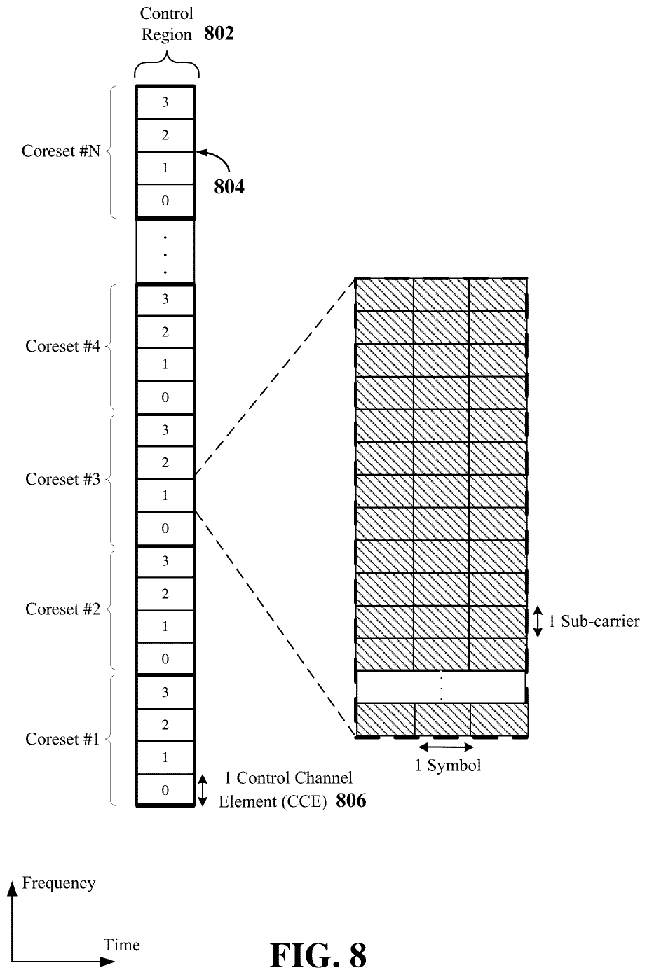

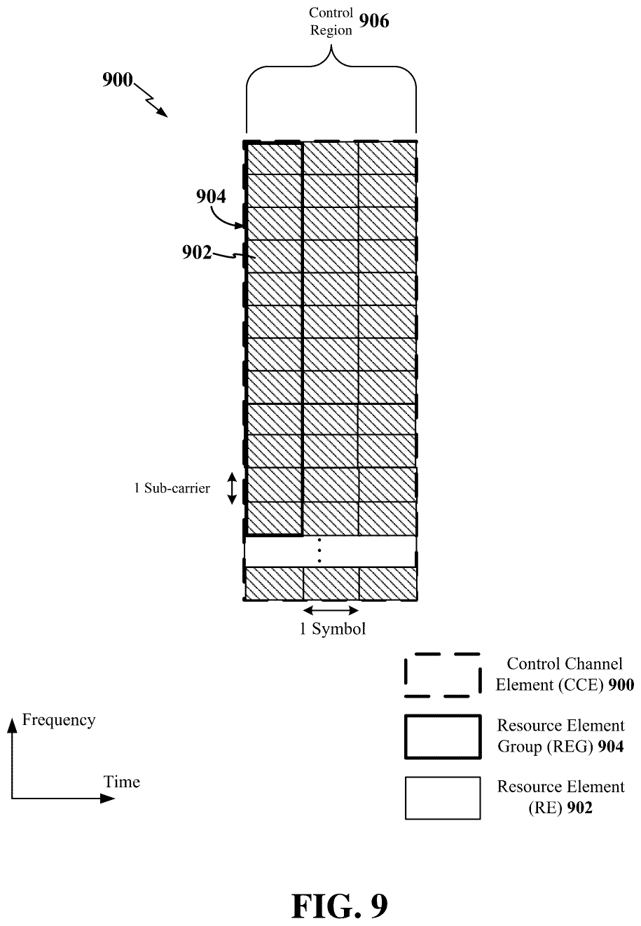

As mentioned above, a base station may use a downlink control region of a slot to send PDCCH information to a UE. In some examples, the PDCCH information may be a scheduling DCI that schedules a downlink transmission to a UE, a scheduling DCI that schedules an uplink transmission by a UE, or a scheduling DCI that schedules some other transmission. In some examples, the PDCCH information may be a non-scheduling DCI (e.g., a DCI that carries information, but does not schedule a transmission). FIGS. 8 and 9 describe example resource configurations that may be used to carry such PDCCH information.

FIG. 8 is a schematic illustration of an example of a downlink (DL) control region 802 of a slot according to some aspects. The DL control region 802 may correspond, for example, to the control region 512 of the slot 510 illustrated in FIG. 5. As discussed above, the DL control region 802 may carry a PDCCH that includes one or more DCIs.

The DL control region 802 includes a plurality of CORESETs 804 indexed as CORESET #1-CORESET #N. Each CORESET 804 includes a number of sub-carriers in the frequency domain and one or more symbols in the time domain. In the example of FIG. 8, each CORESET 804 includes at least one control channel element (CCE) 806 having dimensions in both frequency and time, sized to span across at least three OFDM symbols. A CORESET 804 having a size that spans across two or more OFDM symbols may be beneficial for use over a relatively small system bandwidth (e.g., 5 MHZ). However, a one-symbol CORESET may be used in some scenarios.

In some examples, a base station may configure a CORESET 804 for carrying group common control information or UE-specific control information, whereby the CORESET 804 may be used for transmission of a PDCCH including the group common control information or the UE-specific control information to one or more UEs. Each UE may be configured to monitor one or more CORESETs 804 for the UE-specific or group common control information (e.g., on a PDCCH).

In some examples, the PDCCH may be constructed from a variable number of CCEs, depending on the PDCCH format (e.g., aggregation level). Each PDCCH format (e.g., aggregation level) supports a different DCI length. In some examples, PDCCH aggregation levels of 1, 2, 4, 8, and 16 may be supported, corresponding to 1, 2, 4, 8, or 16 contiguous CCEs, respectively.

FIG. 9 is a schematic illustration of an example of a CCE structure 900 in a DL control region 906 of a slot according to some aspects. The DL control region 906 may correspond, for example, to the control region 512 of the slot 510 illustrated in FIG. 5. The CCE structure 900 includes a number of REs 902 that may be grouped into at least one RE group (REG) 904. Each REG 904 generally may contain, for example, twelve consecutive REs 902 (or nine REs 902 and three DMRS REs) within the same OFDM symbol and the same RB. In the example of FIG. 9, the CCE structure 900 includes at least six REGs 904 (not shown in their entirety) distributed across three OFDM symbols. However, as those skilled in the art will readily appreciate, the CCE structure 900 for any particular application may vary from the example described herein, depending on any number of factors. For example, the CCE structure 900 may contain any suitable number of REGs.

In some examples, a UE may be unaware of the particular aggregation level of the PDCCH or whether multiple PDCCHs may exist for the UE in the slot. Consequently, the UE may perform blind decoding of various PDCCH candidates within the first N control OFDM symbols of the slot (as indicated by the slot format of the slot) and/or other OFDM symbols of the slot. In some examples, this decoding is based on a radio network temporary identifier (RNTI) (e.g., a UE-specific RNTI or a group RNTI) that the base station is expected to use when encoding the PDCCH. Each PDCCH candidate includes a collection of one or more consecutive CCEs based on an assumed DCI length (e.g., PDCCH aggregation level). The term PDCCH candidate is used here to emphasize that the UE might not be configured with information indicating exactly what type of PDCCH is carried within a slot or where a particular PDCCH is carried within a slot. Thus, with blind decoding, the UE attempts to decode signals received on different sets of resource (e.g., corresponding to different PDCCH candidates) to determine whether those resources are actually carrying a PDCCH.

To limit the number of blind decodes performed by a UE, a base station may configure certain search spaces such as UE-specific search spaces (USSs) and common search spaces (CSSs). Here, the base station may send a PDCCH to a UE or a set of UEs only on the resources specified for the configured search space(s). Thus, the UE or UEs may limit their blind decoding to the configured search space(s). In some examples, the base station may configure one or more search space sets, each of which includes at least one search space. In some examples, different search space sets may be assigned different search space set identifiers (IDs). In some examples, a search space set ID may be referred to as a search space set index.

A UE-specific search space set may consist of CCEs used for sending control information to a particular UE. The starting point (offset or index) of a UE-specific search space may be different for each UE. In addition, each UE may have multiple UE-specific search spaces (e.g., a respective one for each aggregation level).

A common search space set may consist of CCEs used for sending control information that is common to a group of UEs or to all UEs (e.g., under a given cell). Thus, a common search space set may be monitored by multiple UEs in a cell. The starting point (offset or index) of a search space set for group common control information may be the same for all UEs in the group and there may be multiple search space sets defined for group common control information (e.g., a respective one for each configured aggregation level for the group of UEs).

A UE may perform blind decoding over all aggregation levels and corresponding USSs or CSSs to determine whether at least one valid DCI is carried by the UE-specific search space (USS) or the common search space (CSS) for the UE. By using search space sets (e.g., USSs and CSSs) configured for at least one UE for this blind decoding, the number of blind decodes that each UE performs for each PDCCH format combination may be reduced (e.g., as compared to a scenario that does not use search space sets).

A UE may monitor a search space for downlink assignments and uplink grants relating to a particular component carrier for the UE. For example, the UE may monitor the search space for a PDCCH that includes a DCI that schedules a PDSCH in the same slot or in a different slot for that component carrier. In this case, the DCI includes a frequency domain resource assignment and a time domain resource assignment for a PDSCH and other information (e.g., MCS, etc.) that enables the UE to decode the PDSCH.

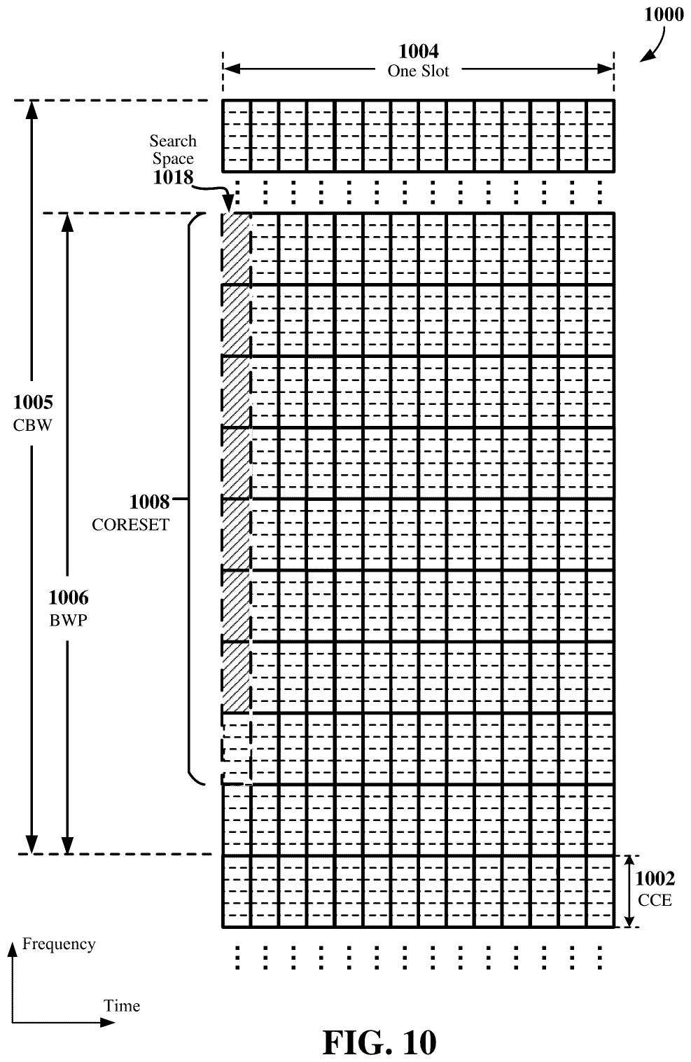

FIG. 10 is a schematic illustration of an example of downlink time-frequency resources 1000, where a search space is defined within a CORESET. In FIG. 10, time is in the horizontal direction with units of OFDM symbols and frequency is in the vertical direction with units of CCEs. For example, the vertical dimension of each major solid line rectangle represents one CCE 1002. Each CCE 1002 includes 6 resource element groups (REGs). Each REG may correspond to one physical resource block (PRB), including 12 resource elements (REs) in the frequency domain and one OFDM symbol in the time domain. The 6 REGs of each CCE 1002 are respectively represented by a minor dashed line rectangle. One slot 1004 in the time domain is represented. Other resource configurations may be used in other examples.

FIG. 10 depicts one bandwidth part (BWP) 1006 within a carrier bandwidth (CBW) 1005. According to some aspects, the BWP 1006 is a contiguous set of physical resource blocks (PRBs) on a given carrier. In the example of FIG. 10, the contiguous set of PRBs are represented by a contiguous set of CCEs 1002. In addition, the BWP 1006 corresponds to a set of 64 PRBs, which represent 648 subcarriers (i.e., 12 REs/REG×6 REGs/CCE×9 CCEs). A base station may configure different sets of these CCEs as common CCEs or UE-specific CCEs.

In the example of FIG. 10, a CORESET 1008 includes 48 REGs in one set of eight CCEs (where each CCE may be similar to the CCE 1002). The eight CCEs may be grouped as a first DCI.

A CORESET may include a one or more search spaces. A search space may include all or a portion of a CORESET. A CORESET may be associated with a common search space, a UE-specific search space, or a combination of both. In the example of FIG. 10, one search space (SS) 1018 is indicated for the CORESET 1008 (represented by the slanted lines).

A search space may include a number of PDCCH candidates. As mentioned above, a UE may attempt to blind decode a PDCCH candidate in each search space; even if a base station did not schedule a PDCCH in any given search space.

The following relationships between CORESETs, BWPs, and search spaces are made with reference to some examples of NR; however, the following is an example and non-limiting and other relationships between CORESETs, BWPs, and search spaces (or their equivalents, for example in other radio technologies) are within the scope of the disclosure. In some examples, for a given UE, a base station may configure up to three CORESETs in a BWP of a serving cell (e.g., a component carrier (CC)), including both common and UE-specific CORESETs. In addition, the base station may configure up to four BWPs per serving cell, with one of the BWPs active at a given time. Accordingly, a maximum number of CORESETs for a UE per serving cell may be twelve (e.g., 3 CORESETs per BWP×4 BWPs per serving cell) in these examples. The resource elements of a CORESET may be mapped to one or more CCEs. One or more CCEs from one CORESET may be aggregated to form the resources used by one PDCCH. In some examples, the maximum number of search spaces per BWP may be ten (10). In some examples, multiple search spaces may use the time-frequency resources of one CORESET.

A base station may send a PDCCH to a UE via the downlink time-frequency resources 1000 (e.g., within a configured search space). In some examples, the base station may compute a cyclic redundancy check (CRC) of a payload of a DCI carried by a PDCCH. The CRC may be scrambled using an identifier of a UE. An example of such an identifier may be a radio network temporary identifier (RNTI), such as a random access-radio network temporary identifier (RA-RNTI).

During blind decoding of a search space, the UE may attempt to descramble CRC of a PDCCH candidate using an RNTI. For example, the UE may compute a CRC on the payload of the corresponding DCI using the same procedure as used by the base station, and then compare the CRCs. If the CRCs are equal, the DCI was destined for the UE. If the payload was corrupted or the CRC was scrambled using another UE's RNTI, then the CRCs would not match, and the UE may disregard the DCI.

A UE under the coverage area of a RAN may operate in one of several defined operating states (also referred to as modes). In some examples, these states include an idle state, an inactive state, and a connected state. In 5G NR, these operating states are defined as radio resource control (RRC) states: RRC_IDLE, RRC_INACTIVE, and RRC_CONNECTED.

During RRC_IDLE, a UE-specific discontinuous reception (DRX) may be configured by upper layers. At lower layers, the UE may be configured with a DRX for point-to-multipoint (PTM) transmission of multicast and broadcast services (MBS) broadcast. UE controlled mobility may be based on network configuration.

In addition, during RRC_IDLE, the UE may monitor short messages transmitted with P-RNTI over DCI, and may monitor a paging channel for core network (CN) paging using 5G-S-TMSI. If the UE is configured by upper layers for MBS multicast reception, the UE may monitor a paging channel for CN paging using a temporary mobile group identity (TMGI).

Also during RRC_IDLE, the UE may perform neighboring cell measurements and cell (re-)selection, acquire system information (SI), send SI requests (if configured), perform logging of available measurements together with location and time for logged measurement configured UEs, and perform idle/inactive measurements for idle/inactive measurement configured UEs. If configured by upper layers for MBS broadcast reception, the UE may acquire multicast control channel (MCCH) change notifications and MBS broadcast control information and data.

During RRC_INACTIVE, a UE-specific discontinuous reception (DRX) may be configured by upper layers or by the RRC layer. At lower layers, the UE may be configured with a DRX for PTM transmission of MBS broadcast. UE controlled mobility may be based on network configuration.

In addition, during RRC_INACTIVE, the UE may store the UE inactive access stratum (AS) context, and transfer unicast data and/or signaling to/from the UE over radio bearers configured for small data transmission (SDT). A RAN-based notification area may be configured by the RRC layer.

Also during RRC_INACTIVE, the UE may monitor short messages transmitted with P-RNTI over DCI. During an SDT procedure, the UE may monitor control channels associated with the shared data channel to determine whether data is scheduled for the UE. When the SDT procedure is not ongoing, the UE may monitor a paging channel for CN paging using 5G-S-TMSI and RAN paging using full I-RNTI. If the UE is configured by upper layers for MBS multicast reception, while an SDT procedure is not ongoing, the UE may monitor a paging channel for paging using TMGI. The UE may perform neighboring cell measurements and cell (re-)selection, perform RAN-based notification area updates periodically and when moving outside the configured RAN-based notification area, acquire system information and, while an SDT procedure is not ongoing, send SI requests (if configured). While an SDT procedure is not ongoing, the UE may perform logging of available measurements together with location and time for logged measurement configured UE, and perform idle/inactive measurements for idle/inactive measurement configured UEs. If configured by upper layers for MBS broadcast reception, the UE may acquire MCCH change notification and MBS broadcast control information and data. In addition, the UE may transmit SRS for positioning.

During RRC_CONNECTED, a UE may store AS context, transfer unicast data, and transfer MBS multicast data. At lower layers, the UE may be configured with a UE-specific DRX and/or a DRX for PTM transmission of MBS broadcast and/or a DRX for MBS multicast. For UEs supporting carrier aggregation (CA), the UE may use one or more SCells, aggregated with an SpCell, for increased bandwidth. For UEs supporting dual connectivity (DC), the UE may use a secondary cell group (SCG), aggregated with a master cell group (MCG), for increased bandwidth. Network controlled mobility within NR includes to/from Evolved Universal Terrestrial Radio Access (E-UTRA) and to Universal Terrestrial Radio Access frequency division duplex (UTRA-FDD).

Also during RRC_CONNECTED, a UE may monitor short messages transmitted with P-RNTI over DCI, monitor control channels associated with the shared data channel to determine whether data is scheduled for the UE, provide channel quality and feedback information, perform neighboring cell measurements and measurement reporting, acquire SI, perform immediate MDT measurement together with available location reporting, and, if configured by upper layers for MBS broadcast reception, acquire MCCH change notification and MBS broadcast control information and data.

A UE will be in an idle state when it first powers up. The UE may transition to a connected state with a RAN by performing a random access procedure with that RAN. In the connected state, the UE may communicate with the RAN via dedicated signaling (e.g., dedicated channels). A UE may switch to idle state or inactive state under certain circumstances. For example, a UE that does not have data to send to the RAN and that is not receiving data from the RAN may elect to switch to the idle state or the inactive state to conserve battery power. In these states, since the UE is not actively communicating with the RAN, the UE may power off some of its components (e.g., radio components). That is, the UE enters a lower power state.

The UE will periodically wake up from the low power state to monitor for signaling from the RAN (e.g., to determine whether the RAN has data to send to the UE). This periodicity may be based on a discontinuous reception (DRX) cycle specified by the RAN. If the RAN has data to send to the UE or if the RAN needs to communicate with the UE for other reasons, the RAN will page the UE according to the DRX cycle (i.e., during the time intervals when the UE periodically wakes up from the lower power state). The RAN sends a paging message via a paging channel (e.g., via a paging frame). In addition, the RAN may define different paging opportunities (also referred to as paging occasions) that can be used by different UEs to receive a paging message. That is, UEs may remain in the lower power state until their own paging opportunities occur. The use of different paging opportunities for different UEs allows the RAN to direct paging to a particular UE or a small subset of UEs. This reduces the likelihood that a UE will need to expend battery power to process paging that is directed to another UE. Upon receiving a paging message indicating that the network will be sending data (or other information) that a UE needs to receive, the UE may resume full operations (e.g., turn on all radio components) and, if needed, reestablish a connected state with the RAN.

The RAN may configure a UE (e.g., via broadcast) with information that enables a UE to receive a paging message. For example, this information may identify one or more of: a paging channel (e.g., the resources used for paging), a paging frame, at least one parameter that a UE uses to determine its paging opportunities, or a paging-radio network temporary identifier (P-RNTI) that the RAN uses when transmitting a paging message.

A RAN may use DCI to page a UE. For example, the RAN may transmit DCI including a paging indicator during a paging opportunity. For example, a DCI may include a short message indicator that indicates whether the DCI includes a paging indicator and/or a short message. Table 1 illustrates an example of a short message indicator consisting of two bits. The binary value of 00 for the short message indicator is reserved. The binary value of 01 for the short message indicator indicates that the DCI includes scheduling information for paging. The binary value of 10 for the short message indicator indicates that the DCI includes a short message. The binary value of 11 for the short message indicator indicates that the DCI includes scheduling information for paging and a short message.

TABLE 1

| Bit field | Short Message indicator |
|---|---|
| 00 | Reserved |
| 01 | Only scheduling information for Paging is present in the DCI |
| 10 | Only short message is present in the DCI |
| 11 | Both scheduling information for Paging and short message are |
| | present in the DCI |

As shown in the short message indicator of Table 1, the short message indicator indicates whether the DCI includes a short message. Table 2 illustrates an example of a short message in some examples (e.g., some versions of 3GPP NR). A first bit indicates whether SI has been modified. A second bit is used for alerts. A third bit indicates that a UE may stop monitoring PDCCH. A fourth bit indicates whether SI has been modified. The fifth through eighth bits are unused. Thus, in some examples, the DCI format illustrated in Tables 1 and 2 may be used to send a paging message to UEs indicating that SI has changed. However, it should be understood that this DCI format is merely an example, and other suitable DCI formats may be used to transmit paging messages indicating a change in SI.

TABLE 2

| Bit | Short Message |
|---|---|
| 1 | systemInfoModification |
| | If set to 1: indication of a broadcast control channel (BCCH) |
| | modification other than SIB6, SIB7, SIB8 and posSIBs. |
| 2 | etwsAndCmasIndication |
| | If set to 1: indication of an ETWS primary notification and/or an |
| | ETWS secondary notification and/or a CMAS notification. |
| 3 | stopPagingMonitoring |
| | This bit can be used for only operation with shared spectrum channel |
| | access and if nrofPDCCH-MonitoringOccasionPerSSB-InPO is |
| | present. |
| | If set to 1: indication that the UE may stop monitoring PDCCH |
| | occasion(s) for paging in this Paging Occasion as specified in TS |
| | 38.304 [20], clause 7.1. |
| 4 | systemInfoModification-eDRX |
| | If set to 1: indication of a BCCH modification other than SIB6, SIB7, |
| | SIB8 and posSIBs. This indication applies only to UEs using IDLE |
| | eDRX cycle longer than the BCCH modification period. |
| 5-8 | Not used in this release of the specification, and shall be ignored |
| | by UE if received. |

For short message reception in a paging occasion, a UE may monitor the PDCCH monitoring occasion(s) for paging as follows. The paging frame (PF) and paging occasion (PO) used for paging are determined by the following formulas: system frame number (SFN) for the PF is determined by: (SFN+PF_offset) mod T=(T div N)*(UE_ID mod N); and Index (i_s), indicating the index of the PO is determined by: i_s=floor (UE_ID/N) mod Ns.

The PDCCH monitoring occasions for paging may be determined according to a pagingSearchSpace and a firstPDCCH-MonitoringOccasionOfPO, if configured. When SearchSpaceId=0 is configured for the pagingSearchSpace, the PDCCH monitoring occasions for paging are the same as for the remaining minimum SI (RMSI).

The following parameters may be used for the calculation of the PF and i_s parameters mentioned above: T: DRX cycle of the UE (T is determined by the shortest of the UE specific DRX value(s), if configured by RRC and/or upper layers, and a default DRX value broadcast in system information. In RRC_IDLE state, if UE specific DRX is not configured by upper layers, the default value is applied). N: number of total paging frames in T. Ns: number of paging occasions for a PF. PF_offset: offset used for PF determination. UE_ID: 5G-S-TMSI mod 1024. Here, the 5G-S-TMSI is a shortened version of the 5G global unique temporary identifier (GUTI) that includes the 5G temporary mobile subscriber identity (TMSI).

The parameters Ns, nAndPagingFrameOffset, and the length of default DRX Cycle are signaled in SIB1. The values of N and PF_offset are derived from the parameter nAndPagingFrameOffset. The parameter first-PDCCH-MonitoringOccasionOfPO is signaled in SIB1 for paging in an initial DL BWP. For paging in a DL BWP other than the initial DL BWP, the parameter first-PDCCH-MonitoringOccasionOfPO is signaled in the corresponding BWP configuration.

If the UE has no 5G-S-TMSI, for instance when the UE has not yet registered onto the network, the UE may use as a default identity UE_ID=0 in the PF and i_s formulas above. 5G-S-TMSI is a 48 bit long bit string, interpreted as a binary number where the left most bit represents the most significant bit.

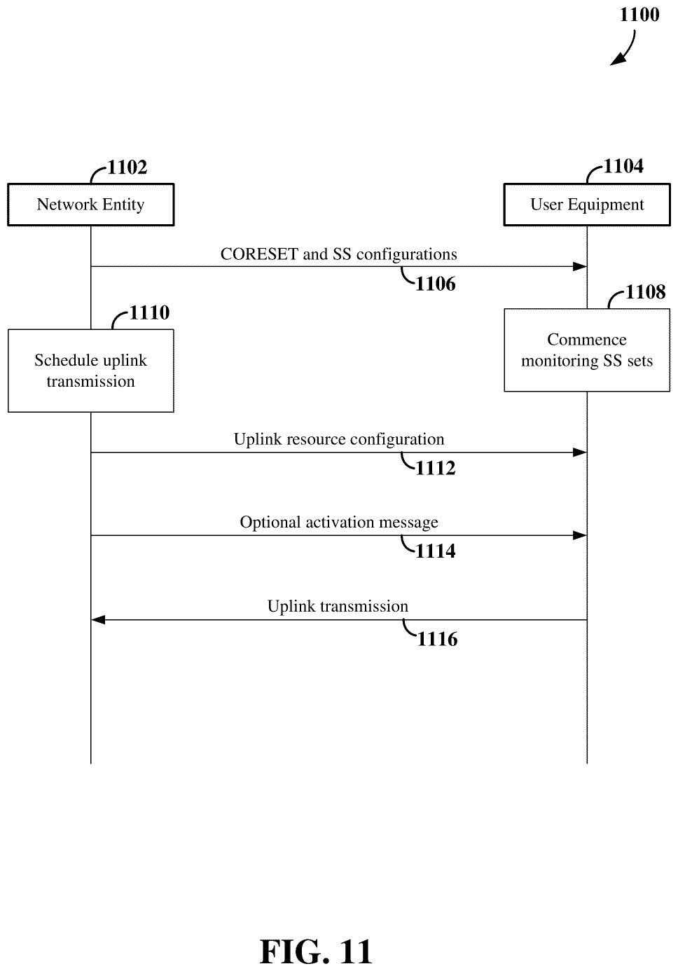

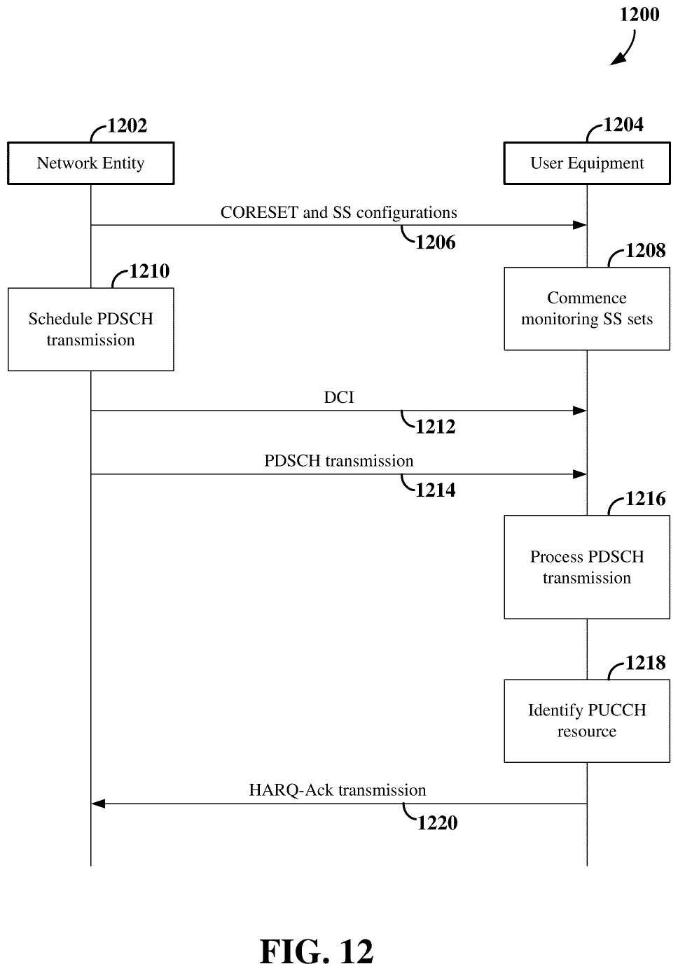

As discussed above, a network entity may transmit DCI to schedule uplink transmission by a UE and schedule downlink transmissions to a UE. FIGS. 11 and 12 illustrates examples of such scheduling.

FIG. 11 is a signaling diagram 1100 illustrating an example of uplink transmission configuration-related signaling in a wireless communication system including a network entity 1102 and a user equipment (UE) 1104. In some examples, the network entity 1102 may correspond to any of the base stations, CUs, DUs, RUs, or scheduling entities shown in any of FIGS. 1, 2, 3, 4, 7, 12, 13, 15, 16, 17, 18, 19, 20, and 23. In some examples, the UE 1104 may correspond to any of the UEs or scheduled entities shown in any of FIGS. 1, 2, 3, 4, 7, 12, 13, 15, 16, 17, 18, 19, 20, and 21.

At 1106 of FIG. 11, the network entity 1102 transmits (e.g., via RRC messaging) CORESET and search space (SS) configurations that the UE 1104 is to use for receiving information from the network entity 1102. For example, a CORESET configuration for the UE 1104 may specify the RBs and the number of symbols for each CORESET configured for the UE 1104. In addition, an SS configuration may specify, for each configured SS set, the associated CORESET, PDCCH monitoring occasion (MO) information, PDCCH candidates, and so on.

At 1108, the UE 1104 repeatedly monitors the configured SS sets to determine whether the network entity 1102 has transmitted any messages to the UE 1104. In some aspects, this may involve blind decoding for PDCCH candidates in a search space configured for the UE 1104 as discussed herein.

At 1110, at some point in time, the network entity 1102 configures an uplink (e.g., a PUSCH transmission or a PUCCH transmission) for the UE 1104. Accordingly, at 1112, the network entity 1102 transmits a message to the UE 1104, where the message may indicate a configured resource for the uplink transmission. As discussed above, the message may be a dynamic grant that dynamically configures an uplink resource, a configured grant (CG) that configures a set of resources (e.g., PUSCH occasions), or some other type of configuration message.

At optional 1114, for a CG scenario, the network entity 1102 may transmit a message (e.g., a DCI) to the UE 1104 to activate the CG resource.

At 1116, the UE 1104 transmits the uplink transmission to the network entity 1102 via the configured resource.

FIG. 12 is a signaling diagram 1200 illustrating an example of PDSCH-related signaling in a wireless communication system including a network entity 1202 and a user equipment (UE) 1204. In some examples, the network entity 1202 may correspond to any of the base stations, CUs, DUs, RUs, or scheduling entities shown in any of FIGS. 1, 2, 3, 4, 7, 11, 13, 15, 16, 17, 18, 19, 20, and 23. In some examples, the UE 1204 may correspond to any of the UEs or scheduled entities shown in any of FIGS. 1, 2, 3, 4, 7, 11, 13, 15, 16, 17, 18, 19, 20, and 21.

At 1206 of FIG. 12, the network entity 1202 transmits (e.g., via RRC messaging) CORESET and search space (SS) configurations that the UE 1204 is to use for receiving information from the network entity 1202. For example, a CORESET configuration for the UE 1204 may specify the RBs and the number of symbols for each CORESET configured for the UE 1204. In addition, an SS configuration may specify, for each configured SS set, the associated CORESET, PDCCH monitoring occasion (MO) information, PDCCH candidates, and so on.

At 1208, the UE 1204 repeatedly monitors the configured SS sets to determine whether the network entity 1202 has transmitted any messages to the UE 1204. In some aspects, this may involve blind decoding for PDCCH candidates in a search space configured for the UE 1204 as discussed herein.

At 1210, at some point in time, the network entity 1202 schedules a PDSCH transmission for the UE 1204. In some examples, the network entity 1202 may schedule a PDSCH transmission and an associated PUCCH transmission (e.g., for a HARQ-Ack). Accordingly, at 1212, the network entity 1202 transmits a DCI to the UE 1204, where the DCI may indicate a PDSCH resource for the PDSCH transmission and a PUCCH resource for a HARQ-Ack. At 1214, the network entity 1202 transmits the PDSCH transmission to the UE 1204. In some examples, the network entity 1202 may transmit the DCI and a PDSCH in the same slot.

At 1216, the UE 1204 attempts to decode the PDSCH transmission and generates a HARQ-Ack to be sent to the network entity 1202 to indicate whether the UE 1204 successfully received the PDSCH transmission. Thus, at 1218, the UE 1204 will identify the PUCCH resource for sending the HARQ-Ack to the network entity 1202 (e.g., based on information in the DCI received at 1212). In some examples, during the reception of a slot that includes a DCI, the user equipment 1104 may decode the DCI and, based on the DCI information, decode the next PDSCH.

At 1220, the UE 1204 transmits the HARQ-Ack transmission on the PUCCH resource identified at 1218 to the network entity 1202 to indicate whether the UE 1204 successfully decoded the PDSCH transmission.

Different DCI formats may be used for different scheduling operations. In some aspects, a DCI format specifies a set of fields for a DCI. In some aspects, a particular DCI format may correspond to a particular size (e.g., in bits) of a DCI.

Tables 3 and 4 describe a set of DCI formats that may be used in some examples (e.g., some versions of 3GPP NR). Other sets of DCI formats may be used in other examples. As indicated in Table 3, a network entity (e.g., gNB) uses the DCI formats 0_x for scheduling PUSCH, the DCI formats 1_x for scheduling PDSCH, and the DCI formats 2_x for various scheduling-related operations.

TABLE 3

| DCI | |
|---|---|
| Format | Usage |
| 0_0 | Scheduling of PUSCH in one cell |
| 0_1 | Scheduling of one or multiple PUSCH in one cell, or indicating |
| | downlink feedback information for configured grant PUSCH |
| | (CG-DFI) |
| 0_2 | Scheduling of PUSCH in one cell |
| 1_0 | Scheduling of PDSCH in one cell |
| 1_1 | Scheduling of PDSCH in one cell |
| 1_2 | Scheduling of PDSCH in one cell, and/or triggering one shot |
| | HARQ-ACK codebook feedback |
| 2_0 | Notifying a group of UEs of the slot format, available RB sets, |
| | COT duration and search space set group switching |
| 2_1 | Notifying a group of UEs of the PRB(s) and OFDM symbols(s) |
| | where UE may assume no transmission is intended for the UE |
| 2_2 | Transmission of transmit power control (TPC) commands for |
| | PUCCH and PUSCH |
| 2_3 | Transmission of a group of TPC commands for SRS |
| | transmissions by one or more UEs |
| 2_4 | Notifying a group of UEs of the PRB(s) and OFDM symbol(s) |
| | where UE cancels the corresponding UL transmission from the |
| | UE |
| 2_5 | Notifying the availability of soft resources as defined in |
| | Clause 9.3.1 of [10, TS 38.473] |
| 2_6 | Notifying the power saving information outside DRX Active |
| | time for one or more UEs |

As indicated in Table 4, the DCI formats 0_x and the DCI formats 1_x may be either a Fallback DCI format or a Non-fallback DCI format. In some aspects, a Fallback DCI format refers to a DCI format that is smaller (e.g., has fewer bits) than a Non-fallback DCI format. For example, a network entity may use a Non-fallback DCI format (as opposed to a Fallback DCI format) when the gNB needs to send more information to a UE via a DCI.

Table 4 also illustrates several examples of different RNTIs that may be used to encode the CRC of DCIs transmitted according different DCI formats. For example, a network entity uses C-RNTI or TC-RNTI to encode the CRC of DCIs transmitted using DCI format 0_0, the network entity uses C-RNTI or SP-CSI-RNTI to encode the CRC of DCIs transmitted using DCI format 0_1, and so on. Other mappings of RNTI and DCI formats may be used in other examples.

TABLE 4

| DCI | | |
|---|---|---|
| Format | DCI Info | Applicable RNTIs |
| 0_0 | Fallback UL DCI | C-RNTI, TC-RNTI |
| 0_1 | Non-fallback UL DCI | C-RNTI, SP-CSI-RNTI |
| 0_2 | Non-fallback UL DCI | C-RNTI, SP-CSI-RNTI |
| 1_0 | Fallback DL DCI | C-RNTI, SI-RNTI, P-RNTI, RA-RNTI, |
| | | MsgB-RNTI, TC-RNTI, |
| 1_1 | Non-fallback DL DCI | C-RNTI |
| 1_2 | Non-fallback DL DCI | C-RNTI |
| 2_0 | Type 3 CSS | SFI-RNTI |
| 2_1 | Type 3 CSS | INT-RNTI |
| 2_2 | Type 3 CSS | TPC-PUSCH-RNTI, |
| | | TPC-PUCCH-RNTI |
| 2_3 | Type 3 CSS | TPC-SRS-RNTI |
| 2_4 | Type 3 CSS | CI-RNTI |
| 2_5 | Type 3 CSS | AI-RNTI |
| 2_6 | Type 3 CSS | PS-RNTI |

A brief description of several of the RNTIs of Table 4 follows. A network entity uses a system information RNTI (SI-RNTI) when transmitting system information via a common search space (CSS). A network entity uses a paging RNTI (P-RNTI) when transmitting paging information via a common search space (CSS). A network entity uses a random access RNTI (RA-RNTI) when transmitting random access response (RAR) information for a random access procedure. A network entity uses a temporary cell RNTI (TC-RNTI) when scheduling a particular UE during a random access procedure. For example, the network entity may use a TC-RNTI when scheduling an uplink Msg3 retransmission or a downlink Msg4 transmission. A network entity uses a cell RNTI (C-RNTI) when scheduling a particular UE. In some aspects, a C-RNTI serves to identify an RRC connection. Thus, a network entity may transmit a DCI based on a C-RNTI via a UE-specific search space (USS).

Tables 5-9 illustrates several examples of DCI formats that may be used in some examples (e.g., some versions of 3GPP NR). Each of these tables illustrates two examples of the number of bits (bit width) for each field. Other DCI formats may be used in other examples.

Table 5 is an example of DCI format 1_0 associated with SI-RNTI (e.g., for scheduling an SI downlink transmission). As shown, Table 5 defines fields for a frequency domain resource allocation (FDRA), a time domain resource allocation (TDRA), a virtual resource block to physical resource block (VRB-PRB) mapping, a modulation and coding scheme (MCS), a redundancy vector (RV), a system information (SI) indicator, reserved bits, and cyclic redundancy check (CRC). In the Example 2 (last column) the MCS field is reduced to 4 bits and the reserved field is not used, resulting in a DCI format with 16 fewer bits.

TABLE 5

| | | |
|---|---|---|
| Field | Bit Width - Example 1 | Bit Width - Example 2 |

| | | |
|---|---|---|
| FDRA | log₂[N_{RB}(N_{RB} + 1)/2] | log₂[N_{RB}(N_{RB} + 1)/2] |
| | 9 bits for 24 RBs | 9 bits for 24 RBs |
| | (11 bits for 48 RBs) | (11 bits for 48 RBs) |

| TDRA | 4 | bits | 4 | bits |
|---|---|---|---|---|
| VRB-PRB | 1 | bit | 1 | bit |
| mapping | | | | |
| MCS | 5 | bits | 4 bits | |
| | | | Only quadrature phase shift | |
| | | | keying (QPSK) (10 first | |
| | | | entries of MCS table) | |
| RV | 2 | bits | 2 | bits |
| SI | 1 | bit | 1 | bit |
| indicator | | | | |
| Reserved | 15 | bits | 0 | bits |
| CRC | 24 | bits | 24 | bits |

| | | |
|---|---|---|
| Total bit | 61 | 45 |

width for
24 RBs

Table 6 is an example of DCI format 1_0 associated with P-RNTI (e.g., for scheduling a downlink paging transmission). As shown, Table 6 defines fields for a short message indicator, short messages, a FDRA, a TDRA, a VRB-PRB mapping, a MCS, transport block (TB) scaling, reserved bits, and CRC. In the Example 2 (last column) the short messages field is reduced to 4 bits, the MCS field is reduced to 4 bits, and the reserved field is not used, resulting in a DCI format with 11 fewer bits.

TABLE 6

| | | |
|---|---|---|
| Field | Bit Width - Example 1 | Bit Width - Example 2 |

| | | | | |
|---|---|---|---|---|
| Short Messages | 2 | bits | 2 | bits |
| Indicator | | | | |
| Short Messages | 8 | bits | 4 | bits |

| | | |
|---|---|---|
| FDRA | log₂[N_{RB}(N_{RB} + 1)/2] | log₂[N_{RB}(N_{RB} + 1)/2] |
| | 9 bits for 24 RBs | 9 bits for 24 RBs |
| | (11 bits for 48 RBs) | (11 bits for 48 RBs) |

| TDRA | 4 | bits | 4 | bits |
|---|---|---|---|---|
| VRB-PRB | 1 | bit | 1 | bit |
| mapping | | | | |
| MCS | 5 | bits | 4 bits | |
| | | | Only QPSK (10 first | |
| | | | entries of MCS table) | |
| TB scaling | 1 | bit | 1 | bit |
| Reserved | 15 | bits | 0 | bits |
| CRC | 24 | bits | 24 | bits |

| | | |
|---|---|---|
| Total bit width | 61 | 44 |

for 24 RBs

Table 7 is an example of DCI format 1_0 associated with RA-RNTI (e.g., for transmitting a RAR). As shown, Table 7 defines fields for a FDRA, a TDRA, a VRB-PRB mapping, a MCS, TB scaling, reserved bits, and CRC. In the Example 2 (last column) the MCS field is reduced to 4 bits and the reserved field is not used, resulting in a DCI format with 17 fewer bits.

TABLE 7

| | | |
|---|---|---|
| Field | Bit Width - Example 1 | Bit Width - Example 2 |

| | | |
|---|---|---|
| FDRA | log₂[N_{RB}(N_{RB} + 1)/2] | log₂[N_{RB}(N_{RB} + 1)/2] |
| | 9 bits for 24 RBs | 9 bits for 24 RBs |
| | (11 bits for 48 RBs) | (11 bits for 48 RBs) |

| TDRA | 4 | bits | 4 | bits |
|---|---|---|---|---|
| VRB-PRB | 1 | bit | 1 | bit |
| mapping | | | | |
| MCS | 5 | bits | 4 bits | |
| | | | Only QPSK (10 first | |
| | | | entries of MCS table) | |
| TB | 2 | bits | 2 | bits |
| Scaling | | | | |
| Reserved | 16 | bits | 0 | bits |
| CRC | 24 | bits | 24 | bits |

| | | |
|---|---|---|
| Total bit | 61 | 44 |

width for
24 RBs

Table 8 is an example of DCI format 1_0 associated with TC-RNTI (e.g., for scheduling a Msg4 downlink transmission). As shown, Table 8 defines fields for an identifier for DCI formats, an FDRA, a TDRA, a VRB-PRB mapping, an MCS, a new data indicator (NDI), an RV, a HARQ process #, a downlink assignment index (DAI), transmit power control (TPC) for PUCCH, a PUCCH resource indicator (PRI), the parameter K1, and CRC. In the Example 2 (last column) the DAI field in not used, resulting in a DCI format with 2 fewer bits.

TABLE 8

| Field | Bit Width - Example 1 | | Bit Width - Example 2 | |
|---|---|---|---|---|
| Identifier of | 1 | bit | 1 | bit |
| DCI formats | | | | |
| FDRA | log₂[N_{RB}(N_{RB} + 1)/2] | | log₂[N_{RB}(N_{RB} + 1)/2] | |
| | 9 bits for 24 RBs | | 9 bits for 24 RBs | |
| | (11 bits for 48 RBs) | | (11 bits for 48 RBs) | |
| TDRA | 4 | bits | 4 | bits |
| VRB-PRB | 1 | bit | 1 | bit |
| mapping | | | | |
| MCS | 5 | bits | 5 | bits |
| NDI | 1 | bit | 1 | bit |
| RV | 2 | bits | 2 | bits |
| HARQ process # | 4 | bits | 4 | bits |
| DAI | 2 | bits | reserved | |
| TPC for PUCCH | 2 | bits | 2 | bits |
| PRI | 3 | bits | 3 | bits |
| K1 | 3 | bits | 3 | bits |
| CRC | 24 | bits | 24 | bits |
| Total bit width | 61 | | 59 | |
| for 24 RBs | | | | |

Table 9 is an example of DCI format 0_0 associated with TC-RNTI (e.g., for scheduling a Msg3 uplink retransmission). As shown, Table 9 defines fields for an identifier for DCI formats, an FDRA, a TDRA, a frequency hopping flag, an MCS, an NDI, an RV, a HARQ process #, transmit power control (TPC) for PUSCH, an uplink/supplemental uplink (UL/SUL) indicator, padding, and CRC. In the Example 2 (last column) the NDI, HARQ process #, UL/SUL indicator, and padding fields might not be used, resulting in a DCI format with 13 fewer bits.

TABLE 9

| Field | Bit Width - Example 1 | | Bit Width - Example 2 | |
|---|---|---|---|---|
| Identifier of DCI | 1 | bit | 1 | bit |
| formats | | | | |
| FDRA | log2[N_{RB}(N_{RB} + 1)/2] | | log2[N_{RB}(N_{RB} + 1)/2] | |
| | 9 bits for 24 RBs | | 9 bits for 24 RBs | |
| | (11 bits for 48 RBs) | | (11 bits for 48 RBs) | |
| TDRA | 4 | bits | 4 | bits |
| Freq hopping flag | 1 | bit | 1 | bit |
| MCS | 5 | bits | 5 | bits |
| NDI | 1 | bit | 0 | bits; reserved |
| RV | 2 | bits | 2 | bits |
| HARQ process # | 4 | bits | 0 | bits; reserved |
| TPC for PUSCH | 2 | bits | 2 | bits |
| UL/SUL indicator | 1 | bit | 0 | bits; reserved |
| Padding | 7 bits (depends on | | 0 bits (depends on | |
| | DCI format 1_0) | | DCI format 1_0) | |
| CRC | 24 | bits | 24 | bits |

| | | |
|---|---|---|
| Total bit width | 61 | 48 |
| for 24 RBs | | |

As discussed above, a network entity may transmit a DCI via a search space (SS), whereby a UE can detect the DCI by monitoring the SS. Table 10 illustrates several search space sets (CSS and USS sets) that may be used in some examples (e.g., some versions of 3GPP NR). Other SS sets may be used in other examples.

TABLE 10

| DCI format(s) | Search Space Sets |
|---|---|
| DCI format 1_0 | Type0-PDCCH CSS set configured by pdcch-ConfigSIB1 |
| | in MIB or by searchSpaceSIBI in PDCCH-ConfigCommon |
| | or by searchSpaceZero in PDCCH-ConfigCommon for a |
| | DCI format with CRC scrambled by an SI-RNTI on the |
| | primary cell of the MCG |
| DCI format 1_0 | Type0A-PDCCH CSS set configured by |
| | searchSpaceOtherSystemInformation in PDCCH- |
| | ConfigCommon for a DCI format with CRC scrambled by |
| | an SI-RNTI on the primary cell of the MCG |
| DCI format 1_0 or 0_0 | Type1-PDCCH CSS set configured by ra-SearchSpace in |
| | PDCCH-ConfigCommon for a DCI format with CRC |
| | scrambled by an RA-RNTI, a MsgB-RNTI, or a TC-RNTI |
| | on the primary cell of the MCG |
| DCI format 1_0 | Type2-PDCCH CSS set configured by pagingSearchSpace |
| | in PDCCH-ConfigCommon for a DCI format with CRC |
| | scrambled by a P-RNTI on the primary cell of the MCG |
| DCI format 2_x, 1_0, | Type3-PDCCH CSS set configured by SearchSpace in |
| or 0_0 | PDCCH-ConfigCommon with searchSpaceType = common |
| | for DCI formats with CRC scrambled by an INT-RNTI, |
| | SFI-RNTI, TPC-PUSCH-RNTI, TPC-PUCCH-RNTI, TPC- |
| | SRS-RNTI, or CI-RNTI and, only for the primary cell, C- |
| | RNTI, MCS-C-RNTI, CS-RNTI(s), or PS-RNTI |
| DCI format 1_0, 0_0, | USS set configured by SearchSpace in PDCCH- |
| 1_1, 0_1, 1_2, or 0_2 | ConfigCommon with searchSpaceType = ue-Specific for |
| | DCI formats with CRC scrambled by C-RNTI, MCS-C- |
| | RNTI, SP-CSI-RNTI, CS-RNTI(s), SL-RNTI, SL-CS- |
| | RNTI, or SL Semi-Persistent Scheduling V-RNTI |

To improve the efficiency of the blind decoding process performed by a UE, a base station may use up to a specified number of DCI sizes for transmitting DCI. Thus, a UE may limit its blind decoding to these DCI sizes. Is some examples, a wireless communication standard may specify the number of DCI sizes to be used. For example, some versions of 3GPP NR use a maximum of 4 DCI sizes (e.g., with a maximum of 3 DCI sizes for C-RNTI). As another example, 3GPP 6G may use a maximum of 5 DCI sizes.

To support a maximum number of DCI sizes, a network entity may perform DCI size alignment when transmitting DCI. Table 11 illustrates an example of DCI size alignment that may be used in some examples (e.g., some versions of 3GPP NR). Other DCI size alignment procedures may be used in other examples.

```
TABLE 11
- N1 = Size of DCI format 1_0 in CSS based on CORESET0 / Initial DL BWP
  - Zero-pad or truncate DCI format 0_0 in CSS based on initial UL BWP to match
N1
- N2 = Max{size of DCI format 1_0 in USS, size of DCI format 0_0 in USS}
  - Based on active DL/UL BWP
- N3 = Size of DCI format 1_1 in USS based on Active DL BWP
  - If N3 = = N2, increment N3
- N4 = Size of DCI format 0_1 in USS based on Active UL BWP
  - If N4 = = N2, increment N4
If the 4 values above are all different (i.e., there are more than 3 DCI sizes for C-
RNTI) or if there are more than 4 DCI sizes overall (e.g., by also considering DCI
formats 2_x in CSS for other RNTIs:
  - Remove the 1 bit padding (if any) for N3 and N4 described above
  - Set N2 = N1
    - For DCI format 1_0 in USS, the DCI size is now determined based on the
CORESET0 /
      Initial DL BWP (instead of the active DL BWP)
    - Zero-pad or truncate DCI format 0_0 in USS based on initial UL BWP to match
N2 = N1
```

Among downlink (DL) channels, PDCCHs that schedule PDSCH RMSI (DCI format 1_0 with CRC scrambled with SI-RNTI monitored in Type0 CSS) have been identified as a coverage bottleneck. If, due to such a bottleneck, a UE fails to successfully decode the SI transmitted by a network entity, communication performance at the UE may be degraded.

One technique that has been proposed for addressing this bottleneck is using PDCCH repetition for PDCCH RMSI to increase the coverage. However, the transmission of repetitions uses more resources and energy. Thus, there are performance tradeoffs with such an approach.

The disclosure relates in some aspects to at least one DCI format for initial access that has a smaller size than other DCI formats. In some aspects, reducing the DCI payload size in this way provides a more effective approach for addressing bottleneck issues (e.g., a more resource/energy efficient approach) as compared to PDCCH repetition. For example, by using a smaller DCI, better coverage may be achieved as compared to using a larger DCI.

In NR, the same DCI format 1_0 that can schedule PDSCH for C-RNTI is used for SI-RNTI, P-RNTI, RA-RNTI, and TC-RNTI based DCI transmissions as well. In addition, the same DCI format 0_0 that can schedule PUSCH for C-RNTI is used for TC-RNTI based DCI transmission.

The disclosure relates in some aspects to at least one DCI format with a reduced size that can be used for initial access operations including SI-related communication (e.g., DCI with CRC scrambled with a particular RNTI such as SI-RNTI), paging-related communication (e.g., DCI scrambled with P-RNTI), and random access-related communication (e.g., DCI scrambled with RA-RNTI or TC-RNTI). This stands in contrast with DCI format IC defined for 3GPP LTE that is dedicated for only SI-RNTI, P-RNTI, and RA-RNTI. Notably, in contrast with DCI format IC, the disclosed compact DCI format supports TC-RNTI. Thus, the compact DCI format fully supports initial access operations including DCI format 0_0 with TC-RNTI for scheduling the retransmission of Msg3, and DCI format 1_0 with TC-RNTI for scheduling Msg4.

Of note, the coverage of DCI with CRC scrambled with TC-RNTI is important since it is used during initial access. For DCI format 0_0 with TC-RNTI (scheduling a retransmission of Msg3), this DCI format can be size-aligned to the compact broadcast DCI used for SI-RNTI, P-RNTI, and RA-RNTI DCI format. Thus, the main DCI format may support SI-RNTIs, P-RNTIs, and RA-RNTIs used to schedule PDSCH and a TC-RNTI used to schedule PUSCH (Msg3 retransmission).

For DCI format 1_0 with TC-RNTI (scheduling Msg4), it might not be possible to compress this DCI as much as the other 4 DCIs (SI-RNTI, P-RNTI, RA-RNTI, UL DCI with TC-RNTI). Two example implementations for this DCI follow.

In a first implementation (e.g., Option 1), DCI format 1_0 with TC-RNTI is not size aligned to the broadcast DCI described above. Instead a second compact broadcast DCI format with a reduced size (˜40 bits including CRC) is used for TC-RNTI for DCI format 1_0 (DL fallback DCI for monitoring DCI that schedules Msg4). This second DCI size only needs to be monitored during initial access since RRC-connected UEs do not need to monitor the second compact broadcast DCI. In this case, the main compact DCI format supports SI-RNTI, P-RNTI, and RA-RNTI, and DCI format 0_0 for TC-RNTI and the second compact DCI format supports DCI format 1_0 for TC-RNTI.

In a second implementation (e.g., Option 2), all five of the DCIs (the SI-RNTI, the P-RNTI, the RA RNTI, and the two TC-RNTIs) are sized matched. Thus, in this case, the main compact DCI format supports SI-RNTI, P-RNTI, RA-RNTI, DCI format 0_0 for TC-RNTI, and DCI format 1_0 for TC-RNTI. In this example, the size is slightly increased (e.g., approximately 40 bits including CRC).

The disclosure also relates in some aspects to compression techniques for achieving the compact DCI format. Many of the bits in the NR DCI formats described above are unused (reserved) when the DCI has a CRC scrambled with SI-RNTI, P-RNTI, RA-RNTI, or TC-RNTI. In the compact DCI format (with a much smaller size) for initial access, the reserved bits are not needed. In addition, some fields can be compressed to further reduce the DCI size for the new DCI format. For example, MCS and RV fields may be jointly compressed. This stands in contrast with DCI format 1C that does not employ this compression technique (e.g., no RV information provided). In addition, the CRC length can be reduced to further reduce the DCI size for the compact DCI format. In some examples, the DCI size (including CRC) can be reduced by roughly one half, which provides an approximately 3 dB coverage gain.

The disclosure also relates in some aspects to supporting a maximum of four DCI sizes along with the compact DCI format for initial access. In contrast, LTE specifies that a UE needs to monitor five DCI sizes. By reducing the number of DCI sizes that a UE is required to monitor, the blind decoding operations of the UE may be more efficient.

A UE may monitor the compact DCI during RRC-connected mode in CSS. A UE may monitor P-RNTI in RRC-connected mode once per modification period for an SI change indication. A UE may monitor SI-RNTI after receiving an indication of SI change, or if the UE has not stored a valid version of SIB1, or when the timer T311 is running (RRC connection re-establishment is initiated). A UE may monitor RA-RNTI for contention based random access (CBRA) and/or contention free random access (CFRA). A UE may monitor TC-RNTI for CBRA for a Msg3 retransmission. While the requirements for monitoring P-RNTI and SI-RNTI can be relaxed (e.g., the network can provide SIB1 by dedicated signaling in the future), for RA-RNTI as well as TC-RNTI (for Msg3 retransmission) in CBRA, monitoring in CSS may still be needed.

However, RRC-connected UEs do not need to monitor DCI format 1_0 with TC-RNTI since scheduling of Msg4 is not needed in this case. Thus, the second compact DCI may be used only for initial access in Option 1 (RRC-connected UEs do not need to monitor the second broadcast compact DCI). Accordingly, since fallback DL/UL DCI formats (0_0/1_0) in CSS need not be monitored, the maximum number of DCI sizes may be four (not five).

In view of the above, the disclosure relates in various aspects to enhancing coverage of all PDCCH communication during initial access by using one or two DCI formats that are compact for broadcast scheduling (in CSS). The compact DCI format may be used for PDCCH for scheduling RMSI/SIB1 or other system information (SI-RNTI), paging (P-RNTI), RAR (RA-RNTI, MsgB-RNTI), Msg3 retransmission (TC-RNTI), and Msg4 (TC-RNTI). In addition, the impact on RRC-connected UEs with respect to the number of DCI sizes that the UE needs to monitor may be mitigated.

Various techniques may be employed in conjunction with the use of a compact DCI format. Several examples of these techniques follow.

In a first example, instead of using a single compact DCI size (e.g., in NR) for SI-RNTI, P-RNTI, RA-RNTI, and TC-RNTI for fallback DCI monitoring in CSS, two DCI sizes are introduced. A first DCI size is used for SI-RNTI, P-RNTI, RA-RNTI, and TC-RNTI for Msg3 retransmission scheduling. A second DCI size is for TC-RNTI for Msg4 scheduling. Both of these DCI sizes, especially the first DCI size, are smaller than the single DCI size used in NR, resulting in improved coverage for fallback DCI in CSS. The second DCI size is used for idle UEs and, hence, does not increase the total DCI size limit at a given time.

In a second example, the SI indicator (e.g., that indicates whether the scheduled PDSCH is RMSI, SIB1, other SIBs, or an SI message) is removed from the fallback DCI with SI-RNTI. The SI indicator may be alternatively signaled without additional DCI overhead. For example, the SI indicator may be signaled via a dedicated RNTI or in PDSCH.

In a third example, for fallback DCI with SI-RNTI and TC-RNTI, the code rate and the RV can be jointly encoded. In this way, fewer bits of the DCI can be used to indicate the code rate and the RV (e.g., as opposed to an approach that uses two separate fields for separately indicating the code rate and the RV).

In a fourth example, the “short messages indicator” field and the dedicated field for “short messages” is removed from the fallback DCI with P-RNTI and RA-RNTI. The “short messages indicator” and the “short messages” can be alternatively signaled without additional DCI overhead, e.g., via FDRA.

In a fifth example, for fallback DCI with P-RNTI, instead of using an existing shared MCS table and a TB scaling field, a dedicated shorter MCS table which includes lower code rates can be used. Thus, fewer bits of the DCI can be used for signaling MCS.

In a sixth example, for fallback DCI with TC-RNTI for scheduling a retransmission of Msg3, the same TBS that was used for the initial Msg3 transmission may be used for the retransmission. Thus, the MCS field may be removed from this fallback DCI.

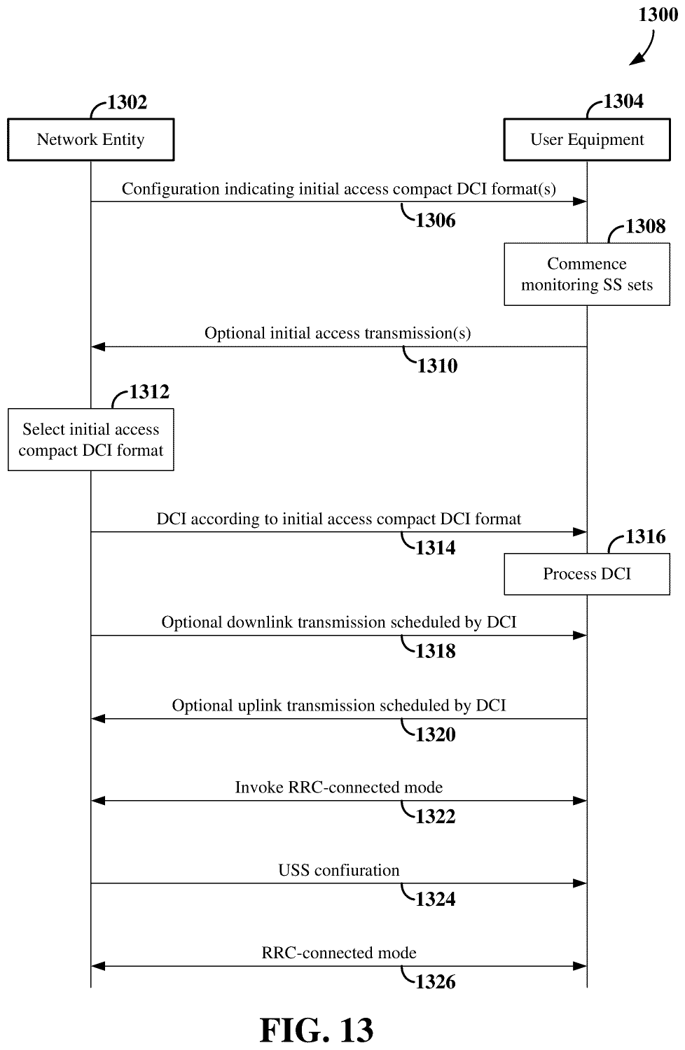

Further to the above, FIG. 13 is a signaling diagram 1300 illustrating an example of DCI-related signaling in a wireless communication system including a network entity 1302 and a UE 1304. In some examples, the network entity 1302 may correspond to any of the network entities, base stations, CUs, DUs, RUs, or scheduling entities shown in any of FIGS. 1, 2, 3, 4, 7, 11, 12, 15, 16, 17, 18, 19, 20, and 23. In some examples, the UE 1304 may correspond to any of the UEs or scheduled entities shown in any of FIGS. 1, 2, 3, 4, 7, 11, 12, 15, 16, 17, 18, 19, 20, and 21.

In some aspects, #1306-#1320 of FIG. 13 may be associated with initial access. For example, during this time the UE 1304 may be in RRC-IDLE mode or RRC-INACTIVE mode.

At #1306, the network entity 1302 may send configuration information to the UE 1304. In some examples, the configuration information may be for at least one compact DCI format for initial access. In some examples, the configuration information may indicate CORESET and search space (SS) configurations that the UE 1304 is to use for receiving information from the network entity 1302. For example, a CORESET configuration may specify the RBs and the number of symbols for each CORESET. In addition, an SS configuration may specify, for each configured SS set, the associated CORESET, PDCCH monitoring occasion (MO) information, PDCCH candidates, and so on. The configuration information may include other information as well. In some examples, the configuration information may be sent via a MIB, PDCCH-ConfigCommon, PDCCH-Config, or in some other manner.

At #1308, the UE 1304 repeatedly monitors the configured SS sets to determine whether the network entity 1302 has transmitted any messages to the UE 1304. In some aspects, this may involve blind decoding for PDCCH candidates in a common search space (CSS) as discussed herein.

At optional #1310, in some scenarios (e.g., during a random access procedure) the UE 1304 may transmit a message to the network entity 1302. For example, the UE 1304 may transmit a PRACH preamble to the network entity 1302 to obtain network access.

At #1312, at some point in time, the network entity 1302 may select a DCI format to use for an initial access operation. For example, in a scenario where one compact DCI format is specified for initial access, the network entity 1302 may select that compact DCI format. As another example, in a scenario where two compact DCI formats are specified for initial access, the network entity 1302 may select one of those compact DCI formats depending on what needs to be scheduled. For example, the network entity 1302 may select the larger of the two compact DCI formats when scheduling a Msg4 transmission, and select the smaller of the two compact DCI formats otherwise.

At #1314, the network entity 1302 sends a DCI formatted according to the selected compact DCI format to the UE 1304. The DCI includes scheduling information for scheduling at least one transmission. For example, the network entity may send a DCI with CRC scrambled by an SI-RNTI to schedule an SI transmission. As another example, the network entity may send a DCI with CRC scrambled by a P-RNTI to schedule paging. As another example, the network entity may send a DCI with CRC scrambled by an RA-RNTI to schedule a RAR transmission. As another example, the network entity may send a DCI with CRC scrambled by a TC-RNTI to schedule a Msg3 retransmission. As another example, the network entity may send a DCI with CRC scrambled by a TC-RNTI to schedule a Msg4 transmission.

At #1316, as a result of monitoring the SS sets, the UE 1304 decodes the DCI and obtains the scheduling information included in the DCI.

At #1318, if the DCI scheduled a downlink transmission (e.g., SI, paging, RAR, Msg4), the UE 1304 receives the corresponding downlink transmission from the network entity 1302 according to the scheduling information included in the DCI.

At #1320, if the DCI scheduled an uplink transmission (e.g., Msg3 retransmission), the UE 1304 transmits the corresponding uplink transmission to the network entity 1302 according to the scheduling information included in the DCI.

At #1322, the UE 1304 and the network entity 1302 establish an RRC connection. Thus, the UE 1304 transitions from an initial access mode (e.g., RRC-IDLE mode or RRC-INACTIVE mode) to an RRC-CONNECTED mode.

At #1324, the network entity 1302 sends UE-specific search space (USS) configuration information to the UE 1304.

At #1326, the UE 1304 and the network entity 1302 maintain the RRC connection until the UE 1304 transitions back to an initial access mode (e.g., RRC-IDLE mode or RRC-INACTIVE mode).

Option 1 and Option 2 mentioned above will now be described in more detail.

In Option 1, a first broadcast DCI size (NO=˜ 30 bits including CRC) in CSS is based on CORESET0/initial BWP. For DL DCI format (1_0) with SI-RNTI/P-RNTI/RA-RNTI and UL DCI format (0_0) with TC-RNTI, zero-padding is performed across these four DCIs, if needed. NO is the maximum length across these four DCIs.

In addition, a second broadcast DCI size (NOA=˜ 40 bits including CRC) in CSS is based on CORESET0/initial BWP that is only monitored in RRC-idle/inactive. That is, RRC-connected UEs do not monitor this DCI.

In some aspects, the set of DCI formats (and the number of DCI sizes) that a UE monitors may be different for: (1) initial access (RRC-idle and RRC-inactive); (2) an RRC-connected UE before receiving USS configurations; and (3) an RRC-connected UE after receiving USS configurations.

For example, in (1), for a UE during initial access (RRC-idle/inactive), the UE monitors two DCI sizes. These DCI sizes may be referred to as the first broadcast DCI size (NO) and the second broadcast DCI size (NOA).

In (2), for an RRC-connected UE before receiving USS configurations, the UE monitors 2 (or 3) DCI sizes. For broadcast DCI size in CSS (NO) for SI-RNTI/P-RNTI/RA-RNTI/TC-RNTI, in the case of carrier aggregation (CA), the UE only monitors this DCI in the primary cell (PCell).

For fallback DL/UL DCIs (0_0/0_1) in CSS (N1) for C-RNTI, the monitored DCI size is based on N1=Size of DCI format 1_0 in CSS based on the active BWP.

Finally, one or more sizes may be defined for Type 3 CSS for DCI formats 2_x for other RNTIs.

In (3), for an RRC-connected UE after receiving USS configurations, the UE monitors the four DCI sizes. The first DCI size is a broadcast DCI size in CSS (NO) for SI-RNTI/P-RNTI/RA-RNTI/TC-RNTI. In case of CA, the UE only monitors this DCI in the PCell.

The second DCI size is for fallback DL/UL DCIs (0_0/0_1) in USS (N2) for C-RNTI. Here, the DCI size is based on N2=Max {size of DCI format 1_0 in USS, size of DCI format 0_0 in USS} based on the active BWP.

The third DCI size is for non-fallback DL DCI (1_1) in USS based on the active BWP (N3) for C-RNTI.

The fourth DCI size is for non-fallback UL DCI (0_1) in USS based on the active BWP (N4) for C-RNTI.

In Option 2, one broadcast DCI size (N0˜40 bits including CRC) in CSS is based on CORESET0/initial BWP. For DL DCI format (1_0) with SI-RNTI/P-RNTI/RA-RNTI/TC-RNTI and UL DCI format (0_0) with TC-RNTI, zero-padding is performed across these five DCIs, if needed. NO is the maximum length across these five DCIs. NO is larger in this option (N0˜40 bits including CRC) as compared to Option 1.

Similar to Option 1, in Option 2 the set of DCI formats (and the number of DCI sizes) that a UE monitors may be different for: (1) initial access (RRC-idle and RRC-inactive); (2) an RRC-connected UE before receiving USS configurations; and (3) an RRC-connected UE after receiving USS configurations.

For example, in (1), for a UE during initial access (RRC-idle/inactive), the UE monitors one DCI size. This DCI size may be referred to as the first broadcast DCI size (NO).

In (2), for an RRC-connected UE before receiving USS configurations, the UE monitors 2 (or 3) DCI sizes. For broadcast DCI size in CSS (NO) for SI-RNTI/P-RNTI/RA-RNTI/TC-RNTI, in case of CA, the UE only monitors this DCI in the PCell.

For fallback DL/UL DCIs (0_0/0_1) in CSS (N1) for C-RNTI, the monitored DCI size is based on N1=Size of DCI format 1_0 in CSS based on the active BWP.

Finally, one or more sizes may be defined for Type 3 CSS for DCI formats 2_x for other RNTIs.

In (3), for an RRC-connected UE after receiving USS configurations, the UE monitors up to four DCI sizes. The first DCI size is a broadcast DCI size in CSS (NO) for SI-RNTI/P-RNTI/RA-RNTI/TC-RNTI. In case of CA, the UE only monitors this DCI in the PCell.

The second DCI size is for fallback DL/UL DCIs (0_0/0_1) in USS (N2) for C-RNTI. Here, the DCI size is based on N2=Max {size of DCI format 1_0 in USS, size of DCI format 0_0 in USS} based on the active BWP.

The third DCI size is for non-fallback DL DCI (1_1) in USS based on the active BWP (N3) for C-RNTI.

The fourth DCI size is for non-fallback UL DCI (0_1) in USS based on the active BWP (N4) for C-RNTI.

In some aspects, a UE does not need to monitor fallback DCI for C-RNTI in CSS (to save one DCI size). That is, the compact broadcast DCI format(s) may be dedicated to SI/P/RA/TC-RNTIs and not C-RNTI.

In this case, there is no need to perform the NR DCI size alignment as discussed above (4 total DCI sizes, 3 DCI sizes for C-RNTI). Thus, there is no need to obtain the size of fallback DCIs 1_0/0_0 in USS based on CORESET0/initial BWP (there is no N1, hence no need to match N2=N1). Fallback DCIs in USS are based on the active BWP. This may provide more flexibility when the network uses fallback DCI.

However, the above assumes all other RNTIs used for Type3 CSS (i.e., GC DCI formats 2_x including INT-RNTI, SFI-RNTI, TPC-PUSCH-RNTI, TPC-PUCCH-RNTI, TPC-SRS-RNTI, CI-RNTI) can be size matched to the first broadcast DCI. That is, they should not have a size greater than NO, and if they have a smaller size, zero-padding is done for them to align the size. This can be a limitation to provide flexibility for DCI formats 2_x.

Two example approaches for addressing the above NO size limit issue follow.

The first approach involves alignment of the size of non-fallback DL DCI (1_1) in USS for C-RNTI and non-fallback UL DCI (0_1) in USS for C-RNTI. Here, N3=N4: 1) one broadcast DCI size (NO)+2) one DCI size for DL/UL fallback DCIs in USS (N2) for C-RNTI+3) one DCI size for DL/UL non-fallback DCIs in USS (N3=N4) for C-RNTI+4) a fourth DCI size for Type3 CSS. This can be done only on the PCell given that the broadcast DCI (with size NO) may need to be monitored only on the PCell. N3 and N4 may be kept separate in the SCell as a UE does not monitor the broadcast DCI (NO). This satisfies the existing NR limit of four DCI sizes in total and three DCI sizes for C-RNTI.

The second approach is based on the proposed 3GPP 6G limit of five total DCI sizes: NO, N2, N3, N4, and N5 (additional DCI size for Type3 CSS (for DCI format 2_x)). This goes beyond the NR limit, but may be needed in the PCell (the SCell can be same as NR, i.e., four DCI sizes total and three DCI sizes for C-RNTI).

As one option, up to three of these sizes can be monitored for C-RNTI (N2, N3, N4)+two sizes for other RNTIs (NO, N5).

As another option, up to four of these sizes can be monitored for C-RNTI (N2, N3, N4, N5). That is, N5 can be monitored for both Type3 CSS and for C-RNTI for fallback DCIs (1_0/0_0) in CSS. In this option, N5 is the same as N1 in legacy (fallback DCI in CSS) and the size of DCI format 2_x in Type3 CSS is same as N1, but the difference compared to legacy is the introduction of NO specific to broadcast.

As mentioned above, the disclosure relates in some aspects to compression techniques for achieving the compact DCI format. These techniques will now be discussed in more detail.

Three techniques are disclosed for compressing DCI format 1_0 with SI-RNTI. The first technique involves TDRA compression, the second technique involves SI indicator removal, and the third technique involves a joint code rate and RV.

In the TDRA compression technique, the TDRA of RMSI PDSCH is determined based on an associated SSB location as well as the location of where the scheduling DCI is received. This applies to, for example, CORESET0 multiplexing pattern 2 or 3 (in FR2, where RMSI is time-overlapping with SSB due to analog beamforming). The TDRA field of the DCI may also indicate one possibility among a limited number of possibilities determined from SSB location/location of DCI, where the limited number can be much smaller (e.g., 2 or even 1) as compared to the possibilities indicated by a conventional TDRA table as shown, for example, in Tables 12 and 13 below.

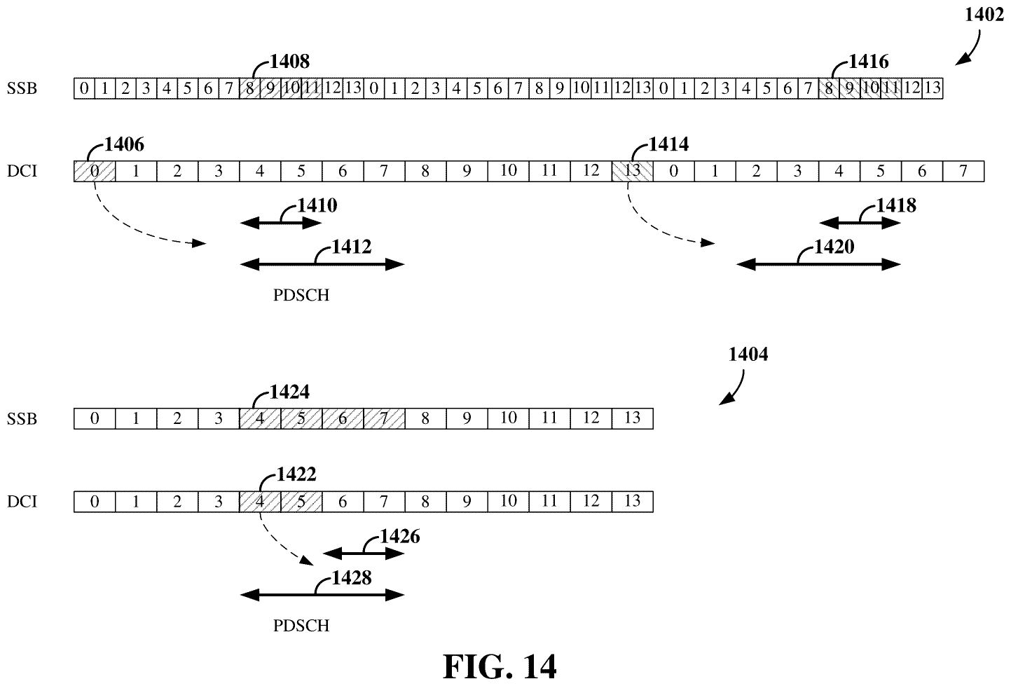

FIG. 14 illustrates a first example 1402 and a second example 1404 of how a TDRA field (e.g., one bit) may be used to indicate one of two possibilities for TDRA. The first example 1402 relates to TDRA for Mux Pattern 2: (240, 120) kHz. The second example 1404 relates to TDRA for Mux Pattern 3: (120, 120) kHz.

In the first example 1402, the TDRA of an RMSI PDSCH may be determined based on a location 1406 of where the scheduling DCI is received and an associated SSB location 1408. In this case, a TDRA field (e.g., one bit) may be used to indicate one of two possibilities 1410 or 1412 for TDRA. Similarly, the TDRA of an RMSI PDSCH may be determined based on a location 1414 of where the scheduling DCI is received and an associated SSB location 1416. Again, a TDRA field (e.g., one bit) may be used to indicate one of two possibilities 1418 or 1420 for TDRA. Thus, one bit in the DCI may be used to indicate a TDRA as opposed to four bits that would be used if the TDRA table shown in Table 12 was used to indicate a TDRA.

Table 12 is an example of a Default PDSCH time domain resource allocation B for some versions of 3GPP NR.

TABLE 12

| | dmrs- | PDSCH | | | |
|---|---|---|---|---|---|
| | TypeA- | mapping | | | |
| Row index | Position | type | K₀ | S | L |
| 1 | 2, 3 | Type B | 0 | 2 | 2 |
| 2 | 2, 3 | Type B | 0 | 4 | 2 |
| 3 | 2, 3 | Type B | 0 | 6 | 2 |
| 4 | 2, 3 | Type B | 0 | 8 | 2 |
| 5 | 2, 3 | Type B | 0 | 10 | 2 |
| 6 | 2, 3 | Type B | 1 | 2 | 2 |
| 7 | 2, 3 | Type B | 1 | 4 | 2 |
| 8 | 2, 3 | Type B | 0 | 2 | 4 |
| 9 | 2, 3 | Type B | 0 | 4 | 4 |
| 10 | 2, 3 | Type B | 0 | 6 | 4 |
| 11 | 2, 3 | Type B | 0 | 8 | 4 |
| 12 (Note 1) | 2, 3 | Type B | 0 | 10 | 4 |
| 13 (Note 1) | 2, 3 | Type B | 0 | 2 | 7 |
| 14 (Note 1) | 2 | Type A | 0 | 2 | 12 |
| | 3 | Type A | 0 | 3 | 11 |
| 15 | 2, 3 | Type B | 1 | 2 | 4 |

| | |
|---|---|
| 16 | Reserved |

(Note 1):
If the PDSCH was scheduled with SI-RNTI in PDCCH Type0 common search space, the UE may assume that this PDSCH resource allocation is not applied

In the second example 1404 of FIG. 14, the TDRA of an RMSI PDSCH may be determined based on a time-domain location 1422 of where the scheduling DCI is received and an associated time-domain SSB location 1424. In this case, a TDRA field (e.g., one bit) may be used to indicate one of two possibilities 1426 or 1428 for TDRA. Thus, one bit in the DCI may be used to indicate a TDRA as opposed to four bits that would be used if the TDRA table shown in Table 13 was used to indicate a TDRA.

Table 13 is an example of a Default PDSCH time domain resource allocation C for some versions of 3GPP NR.

TABLE 13

| | dmrs- | PDSCH | | | |
|---|---|---|---|---|---|
| | TypeA- | mapping | | | |
| Row index | Position | type | K₀ | S | L |
| 1 (Note 1) | 2, 3 | Type B | 0 | 2 | 2 |
| 2 | 2, 3 | Type B | 0 | 4 | 2 |
| 3 | 2, 3 | Type B | 0 | 6 | 2 |
| 4 | 2, 3 | Type B | 0 | 8 | 2 |
| 5 | 2, 3 | Type B | 0 | 10 | 2 |
| 6 | Reserved | | | | |
| 7 | Reserved | | | | |
| 8 | 2, 3 | Type B | 0 | 2 | 4 |
| 9 | 2, 3 | Type B | 0 | 4 | 4 |
| 10 | 2,3 | Type B | 0 | 6 | 4 |
| 11 | 2, 3 | Type B | 0 | 8 | 4 |
| 12 | 2, 3 | Type B | 0 | 10 | 4 |
| 13 (Note 1) | 2, 3 | Type B | 0 | 2 | 7 |
| 14 (Note 1) | 2 | Type A | 0 | 2 | 12 |
| | 3 | Type A | 0 | 3 | 11 |
| 15 (Note 1) | 2, 3 | Type A | 0 | 0 | 6 |
| 16 (Note 1) | 2, 3 | Type A | 0 | 2 | 6 |

(Note 1):
The UE may assume that this PDSCH resource allocation is not used, if the PDSCH was scheduled with SI-RNTI in PDCCH Type0 common search space

Referring again to the six examples mentioned above, in the second example (SI indicator removal), the SI indicator (indicating whether the scheduled PDSCH is RMSI, SIB1, other SIBs, or an SI message) is removed from the DCI. In this case, the SI indicator information may be indicated to a UE in other ways.

In one example, the SI indicator information may be indicated in the PDSCH scheduled by the DCI. For soft-combining of RMSI PDSCH/SIB1, the UE may determine whether the scheduled PDSCH is SIB1 or not based on the transport block size (TBS) (e.g., for scenarios where the network allocates different TBSs for SIB1 versus other SIBs).

In another example, the SI indicator information may be indicated (implicitly) based on the RNTI. For example, SI-RNTI or SIB1-RNTI may be used for scheduling SIB1 PDSCH and another RNTI (e.g. OSI-RNTI) is used for scheduling other SIBs.

In the third example (joint code rate and RV) mentioned above, the code rate and RV are jointly indicated such that the number of possible RVs for lower code rates is smaller than number of possible RVs for a higher code rate (that is, there is no or limited benefit for signaling RV among all four possible RVs when the code rate is small). In some examples, the modulation order is fixed to 2 (QPSK) which resulted in 23 possibilities (which can be indicate using 5 bits). In some examples, a joint field indicates both RV and code rate (and modulation order is fixed to QPSK, thus, there is no need to indicate the modulation order). More RV possibilities may be used for higher code rates (e.g., as shown in the tables herein).

The joint code rate and RV technique is also applicable to TC-RNTI for DCI format 1_0.

Table 14 is an example of an MCS index table 1 for PDSCH for some versions of 3GPP NR. Here, MCS indices 0-2 may be associated with RV0 (RV indication is not needed), MCS indices 3-6 may be associated with RV0 and RV2 (for each such MCS, one of two possible RVs can be indicated), and MCS indices 7-9 may be associated with RV0, RV2, RV1, and RV3 (for each such MCS, one of four possible RVs can be indicated).

TABLE 14

| MCS Index | Modulation Order | Target code Rate | Spectral |
|---|---|---|---|
| I_{MCS} | Qₘ | R × [1024] | efficiency |
| 0 | 2 | 120 | 0.2344 |
| 1 | 2 | 157 | 0.3066 |
| 2 | 2 | 193 | 0.3770 |
| 3 | 2 | 251 | 0.4902 |
| 4 | 2 | 308 | 0.6016 |
| 5 | 2 | 379 | 0.7402 |
| 6 | 2 | 449 | 0.8770 |
| 7 | 2 | 526 | 1.0273 |
| 8 | 2 | 602 | 1.1758 |
| 9 | 2 | 679 | 1.3262 |
| 10 | 4 | 340 | 1.3281 |
| 11 | 4 | 378 | 1.4766 |
| 12 | 4 | 434 | 1.6953 |
| 13 | 4 | 490 | 1.9141 |
| 14 | 4 | 553 | 2.1602 |
| 15 | 4 | 616 | 2.4063 |
| 16 | 4 | 658 | 2.5703 |
| 17 | 6 | 438 | 2.5664 |
| 18 | 6 | 466 | 2.7305 |
| 19 | 6 | 517 | 3.0293 |
| 20 | 6 | 567 | 3.3223 |
| 21 | 6 | 616 | 3.6094 |
| 22 | 6 | 666 | 3.9023 |
| 23 | 6 | 719 | 4.2129 |
| 24 | 6 | 772 | 4.5234 |
| 25 | 6 | 822 | 4.8164 |
| 26 | 6 | 873 | 5.1152 |
| 27 | 6 | 910 | 5.3320 |
| 28 | 6 | 948 | 5.5547 |

| | | |
|---|---|---|
| 29 | 2 | reserved |
| 30 | 4 | reserved |
| 31 | 6 | reserved |

Given the above mapping of RVs and MCS indices. Table 15 below may be used for indicating code rate and RV jointly.

TABLE 15

| Index for joint field | Code rate × 1024 | RV |
|---|---|---|
| 0 | 120 | 0 |
| 1 | 157 | 0 |
| 2 | 193 | 0 |
| 3 | 251 | 0 |
| 4 | 251 | 2 |
| 5 | 308 | 0 |
| 6 | 308 | 2 |
| . . . | . . . | . . . |
| 11 | 526 | 0 |
| 12 | 526 | 1 |
| 13 | 526 | 2 |
| 14 | 526 | 3 |
| . . . | . . . | . . . |

Table 16 illustrates an example of a DCI format 1_0 with SI-RNTI that incorporates the above compression techniques. Here, it may be seen that smaller fields may be used for FDRA and TDRA, the SI indicator may be removed, MCS and RV are indicated jointly, and the number of CRC bits is reduced.

TABLE 16

| Field | Bit Width | |
|---|---|---|
| FDRA | Unit of 4RBs with RA Type 1: | |
| | 5 bits for 24RBs | |
| | (7 bits for 48RBs) | |
| TDRA | 4/1/1 bits for Mux pattern 1/2/3 | |
| | For Mux Pattern 2/3, there are only 1 | |
| | or 2 possible TDRA due to analog | |
| | beamforming | |
| VRB-PRB | 1 | bit |
| mapping | | |
| MCS/RV | 5 bits: One or two RVs enough for | |
| | small coding rates (23 possibilities) | |
| SI indicator | 0 | bits |
| | Can be moved to PDSCH | |
| Reserved | 0 | bits |
| CRC | 16 | bits |

| | |
|---|---|
| | False alarm only results in occasional |
| | unnecessary PDSCH decoding attempt |
| | (one wrong attempt every 1.5 minutes |
| | with 2*(4 + 2 + 1) BDs in 20 ms |
| | monitoring periodicity) |
| Total bit width for 24 RBs | 31/28*/28* |
| | *minimum DCI size before CRC is 12 |
| | bits in NR |

In the fourth example mentioned above, the “short messages indicator” field and the dedicated field for “short messages” may be removed from the fallback DCI with P-RNTI. In this case, the short message information may be indicated in other ways.

For example, if the FDRA field indicates all 1's, this means that the DCI does not schedule a paging message (PDSCH) and only contains short messages. In this case, one or more of the TDRA field, the MCS field, or the VRB-PRB mapping field may be used to indicate the short messages.

Otherwise, the DCI does not include short messages and only schedules a PDSCH/paging message. In this case, if an indication of short messages is also needed (in addition to paging message), this information can be included in the PDSCH (rather than being indicated in the DCI).

This means that both the paging message (PDSCH) and the short messages (in the DCI) would not be needed at the same time.

In the fifth example mentioned above, for fallback DCI with P-RNTI and RA-RNTI, instead of using an existing shared MCS table (e.g., as shown in Table 17 below) and a TB scaling field (e.g., as shown in Table 18 below), a dedicated shorter MCS table which includes lower code rates (e.g., as shown in Table 19 below) can be used.

For example, when the CRC of the DCI is scrambled with P-RNTI or RA-RNTI, a different MCS table (e.g., MCS index table 3 with smaller code rates) may be used. Hence, there is no need for a scaling factor (inclusion of lower code rates in the new MCS table may achieve the same functionality as indicating a scaling factor). Here, the modulation order may be fixed (2=QPSK). Thus, 4 bits may be used instead of 5+2=7 bits.

Table 17 is an example of an MCS index table 1 for PDSCH for some versions of 3GPP NR.

TABLE 17

| MCS Index | Modulation Order | Target code Rate | Spectral |
|---|---|---|---|
| I_{MCS} | Qₘ | R × [1024] | efficiency |
| 0 | 2 | 120 | 0.2344 |
| 1 | 2 | 157 | 0.3066 |
| 2 | 2 | 193 | 0.3770 |
| 3 | 2 | 251 | 0.4902 |
| 4 | 2 | 308 | 0.6016 |
| 5 | 2 | 379 | 0.7402 |
| 6 | 2 | 449 | 0.8770 |
| 7 | 2 | 526 | 1.0273 |
| 8 | 2 | 602 | 1.1758 |
| 9 | 2 | 679 | 1.3262 |
| 10 | 4 | 340 | 1.3281 |
| 11 | 4 | 378 | 1.4766 |
| 12 | 4 | 434 | 1.6953 |
| 13 | 4 | 490 | 1.9141 |
| 14 | 4 | 553 | 2.1602 |
| 15 | 4 | 616 | 2.4063 |
| 16 | 4 | 658 | 2.5703 |
| 17 | 6 | 438 | 2.5664 |
| 18 | 6 | 466 | 2.7305 |
| 19 | 6 | 517 | 3.0293 |
| 20 | 6 | 567 | 3.3223 |
| 21 | 6 | 616 | 3.6094 |
| 22 | 6 | 666 | 3.9023 |
| 23 | 6 | 719 | 4.2129 |
| 24 | 6 | 772 | 4.5234 |
| 25 | 6 | 822 | 4.8164 |
| 26 | 6 | 873 | 5.1152 |
| 27 | 6 | 910 | 5.3320 |
| 28 | 6 | 948 | 5.5547 |

| | | |
|---|---|---|
| 29 | 2 | reserved |
| 30 | 4 | reserved |
| 31 | 6 | reserved |

Table 18 is an example of a scaling factor for some versions of 3GPP NR.

TABLE 18

| TB scaling field | Scaling factor S |
|---|---|
| 00 | 1 |
| 01 | 0.5 |
| 10 | 0.25 |
| 11 | |

Table 19 is an example of an MCS index table 3 for PDSCH for some versions of 3GPP NR.

TABLE 19

| MCS | Modulation | | |
|---|---|---|---|
| Index | Order | Target code Rate | Spectral |
| I_{MCS} | Qₘ | R × [1024] | efficiency |
| 0 | 2 | 30 | 0.0586 |
| 1 | 2 | 40 | 0.0781 |
| 2 | 2 | 50 | 0.0977 |
| 3 | 2 | 64 | 0.1250 |
| 4 | 2 | 78 | 0.1523 |
| 5 | 2 | 99 | 0.1934 |
| 6 | 2 | 120 | 0.2344 |
| 7 | 2 | 157 | 0.3066 |
| 8 | 2 | 193 | 0.3770 |
| 9 | 2 | 251 | 0.4902 |
| 10 | 2 | 308 | 0.6016 |
| 11 | 2 | 379 | 0.7402 |
| 12 | 2 | 449 | 0.8770 |
| 13 | 2 | 526 | 1.0273 |
| 14 | 2 | 602 | 1.1758 |
| 15 | 4 | 340 | 1.3281 |
| 16 | 4 | 378 | 1.4766 |
| 17 | 4 | 434 | 1.6953 |
| 18 | 4 | 490 | 1.9141 |
| 19 | 4 | 553 | 2.1602 |
| 20 | 4 | 616 | 2.4063 |
| 21 | 6 | 438 | 2.5664 |
| 22 | 6 | 466 | 2.7305 |
| 23 | 6 | 517 | 3.0293 |
| 24 | 6 | 567 | 3.3223 |
| 25 | 6 | 616 | 3.6094 |
| 26 | 6 | 666 | 3.9023 |
| 27 | 6 | 719 | 4.2129 |
| 28 | 6 | 772 | 4.5234 |

| | | |
|---|---|---|
| 29 | 2 | reserved |
| 30 | 4 | reserved |
| 31 | 6 | reserved |

Table 20 illustrates an example of a DCI format 1_0 with P-RNTI that incorporates the above compression techniques. Here, it may be seen that the short message fields may be removed, the size of the FDRA field may be reduced, a smaller MCS may be used, and the number of CRC bits may be reduced (e.g., as compared to other DCI formats).

TABLE 20

| Field | Bit Width | |
|---|---|---|
| Short Messages Indicator | 0 | bits |
| | FDRA can be used to indicate scheduling/ | |
| | non-scheduling DCI | |
| Short Messages | 0 | bit |
| | We do not need both short message (in DCI) | |
| | and paging message (PDSCH) at the same | |
| | time. Use TDRA/MCS field when FDRA | |
| | indicates no PDSCH is scheduled | |
| FDRA | Unit of 4RBs with RA Type 1: | |
| | 5 bits for 24RBs | |
| | (7 bits for 48RBs) | |
| TDRA | 4 | bits |
| VRB-PRB | 1 | bit |
| mapping | | |
| MCS/TB Scaling | 4 bits: Use MCS Table 3 instead | |
| Reserved | 0 | bits |
| CRC | 16 | bits |

| | |
|---|---|
| Total bit width for 24 RBs | 30 |

Table 21 illustrates an example of a DCI format 1_0 with RA-RNTI that incorporates the above compression techniques. Here, it may be seen that the size of the FDRA field may be reduced, a smaller MCS may be used, and the number of CRC bits may be reduced (e.g., as compared to other DCI formats).

TABLE 21

| | |
|---|---|
| Field | Bit Width |

| FDRA | Unit of 4RBs with RA Type 1: | |
|---|---|---|
| | 5 bits for 24RBs | |
| | (7 bits for 48RBs) | |
| TDRA | 4 | bits |
| VRB-PRB | 1 | bit |
| mapping | | |
| MCS/TB Scaling | 4 bits: Use MCS Table 3 instead | |
| Reserved | 0 | bits |
| CRC | 16 | bits |

| | |
|---|---|
| Total bit width for 24 RBs | 30 |

Table 22 illustrates an example of a DCI format 1_0 with TC-RNTI that incorporates the above compression techniques. Here, it may be seen that the size of the FDRA field may be reduced, fewer MCS/RV bits may be used, other fields may be removed, and the number of CRC bits may be reduced (e.g., as compared to other DCI formats)

TABLE 22

| | |
|---|---|
| Field | Bit Width |

| Identifier of DCI formats | 1 | bit |
|---|---|---|
| FDRA | Unit of 4RBs with RA Type 1: | |
| | 5 bits for 24RBs | |
| | (7 bits for 48RBs) | |
| TDRA | 4 | bits |
| VRB-PRB | 1 | bit |
| mapping | | |
| MCS | 5 bits combined with RV: Only QPSK, One or | |
| | two RVs enough for small coding rates (23 | |
| | possibilities) | |
| NDI | 0 | bits |
| RV | 0 bits: Combine with MCS | |
| HARQ process # | 0 | bits |
| DAI | 0 | bits |
| TPC for PUCCH | 2 | bits |
| PRI | 3 | bits |
| K1 | 3 | bits |
| CRC | 16 | bits |

| | |
|---|---|
| Total bit width for 24 RBs | 40 |

In the sixth example mentioned above, for fallback DCI with TC-RNTI for scheduling a retransmission of Msg3, the same TBS that was used for the initial Msg3 transmission may be used for the retransmission.

For example, when CRC of the DCI is scrambled with TC-RNTI for scheduling a retransmission of Msg3, the UE assumes the same TBS as the initial transmission of Msg3 (which is determined from the UL grant included in the RAR PDSCH). Here, the modulation order may be fixed (e.g., 2=QPSK). Given that the TBS is known, an indication of code rate is not needed. Also, since the modulation order can be fixed, an indication of MCS is not needed.

Table 23 illustrates an example of a DCI format 0_0 with TC-RNTI that incorporates the above compression techniques. Here, it may be seen that the size of the FDRA field may be reduced, no MCS bits are used, other fields may be reduced, and the number of CRC bits may be reduced (e.g., as compared to other DCI formats).

TABLE 23

| Field | Bit Width | |
|---|---|---|
| Identifier of DCI formats | 0 bit (under the assumption that DCI format 1_0 | |
| | with TC-RNTI has a different size) | |
| FDRA | Unit of 4RBs with RA Type 1 | |
| | 5 bits for 24RBs | |
| | (7 bits for 48RBs) | |
| TDRA | 4 | bits |
| Freq hopping flag | 1 | bit |
| MCS | 0 bits: TBS already known (from RAR UL grant) | |
| | and QPSK assumed | |
| NDI | 0 | bits |
| RV | 2 | bits |
| HARQ process # | 0 | bits |
| TPC for PUSCH | 2 | bits |
| UL/SUL indicator | 0 | bits |
| Padding | 0 | bits |
| CRC | 16 | bits |

| | |
|---|---|
| Total bit width for 24 RBs | 30 |

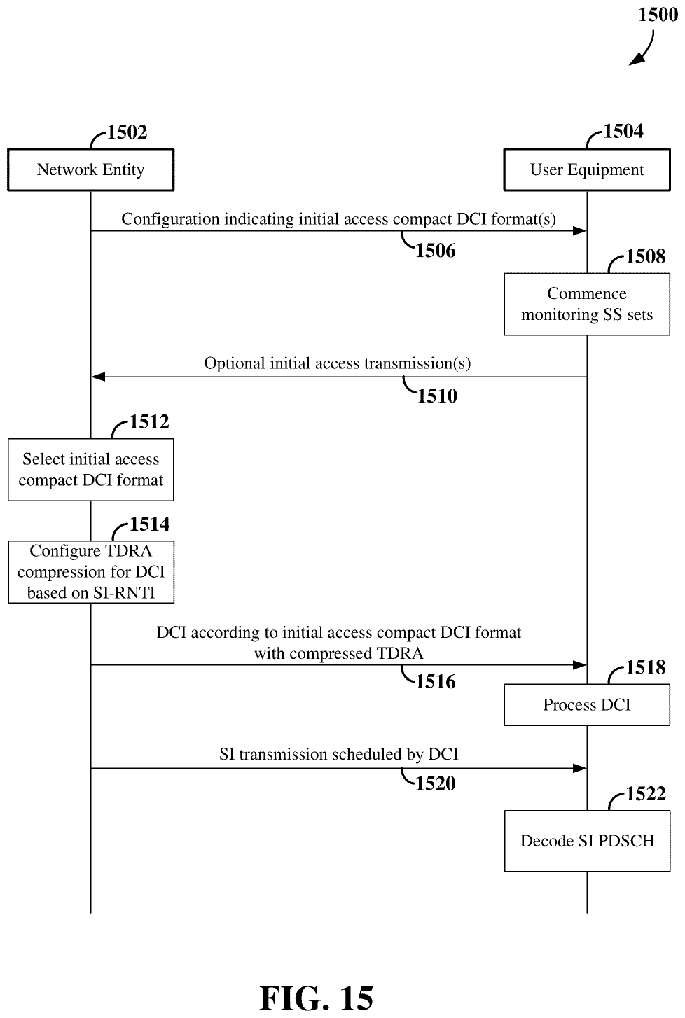

FIGS. 15-20 illustrate several examples of techniques for reducing the size of a DCI format. These techniques may be used independently in some examples or in any combination in other examples.

FIG. 15 is a signaling diagram 1500 illustrating an example of SI-related signaling in a wireless communication system including a network entity 1502 and a UE 1504. In some examples, the network entity 1502 may correspond to any of the network entities, base stations, CUs, DUs, RUs, or scheduling entities shown in any of FIGS. 1, 2, 3, 4, 7, 11, 12, 13, 16, 17, 18, 19, 20, and 23. In some examples, the UE 1504 may correspond to any of the UEs or scheduled entities shown in any of FIGS. 1, 2, 3, 4, 7, 11, 12, 13, 16, 17, 18, 19, 20, and 21.

In some aspects, #1506-#1522 of FIG. 15 may be associated with initial access. For example, during this time the UE 1504 may be in RRC-IDLE mode or RRC-INACTIVE mode.

At #1506, the network entity 1502 may send configuration information to the UE 1504. In some examples, the configuration information may be for at least one compact DCI format for initial access. In some examples, the configuration information may indicate CORESET and search space (SS) configurations that the UE 1504 is to use for receiving information from the network entity 1502. For example, a CORESET configuration may specify the RBs and the number of symbols for each CORESET. In addition, an SS configuration may specify, for each configured SS set, the associated CORESET, PDCCH monitoring occasion (MO) information, PDCCH candidates, and so on. The configuration information may include other information as well. In some examples, the configuration information may be sent via a MIB, PDCCH-ConfigCommon, PDCCH-Config, or in some other manner.

At #1508, the UE 1504 repeatedly monitors the configured SS sets to determine whether the network entity 1502 has transmitted any messages to the UE 1504. In some aspects, this may involve blind decoding for PDCCH candidates in a common search space (CSS) as discussed herein.

At optional #1510, in some scenarios the UE 1504 may transmit a message to the network entity 1502 during initial access.

At #1512, at some point in time, the network entity 1502 may select a DCI format to use for an initial access operation. For example, in a scenario where one compact DCI format is specified for initial access, the network entity 1502 may select that compact DCI format. As another example, in a scenario where two compact DCI formats are specified for initial access, the network entity 1502 may select one of those compact DCI formats depending. For example, the network entity 1502 may select the smaller of the two compact DCI formats to schedule an SI transmission.

At #1514, the network entity 1502 configures TDRA compression for a DCI that schedules an SI transmission (e.g., CRC scrambled by SI-RNTI). As discussed above, this may involve setting a bit in the TDRA field to indicate one of two TDRA possibilities based on an associated SSB time domain location and the time domain location of the scheduling DCI.

At #1516, the network entity 1502 sends a DCI formatted according to the selected compact DCI format to the UE 1504. The DCI includes scheduling information for scheduling at least one transmission. In this case, the network entity sends a DCI with CRC scrambled by an SI-RNTI to schedule an SI transmission.

At #1518, as a result of monitoring the SS sets, the UE 1504 decodes the DCI and obtains the scheduling information included in the DCI.

At #1520, the UE 1504 receives the corresponding downlink transmission from the network entity 1502 according to the scheduling information included in the DCI.

At #1522, the UE 1504 decodes the corresponding PDSCH transmission to extract the SI.

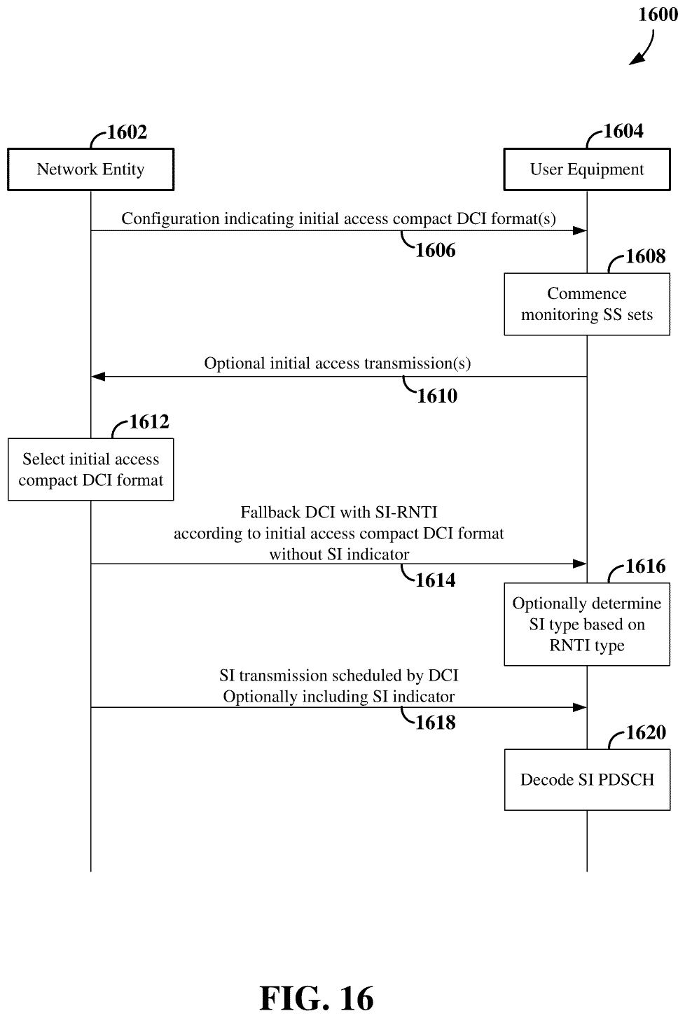

FIG. 16 is a signaling diagram 1600 illustrating an example of SI-related signaling in a wireless communication system including a network entity 1602 and a UE 1604. In some examples, the network entity 1602 may correspond to any of the network entities, base stations, CUs, DUs, RUs, or scheduling entities shown in any of FIGS. 1, 2, 3, 4, 7, 11, 12, 13, 15, 17, 18, 19, 20, and 23. In some examples, the UE 1604 may correspond to any of the UEs or scheduled entities shown in any of FIGS. 1, 2, 3, 4, 7, 11, 12, 13, 15, 17, 18, 19, 20, and 21.

In some aspects, #1606-#1620 of FIG. 16 may be associated with initial access. For example, during this time the UE 1604 may be in RRC-IDLE mode or RRC-INACTIVE mode.

At #1606, the network entity 1602 may send configuration information to the UE 1604. In some examples, the configuration information may be for at least one compact DCI format for initial access. In some examples, the configuration information may indicate CORESET and search space (SS) configurations that the UE 1604 is to use for receiving information from the network entity 1602. For example, a CORESET configuration may specify the RBs and the number of symbols for each CORESET. In addition, an SS configuration may specify, for each configured SS set, the associated CORESET, PDCCH monitoring occasion (MO) information, PDCCH candidates, and so on. The configuration information may include other information as well. In some examples, the configuration information may be sent via a MIB, PDCCH-ConfigCommon, PDCCH-Config, or in some other manner.

At #1608, the UE 1604 repeatedly monitors the configured SS sets to determine whether the network entity 1602 has transmitted any messages to the UE 1604. In some aspects, this may involve blind decoding for PDCCH candidates in a common search space (CSS) as discussed herein.

At optional #1610, in some scenarios the UE 1604 may transmit a message to the network entity 1602 during initial access.

At #1612, at some point in time, the network entity 1602 may select a DCI format to use for an initial access operation. For example, in a scenario where one compact DCI format is specified for initial access, the network entity 1602 may select that compact DCI format. As another example, in a scenario where two compact DCI formats are specified for initial access, the network entity 1602 may select one of those compact DCI formats depending. For example, the network entity 1602 may select the smaller of the two compact DCI formats to schedule an SI transmission.

As discussed here, the DCI for this operation might not include an SI indicator field. In some examples, the network entity 1602 may select a specific type of RNTI (e.g., SI-RNTI, SIB1-RNTI, OSI-RNTI, etc.) to scramble the CRC of the DCI and thereby indicate whether the scheduled PDSCH is, for example, SIB1 or other SI.

At #1614, the network entity 1602 sends a DCI formatted according to the selected compact DCI format (no SI indicator field) to the UE 1604. The DCI includes scheduling information for scheduling at least one transmission. In this case, the network entity sends a DCI with CRC scrambled by an SI-RNTI to schedule an SI transmission.

At #1616, as a result of monitoring the SS sets, the UE 1604 decodes the DCI and obtains the scheduling information included in the DCI. In some examples, the UE 1604 may determine the specific type of RNTI used to encode the CRC of the DCI and thereby determine whether the scheduled PDSCH is SIB1 or not.

At #1618, the UE 1604 receives the corresponding downlink transmission from the network entity 1602 according to the scheduling information included in the DCI. In some examples, the network entity 1602 includes SI indicator information in this transmission (PDSCH).

At #1620, the UE 1604 decodes the corresponding PDSCH transmission to extract the SI. In some examples, this may involve extracting the SI indicator information from the PDSCH transmission.

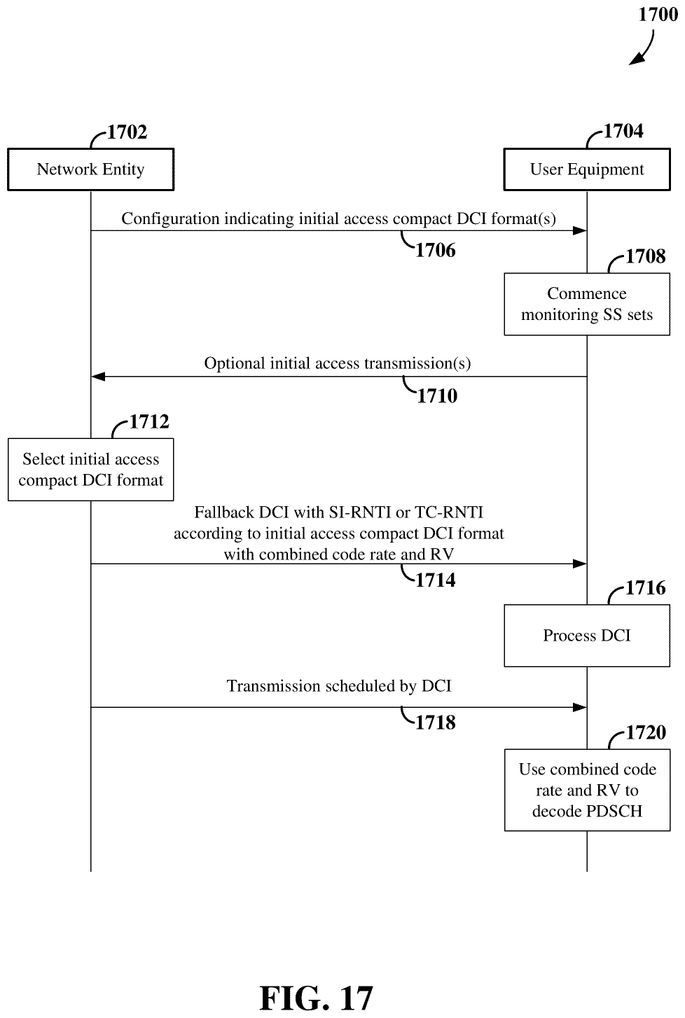

FIG. 17 is a signaling diagram 1700 illustrating an example of SI or RA related signaling in a wireless communication system including a network entity 1702 and a UE 1704. In some examples, the network entity 1702 may correspond to any of the network entities, base stations, CUs, DUs, RUs, or scheduling entities shown in any of FIGS. 1, 2, 3, 4, 7, 11, 12, 13, 15, 16, 18, 19, 20, and 23. In some examples, the UE 1704 may correspond to any of the UEs or scheduled entities shown in any of FIGS. 1, 2, 3, 4, 7, 11, 12, 13, 15, 16, 18, 19, 20, and 21.

In some aspects, #1706-#1720 of FIG. 17 may be associated with initial access. For example, during this time the UE 1704 may be in RRC-IDLE mode or RRC-INACTIVE mode.

At #1706, the network entity 1702 may send configuration information to the UE 1704. In some examples, the configuration information may be for at least one compact DCI format for initial access. In some examples, the configuration information may indicate CORESET and search space (SS) configurations that the UE 1704 is to use for receiving information from the network entity 1702. For example, a CORESET configuration may specify the RBs and the number of symbols for each CORESET. In addition, an SS configuration may specify, for each configured SS set, the associated CORESET, PDCCH monitoring occasion (MO) information, PDCCH candidates, and so on. The configuration information may include other information as well. In some examples, the configuration information may be sent via a MIB, PDCCH-ConfigCommon, PDCCH-Config, or in some other manner.

At #1708, the UE 1704 repeatedly monitors the configured SS sets to determine whether the network entity 1702 has transmitted any messages to the UE 1704. In some aspects, this may involve blind decoding for PDCCH candidates in a common search space (CSS) as discussed herein.

At optional #1710, in some scenarios the UE 1704 may transmit a message to the network entity 1702 during initial access.

At #1712, at some point in time, the network entity 1702 may select a DCI format to use for an initial access operation. For example, in a scenario where one compact DCI format is specified for initial access, the network entity 1702 may select that compact DCI format. As another example, in a scenario where two compact DCI formats are specified for initial access, the network entity 1702 may select one of those compact DCI formats depending. For example, the network entity 1702 may select the smaller of the two compact DCI formats to schedule an SI or RA transmission. As discussed here, the DCI for this operation may include combined code rate and RV information.

At #1714, the network entity 1702 sends a DCI formatted according to the selected compact DCI format (with combined code rate and RV) to the UE 1704. The DCI includes scheduling information for scheduling at least one transmission. In this case, the network entity sends a DCI with CRC scrambled by an SI-RNTI to schedule an SI transmission or scrambled by a TC-RNTI to schedule an RA transmission.

At #1716, as a result of monitoring the SS sets, the UE 1704 decodes the DCI and obtains the scheduling information included in the DCI.

At #1718, the UE 1704 receives the corresponding downlink transmission from the network entity 1702 according to the scheduling information included in the DCI. Here, the UE 1704 may determine the code rate and RV to use for decoding the scheduled transmission based on the combined code rate and RV information in the DCI.

At #1720, the UE 1704 may thus use the combined code rate and RV information to decode the corresponding PDSCH transmission to extract the SI or RA information.

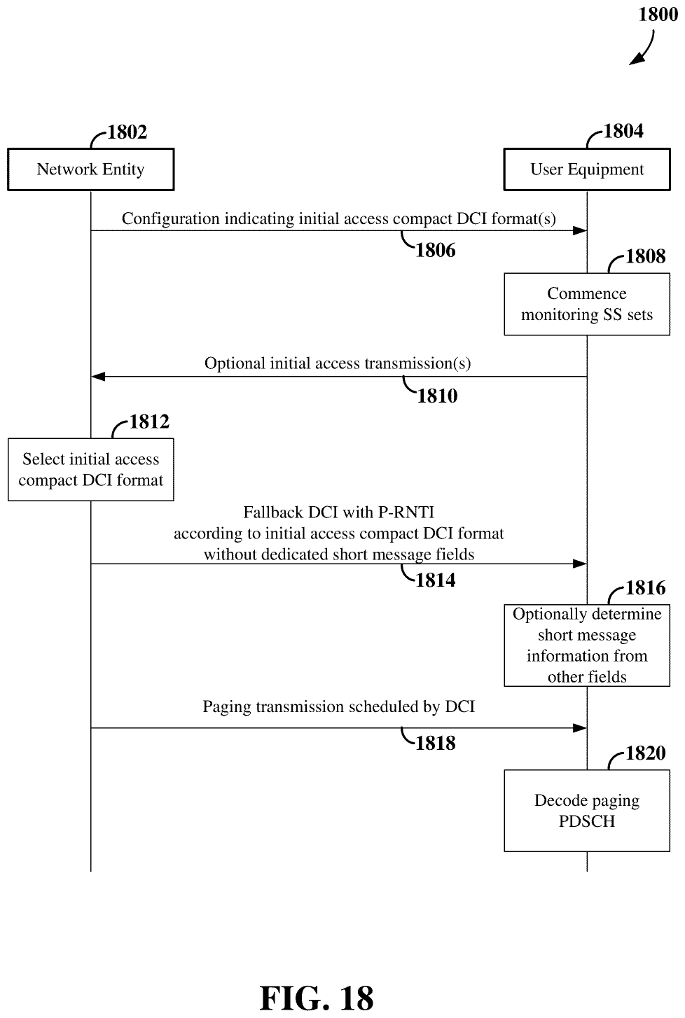

FIG. 18 is a signaling diagram 1800 illustrating an example of paging related signaling in a wireless communication system including a network entity 1802 and a UE 1804. In some examples, the network entity 1802 may correspond to any of the network entities, base stations, CUs, DUs, RUs, or scheduling entities shown in any of FIGS. 1, 2, 3, 4, 7, 11, 12, 13, 15, 16, 17, 19, 20, and 23. In some examples, the UE 1804 may correspond to any of the UEs or scheduled entities shown in any of FIGS. 1, 2, 3, 4, 7, 11, 12, 13, 15, 16, 17, 19, 20, and 21.

In some aspects, #1806-#1820 of FIG. 18 may be associated with initial access. For example, during this time the UE 1804 may be in RRC-IDLE mode or RRC-INACTIVE mode.

At #1806, the network entity 1802 may send configuration information to the UE 1804. In some examples, the configuration information may be for at least one compact DCI format for initial access. In some examples, the configuration information may indicate CORESET and search space (SS) configurations that the UE 1804 is to use for receiving information from the network entity 1802. For example, a CORESET configuration may specify the RBs and the number of symbols for each CORESET. In addition, an SS configuration may specify, for each configured SS set, the associated CORESET, PDCCH monitoring occasion (MO) information, PDCCH candidates, and so on. The configuration information may include other information as well. In some examples, the configuration information may be sent via a MIB, PDCCH-ConfigCommon, PDCCH-Config, or in some other manner.

At #1808, the UE 1804 repeatedly monitors the configured SS sets to determine whether the network entity 1802 has transmitted any messages to the UE 1804. In some aspects, this may involve blind decoding for PDCCH candidates in a common search space (CSS) as discussed herein.

At optional #1810, in some scenarios the UE 1804 may transmit a message to the network entity 1802 during initial access.

At #1812, at some point in time, the network entity 1802 may select a DCI format to use for an initial access operation. For example, in a scenario where one compact DCI format is specified for initial access, the network entity 1802 may select that compact DCI format. As another example, in a scenario where two compact DCI formats are specified for initial access, the network entity 1802 may select one of those compact DCI formats depending. For example, the network entity 1802 may select the smaller of the two compact DCI formats to schedule a paging transmission. As discussed here, the DCI for this operation may exclude dedicated short message fields.

At #1814, the network entity 1802 sends a DCI formatted according to the selected compact DCI format (without dedicated short message fields) to the UE 1804. The DCI includes scheduling information for scheduling at least one transmission. In this case, the network entity sends a DCI with CRC scrambled by an P-RNTI to schedule a paging transmission.

At #1816, as a result of monitoring the SS sets, the UE 1804 decodes the DCI and obtains the scheduling information included in the DCI. In some examples, the UE 1804 may obtain short message information from one or more fields in the DCI (e.g., one or more of the FDRA field, the TDRA field, the MCS field, or the VRB-PRB mapping field) as discussed above.

At #1818, the UE 1804 receives the corresponding downlink transmission from the network entity 1802 according to the scheduling information included in the DCI.

At #1820, the UE 1804 may then decode the corresponding PDSCH transmission to extract paging information.

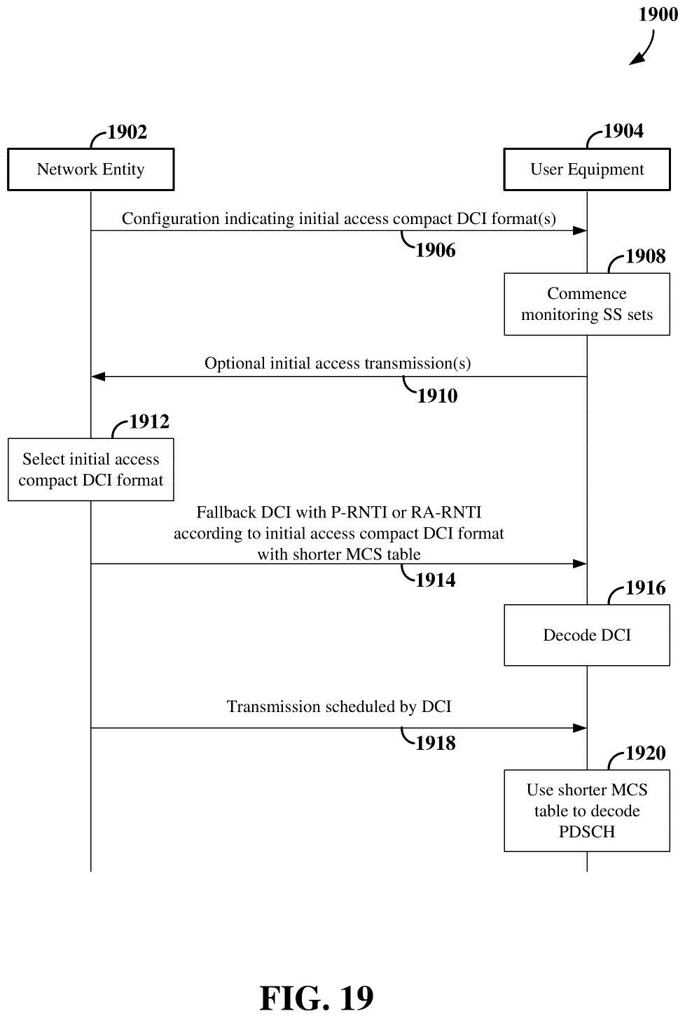

FIG. 19 is a signaling diagram 1900 illustrating an example of paging or RA related signaling in a wireless communication system including a network entity 1902 and a UE 1904. In some examples, the network entity 1902 may correspond to any of the network entities, base stations, CUs, DUs, RUs, or scheduling entities shown in any of FIGS. 1, 2, 3, 4, 7, 11, 12, 13, 15, 16, 17, 18, 20, and 23. In some examples, the UE 1904 may correspond to any of the UEs or scheduled entities shown in any of FIGS. 1, 2, 3, 4, 7, 11, 12, 13, 15, 16, 17, 18, 20, and 21.

In some aspects, #1906-#1920 of FIG. 19 may be associated with initial access. For example, during this time the UE 1904 may be in RRC-IDLE mode or RRC-INACTIVE mode.

At #1906, the network entity 1902 may send configuration information to the UE 1904. In some examples, the configuration information may be for at least one compact DCI format for initial access. In some examples, the configuration information may indicate CORESET and search space (SS) configurations that the UE 1904 is to use for receiving information from the network entity 1902. For example, a CORESET configuration may specify the RBs and the number of symbols for each CORESET. In addition, an SS configuration may specify, for each configured SS set, the associated CORESET, PDCCH monitoring occasion (MO) information, PDCCH candidates, and so on. The configuration information may include other information as well. In some examples, the configuration information may be sent via a MIB, PDCCH-ConfigCommon, PDCCH-Config, or in some other manner.

At #1908, the UE 1904 repeatedly monitors the configured SS sets to determine whether the network entity 1902 has transmitted any messages to the UE 1904. In some aspects, this may involve blind decoding for PDCCH candidates in a common search space (CSS) as discussed herein.

At optional #1910, in some scenarios the UE 1904 may transmit a message to the network entity 1902 during initial access.

At #1912, at some point in time, the network entity 1902 may select a DCI format to use for an initial access operation. For example, in a scenario where one compact DCI format is specified for initial access, the network entity 1902 may select that compact DCI format. As another example, in a scenario where two compact DCI formats are specified for initial access, the network entity 1902 may select one of those compact DCI formats depending. For example, the network entity 1902 may select the smaller of the two compact DCI formats to schedule a paging or RA transmission. As discussed here, the DCI for this operation may be based on a shorter MCS table.

At #1914, the network entity 1902 sends a DCI formatted according to the selected compact DCI format (based on a shorter MCS table, such as MCS Index table 3) to the UE 1904. The DCI includes scheduling information for scheduling at least one transmission. In this case, the network entity sends a DCI with CRC scrambled by a P-RNTI to schedule a paging transmission or scrambled by an RA-RNTI to schedule an RA transmission.

At #1916, as a result of monitoring the SS sets, the UE 1904 decodes the DCI and obtains the scheduling information included in the DCI.

At #1918, the UE 1904 receives the corresponding downlink transmission from the network entity 1902 according to the scheduling information included in the DCI. Here, the UE 1904 determines the MCS to use for decoding the scheduled transmission based on the MCS information in the DCI and the shorter MCS table (e.g., MCS Index table 3).

At #1920, the UE 1904 thus uses the combined MCS information to decode the corresponding PDSCH transmission to extract the paging or RA information.

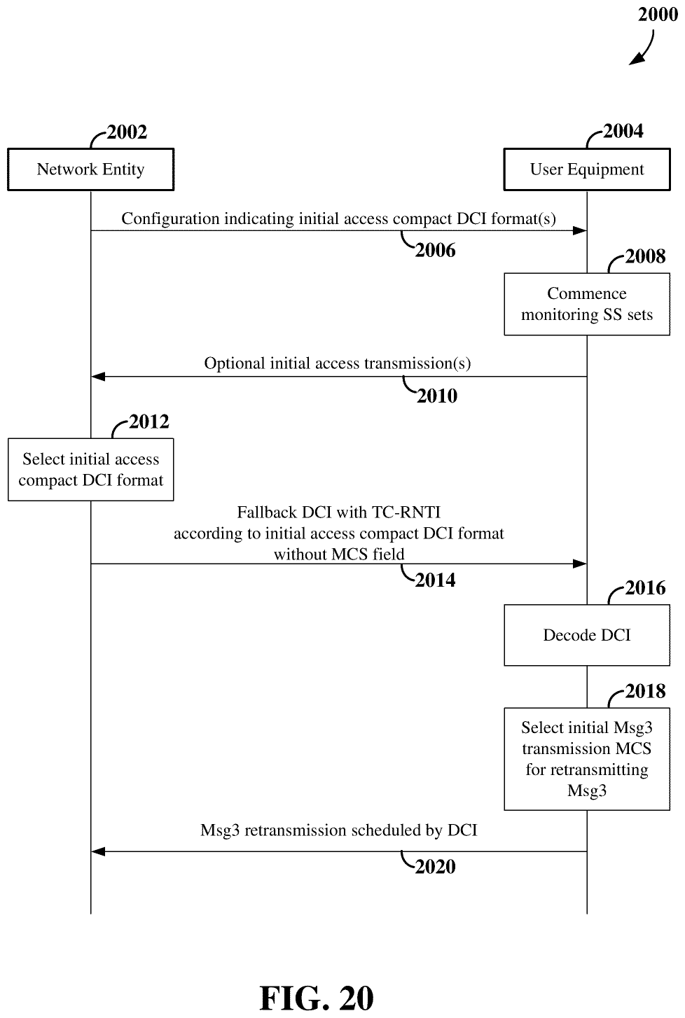

FIG. 20 is a signaling diagram 2000 illustrating an example of RA related signaling in a wireless communication system including a network entity 2002 and a UE 2004. In some examples, the network entity 2002 may correspond to any of the network entities, base stations, CUs, DUs, RUs, or scheduling entities shown in any of FIGS. 1, 2, 3, 4, 7, 11, 12, 13, 15, 16, 17, 18, 19, and 23. In some examples, the UE 2004 may correspond to any of the UEs or scheduled entities shown in any of FIGS. 1, 2, 3, 4, 7, 11, 12, 13, 15, 16, 17, 18, 19, and 21.

In some aspects, #2006-#2020 of FIG. 20 may be associated with initial access. For example, during this time the UE 2004 may be in RRC-IDLE mode or RRC-INACTIVE mode.

At #2006, the network entity 2002 may send configuration information to the UE 2004. In some examples, the configuration information may be for at least one compact DCI format for initial access. In some examples, the configuration information may indicate CORESET and search space (SS) configurations that the UE 2004 is to use for receiving information from the network entity 2002. For example, a CORESET configuration may specify the RBs and the number of symbols for each CORESET. In addition, an SS configuration may specify, for each configured SS set, the associated CORESET, PDCCH monitoring occasion (MO) information, PDCCH candidates, and so on. The configuration information may include other information as well. In some examples, the configuration information may be sent via a MIB, PDCCH-ConfigCommon, PDCCH-Config, or in some other manner.

At #2008, the UE 2004 repeatedly monitors the configured SS sets to determine whether the network entity 2002 has transmitted any messages to the UE 2004. In some aspects, this may involve blind decoding for PDCCH candidates in a common search space (CSS) as discussed herein.

At optional #2010, in some scenarios the UE 2004 may transmit a message (e.g., a Msg3) to the network entity 2002 during initial access.

At #2012, at some point in time, the network entity 2002 may select a DCI format to use for an initial access operation. For example, in a scenario where one compact DCI format is specified for initial access, the network entity 2002 may select that compact DCI format. As another example, in a scenario where two compact DCI formats are specified for initial access, the network entity 2002 may select one of those compact DCI formats depending. For example, the network entity 2002 may select the smaller of the two compact DCI formats to schedule an RA transmission. As discussed here, the DCI for this operation may exclude MCS information.

At #2014, the network entity 2002 sends a DCI formatted according to the selected compact DCI format (no MCS information) to the UE 2004. The DCI includes scheduling information for scheduling at least one transmission. In this case, the network entity sends a DCI with CRC scrambled by a TC-RNTI to schedule an RA transmission (Msg3 retransmission).

At #2016, as a result of monitoring the SS sets, the UE 2004 decodes the DCI and obtains the scheduling information included in the DCI.

At #2018, the UE 2004 generates a PUSCH transmission (for a Msg3 retransmission) according to the scheduling information. Here, the UE 2004 determines the MCS to use for the scheduled transmission based on the MCS that was used for the original Msg3 transmission.

At #2020, the UE 2004 transmits the PUSCH transmission (Msg3 retransmission) to the network entity 2002.

FIG. 21 is a block diagram illustrating an example of a hardware implementation for an apparatus 2100 employing a processing system 2114. For example, the apparatus 2100 may be a device such as a wireless node (e.g., a UE) configured to wirelessly communicate in a network as discussed in any of FIGS. 1-20. In some implementations, the apparatus 2100 may correspond to any of the UEs, sidelink devices, D2D devices, or scheduled entities shown in any of FIGS. 1, 2, 3, 4, 7, 11, 12, 13, 15, 16, 17, 18, 19, and 20.

In accordance with various aspects of the disclosure, an element, or any portion of an element, or any combination of elements may be implemented with the processing system 2114. The processing system 2114 may include one or more processors (referred to herein as the processor 2104, for convenience). Examples of processors 2104 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the apparatus 2100 may be configured to perform any one or more of the functions described herein. That is, the processor 2104, as utilized in an apparatus 2100, may be used to implement any one or more of the processes and procedures described herein.

The processor 2104 may in some instances be implemented via a baseband or modem chip and in other implementations, the processor 2104 may itself include a number of devices distinct and different from a baseband or modem chip (e.g., in such scenarios these devices may work in concert to achieve examples discussed herein). And as mentioned above, various hardware arrangements and components outside of a baseband modem processor can be used in implementations, including RF-chains, power amplifiers, modulators, buffers, interleavers, adders/summers, etc.

In this example, the processing system 2114 may be implemented with a bus architecture, represented generally by the bus 2102. The bus 2102 may include any number of interconnecting buses and bridges depending on the specific application of the processing system 2114 and the overall design constraints. The bus 2102 communicatively couples together various circuits including one or more processors (represented generally by the processor 2104), one or more memories (referred to herein as the memory 2105, for convenience), and one or more computer-readable media (represented generally by the computer-readable medium 2106). The bus 2102 may also link various other circuits such as timing sources, peripherals, voltage regulators, and power management circuits, which are well known in the art, and therefore, will not be described any further. A bus interface 2108 provides an interface between the bus 2102, a transceiver 2110 and an antenna array 2120 and between the bus 2102 and an interface 2130. The transceiver 2110 provides a communication interface or means for communicating with various other apparatus over a wireless transmission medium. The interface 2130 provides a communication interface or means of communicating with various other apparatuses and devices (e.g., other devices housed within the same apparatus as the apparatus 2100 or other external apparatuses) over an internal bus or external transmission medium, such as an Ethernet cable. Depending upon the nature of the apparatus, the interface 2130 may include a user interface (e.g., keypad, display, speaker, microphone, joystick). Of course, such a user interface is optional, and may be omitted in some examples, such as an IoT device.

The processor 2104 is responsible for managing the bus 2102 and general processing, including the execution of software stored on the computer-readable medium 2106. The software, when executed by the processor 2104, causes the processing system 2114 to perform the various functions described below for any particular apparatus. The computer-readable medium 2106 and the memory 2105 may also be used for storing data that is manipulated by the processor 2104 when executing software. For example, the memory 2105 may store control information (CI) 2115 (e.g., DCI format configuration information) used by the processor 2104 for the communication operations described herein.

One or more processors 2104 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 2106.

The computer-readable medium 2106 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 2106 may reside in the processing system 2114, external to the processing system 2114, or distributed across multiple entities including the processing system 2114. The computer-readable medium 2106 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

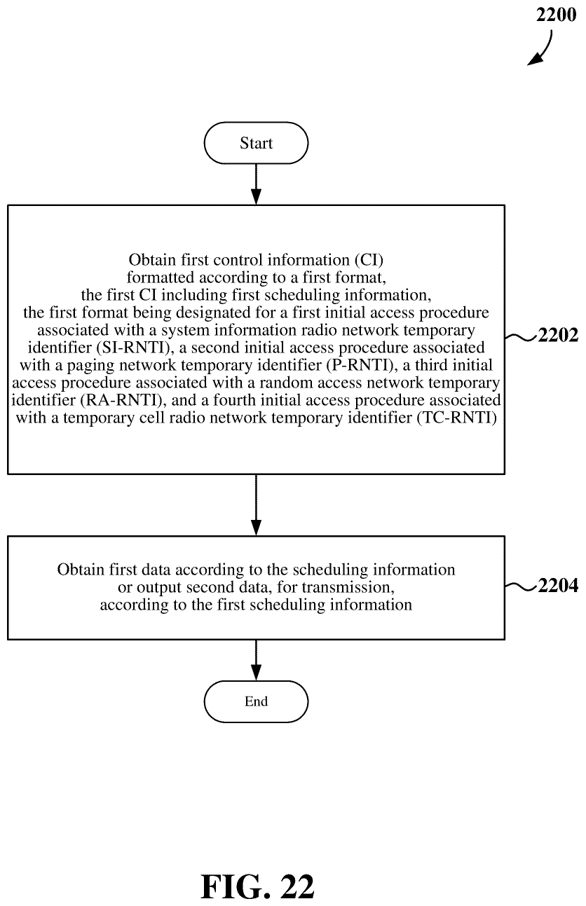

The apparatus 2100 may be configured to perform any one or more of the operations described herein (e.g., as described above in conjunction with FIGS. 1-20, and as described below in conjunction with FIG. 22). In some aspects of the disclosure, the processor 2104, as utilized in the apparatus 2100, may include circuitry configured for various functions.

In some aspects of the disclosure, the processor 2104 may include communication and processing circuitry 2141. The communication and processing circuitry 2141 may be configured to communicate with a network entity and/or other wireless devices. The communication and processing circuitry 2141 may include one or more hardware components that provide the physical structure that performs various processes related to communication (e.g., signal reception and/or signal transmission) as described herein. The communication and processing circuitry 2141 may further include one or more hardware components that provide the physical structure that performs various processes related to signal processing (e.g., processing a received signal and/or processing a signal for transmission) as described herein. The communication and processing circuitry 2141 may further be configured to execute communication and processing software 2151 included on the computer-readable medium 2106 to implement one or more functions described herein.

The communication and processing circuitry 2141 may further be configured to send or receive an indication. For example, the indication may be included in a MAC-CE carried in a Uu PUSCH, Uu PDSCH, or a PSCCH, or included in a Uu RRC message or an SL RRC message. The communication and processing circuitry 2141 may further be configured to send a scheduling request an uplink grant or a sidelink grant.

In some implementations where the communication involves receiving information, the communication and processing circuitry 2141 may obtain information from a component of the apparatus 2100 (e.g., from the transceiver 2110 that receives the information via radio frequency signaling or some other type of signaling suitable for the applicable communication medium), process (e.g., decode) the information, and output the processed information. For example, the communication and processing circuitry 2141 may output the information to another component of the processor 2104, to the memory 2105, or to the bus interface 2108. In some examples, the communication and processing circuitry 2141 may receive one or more of signals, messages, other information, or any combination thereof. In some examples, the communication and processing circuitry 2141 may receive information via one or more channels. In some examples, the communication and processing circuitry 2141 may receive one or more of signals, messages, SCIs, feedback, other information, or any combination thereof. In some examples, the communication and processing circuitry 2141 may receive information via one or more of a PSCCH, a PSSCH, a PSFCH, some other type of channel, or any combination thereof. In some examples, the communication and processing circuitry 2141 may include functionality for a means for obtaining. In some examples, the communication and processing circuitry 2141 and/or the transceiver 2110 may include functionality for a means for receiving (e.g., means for receiving a downlink transmission, means for receiving a configuration, etc.). In some examples, the communication and processing circuitry 2141 may include functionality for a means for decoding. In some examples, the communication and processing circuitry 2141 may include functionality for a means for receiving information from a network entity.

In some implementations where the communication involves sending (e.g., transmitting) information, the communication and processing circuitry 2141 may obtain information (e.g., from another component of the processor 2104, the memory 2105, or the bus interface 2108), process (e.g., encode) the information, and output the processed information. For example, the communication and processing circuitry 2141 may output the information to the transceiver 2110 (e.g., that transmits the information via radio frequency signaling or some other type of signaling suitable for the applicable communication medium). In some examples, the communication and processing circuitry 2141 may send one or more of signals, messages, other information, or any combination thereof. In some examples, the communication and processing circuitry 2141 may send information via one or more channels. In some examples, the communication and processing circuitry 2141 may send one or more of signals, messages, SCIs, feedback, other information, or any combination thereof. In some examples, the communication and processing circuitry 2141 may send information via one or more of a PSCCH, a PSSCH, a PSFCH, some other type of channel, or any combination thereof. In some examples, the communication and processing circuitry 2141 may include functionality for a means for outputting. In some examples, the communication and processing circuitry 2141 and/or the transceiver 2110 may include functionality for a means for transmitting (e.g., means for transmitting an uplink transmission, means for transmitting a symbol, etc.). In some examples, the communication and processing circuitry 2141 may include functionality for a means for encoding. In some examples, the communication and processing circuitry 2141 may include functionality for a means for transmitting information to a network entity.

The processor 2104 may include CI processing circuitry 2142 configured to perform CI processing-related operations as discussed herein (e.g., one or more of the operations described above in conjunction with FIGS. 1-20). The CI processing circuitry 2142 may be configured to execute CI processing software 2152 included on the computer-readable medium 2106 to implement one or more functions described herein.

The CI processing circuitry 2142 may include functionality for a means for obtaining (e.g., as described above in conjunction with FIGS. 1-20). For example, the CI processing circuitry 2142 may obtain information (e.g., a configuration, a CI, a DCI, etc.) from another component of the apparatus 2100. As another example, the CI processing circuitry 2142 may obtain (e.g., receive) information from a network entity (e.g., via a PDCCH, a PDSCH, etc.) via the transceiver 2110.

The CI processing circuitry 2142 may include functionality for a means for processing (e.g., as described above in conjunction with FIGS. 1-20). For example, the CI processing circuitry 2142 may decode a CI (e.g., a DCI) based on a radio network temporary identifier (RNTI), a search space, and/or other information. In various examples, the CI processing circuitry 2142 may be configured to process (e.g., decode) a PDSCH, a PDCCH, a PUSCH, a PUCCH, a PSSCH, a PSCCH, an SRS, a RACH, or other signaling.

The CI processing circuitry 2142 may include functionality for a means for outputting (e.g., as described above in conjunction with FIGS. 1-20). For example, the CI processing circuitry 2142 may output control information (e.g., destined for a UE, etc.) to another component of the apparatus 2100.

The CI processing circuitry 2142 may include functionality for a means for extracting (e.g., as described above in conjunction with FIGS. 1-20). For example, the CI processing circuitry 2142 may extract information (e.g., a short message) from received CI (e.g., received DCI).

The CI processing circuitry 2142 may include functionality for a means for identifying (e.g., as described above in conjunction with FIGS. 1-20). For example, the CI processing circuitry 2142 may identify a TDRA for obtaining SI. As another example, the CI processing circuitry 2142 may identify a type of SI.

The processor 2104 may include data processing circuitry 2143 configured to perform data processing-related operations as discussed herein (e.g., one or more of the operations described above in conjunction with FIGS. 1-20). The data processing circuitry 2143 may be configured to execute data processing software 2153 included on the computer-readable medium 2106 to implement one or more functions described herein.

The data processing circuitry 2143 may include functionality for a means for performing (e.g., as described above in conjunction with FIGS. 1-20). For example, the data processing circuitry 2143 may perform a connected mode procedure independent of the use of a particular format (e.g., a CI format such as a DCI format).

The data processing circuitry 2143 may include functionality for a means for obtaining (e.g., as described above in conjunction with FIGS. 1-20). For example, the data processing circuitry 2143 may obtain data (e.g., originating from a network entity, a UE, etc.) from another component of the apparatus 2100.

The data processing circuitry 2143 may include functionality for a means for outputting (e.g., as described above in conjunction with FIGS. 1-20). For example, the data processing circuitry 2143 may output data (e.g., destined for a UE, a network entity, etc.) to another component of the apparatus 2100.

The data processing circuitry 2143 may include functionality for a means for identifying (e.g., as described above in conjunction with FIGS. 1-20). For example, the data processing circuitry 2143 may identify a TDRA for obtaining SI. As another example, the data processing circuitry 2143 may identify a type of SI.

The data processing circuitry 2143 may include functionality for a means for decoding (e.g., as described above in conjunction with FIGS. 1-20). For example, the data processing circuitry 2143 may decode paging information or random access information from a received PDSCH transmission.

The data processing circuitry 2143 may include functionality for a means for performing a data processing operation (e.g., as described above in conjunction with FIGS. 1-20). For example, the data processing circuitry 2143 may generate data for transmission or process received data.

FIG. 22 is a flow chart illustrating an example method 2200 for communication in accordance with some aspects of the present disclosure. As described below, some or all illustrated features may be omitted in a particular implementation within the scope of the present disclosure, and some illustrated features may not be required for implementation of all examples. In some examples, the method 2200 (e.g., a method for wireless communication) may be carried out by the apparatus 2100 illustrated in FIG. 21, the apparatus 302 illustrated in FIG. 3, or a wireless node (e.g., a UE). In some examples, the method 2200 may be carried out by any suitable apparatus or means for carrying out the functions or algorithm described below.

At block 2202, a first apparatus may obtain first control information (CI) formatted according to a first format, the first CI including first scheduling information, the first format being designated for: a first initial access procedure associated with a system information radio network temporary identifier (SI-RNTI), a second initial access procedure associated with a paging radio network temporary identifier (P-RNTI), a third initial access procedure associated with a random access radio network temporary identifier (RA-RNTI), and a fourth initial access procedure associated with a first temporary cell radio network temporary identifier (TC-RNTI). In some examples, the CI processing circuitry 2142 and/or the communication and processing circuitry 2141 and/or the transceiver 2110, shown and described in FIG. 21, may provide a means to obtain first control information (CI) formatted according to a first format, the first CI including first scheduling information, the first format being designated for: a first initial access procedure associated with a system information radio network temporary identifier (SI-RNTI), a second initial access procedure associated with a paging radio network temporary identifier (P-RNTI), a third initial access procedure associated with a random access radio network temporary identifier (RA-RNTI), and a fourth initial access procedure associated with a first temporary cell radio network temporary identifier (TC-RNTI).

At block 2204, the first apparatus may obtain first data according to the first scheduling information or output second data, for transmission, according to the first scheduling information. In some examples, the data processing circuitry 2143 and/or the communication and processing circuitry 2141 and/or the transceiver 2110, shown and described in FIG. 21, may provide a means to obtain first data according to the first scheduling information or output second data, for transmission, according to the first scheduling information. In some examples, the data processing circuitry 2143, shown and described in FIG. 21, may provide a means to obtain first data according to the first scheduling information or output second data, for transmission, according to the first scheduling information.

In some examples, the first CI is a first DCI or a first SCI. In some examples, the first format is a first DCI format or a first SCI format.

In some examples, the first initial access procedure may include a first idle mode procedure or a first inactive mode procedure. In some examples, the second initial access procedure may include a second idle mode procedure or a second inactive mode procedure. In some examples, the third initial access procedure may include a third idle mode procedure or a third inactive mode procedure. In some examples, the fourth initial access procedure may include a fourth idle mode procedure or a fourth inactive mode procedure.

In some examples, the first apparatus may obtain, during the first initial access procedure, system information according to the first scheduling information, the first CI further including a first cyclic redundancy check (CRC) encoded (e.g., scrambled) with the SI-RNTI. In some examples, the first apparatus may obtain, during the second initial access procedure, paging information according to the first scheduling information, the first CI further including a second CRC encoded (e.g., scrambled) with the P-RNTI. In some examples, the first apparatus may obtain, during the third initial access procedure, random access information according to the first scheduling information, the first CI further including a third CRC encoded (e.g., scrambled) with the RA-RNTI. In some examples, the first apparatus may output for transmission or obtain, during the fourth initial access procedure, random access information according to the first scheduling information, the first CI further including a fourth CRC encoded (e.g., scrambled) with the first TC-RNTI.

In some examples, the first CI is downlink control information (DCI) obtained via a common search space.

In some examples, the first apparatus may obtain second CI formatted according to a second downlink control information (DCI) format, the second DCI format being designated for a connected mode procedure associated with a cell radio network temporary identifier (C-RNTI). In some examples, the first format is a first DCI associated with a first size. In some examples, the second DCI format is associated with a second size that is larger than the first size.

In some examples, the first apparatus may obtain second CI formatted according to a second format, the second CI including second scheduling information, the second format being designated for a fifth initial access procedure associated with a second TC-RNTI. In some examples, the first apparatus may obtain third data according to the second scheduling information.

In some examples, a first size associated with the second format is larger than a second size associated with the first format. In some examples, the fifth initial access procedure is to obtain a Msg4 of a random access procedure according to the second scheduling information, the second CI further including a first cyclic redundancy check (CRC) encoded (e.g., scrambled) with the second TC-RNTI. In some examples, the fourth initial access procedure is to output a retransmission of a Msg3 of a random access procedure according to the first scheduling information, the first CI further including a second CRC encoded (e.g., scrambled) with the first TC-RNTI.

In some examples, the first apparatus may perform connected mode procedures independent of using the second format.

In some examples, the first apparatus may obtain third CI formatted according to a third format, the third format being designated for a connected mode procedure associated with a cell radio network temporary identifier (C-RNTI). In some examples, the first format is associated with a first size. In some examples, the second format is associated with a second size that is different from the first size. In some examples, the third format is associated with a third size that is larger than each of the first size and the second size.

In some examples, the first apparatus may obtain the first CI via a first common search space (CSS) according to a first downlink control information (DCI) size (e.g., NO). In some examples, the first apparatus may obtain fallback downlink or uplink CI associated with a cell radio network temporary identifier (C-RNTI) via a second CSS according to a second DCI size (e.g., N2). In some examples, the first apparatus may obtain non-fallback downlink CI associated with the C-RNTI via a user equipment-specific search space (USS) according to a third DCI size. In some examples, the first apparatus may obtain non-fallback uplink CI associated with the C-RNTI via a third CSS according to the third DCI size. In some examples, the first apparatus may obtain non-scheduling CI associated with a plurality of other radio network temporary identifiers (RNTIs) via a fourth CSS according to a fourth DCI size (e.g., Type3 CSS for DCI formats 2_x).

In some examples, the first apparatus may obtain downlink control information (DCI) via search spaces according to five DCI sizes. In some examples, a first DCI size of the five DCI sizes is associated with the first format. In some examples, second, third, and fourth DCI sizes of the five DCI sizes are associated with formats with a cyclic redundancy check (CRC) encoded (e.g., scrambled) with a cell radio network temporary identifier (C-RNTI). In some examples, a fifth DCI size of the five DCI sizes is associated with formats in at least one common search space (CSS) that is not associated with an initial access procedure.

In some examples, the fifth DCI size is designated for non-scheduling formats in the at least one CSS. In some examples, the fifth DCI size is associated with both fallback scheduling formats with CRC scrambled with C-RNTI in the at least one CSS and non-scheduling formats in the at least one CSS.

In some examples, the first apparatus may obtain system information (SI) based on a time division resource allocation (TDRA), wherein the TDRA is based on a synchronization signal block location associated with the SI and a time domain location of the first CI. In some examples, the TDRA is based on a single bit in a TDRA field of the first CI.

In some examples, the first scheduling information identifies resources for obtaining system information (SI). In some examples, the first CI may include downlink control information (DCI) that excludes an SI indicator. In some examples, the first apparatus may identify a type of the SI based on a physical downlink shared channel (PDSCH) transmission scheduled by the first scheduling information. In some examples, the first apparatus may identify a type of the SI based on a radio network temporary identifier (RNTI) type of the SI-RNTI.

In some examples, the first scheduling information identifies resources for obtaining system information (SI) or obtaining a Msg4 of a random access procedure. In some examples, a joint field of the first CI indicates both a redundancy version (RV) and a code rate. In some examples, the first apparatus may obtain the SI or the Msg4 based on the indicated RV and code rate.

In some examples, the first scheduling information identifies resources for obtaining paging information. In some examples, the first CI may include a first downlink control information (DCI) that excludes at least one of a short messages indicator field or a short messages field. In some examples, the first apparatus may extract a short message from the first DCI based on information in a frequency division resource allocation (FDRA) field included in the first DCI. In some examples, the first apparatus may extract the short message from at least one of a time division resource allocation (TDRA) field included in the first DCI, a modulation and coding scheme (MCS) field included in the first DCI, or a virtual resource block to physical resource block (VRB-PRB) mapping field included in the first DCI.

In some examples, the first scheduling information identifies resources for obtaining paging information or first random access information. In some examples, the first CI may include a first downlink control information (DCI) that excludes a transport block (TB) scaling field.

In some examples, the first apparatus may decode the paging information or the first random access information based on a modulation and coding scheme (MCS) field of the first DCI that specifies a code rate according to a table selected based at least in part on an RNTI associated with the first DCI being a P-RNTI or RA-RNTI.

In some examples, the first scheduling information identifies resources for outputting a retransmission of an initial random access transmission. In some examples, the first CI may include a first downlink control information (DCI) that excludes a modulation and coding scheme (MCS) field. In some examples, the first apparatus may output the retransmission of the initial random access transmission based on a transport block size (TBS) associated with the initial random access transmission.

In some examples, the first apparatus may receive the first CI and the first data and transmit the second data. In some examples, the first apparatus is configured as a user equipment (UE).

Referring again to FIG. 21, in one configuration, the apparatus 2100 includes means for obtaining first control information (CI) formatted according to a first format, the first CI including first scheduling information, the first format being designated for: a first initial access procedure associated with a system information radio network temporary identifier (SI-RNTI), a second initial access procedure associated with a paging radio network temporary identifier (P-RNTI), a third initial access procedure associated with a random access radio network temporary identifier (RA-RNTI), and a fourth initial access procedure associated with a first temporary cell radio network temporary identifier (TC-RNTI), and means for obtaining first data according to the first scheduling information or outputting second data, for transmission, according to the first scheduling information. In one aspect, the aforementioned means may be the processor 2104 shown in FIG. 21 configured to perform the functions recited by the aforementioned means (e.g., as discussed above). In another aspect, the aforementioned means may be a circuit or any apparatus configured to perform the functions recited by the aforementioned means.

Of course, in the above examples, the circuitry included in the processor 2104 is merely provided as an example, and other means for carrying out the described functions may be included within various aspects of the present disclosure, including but not limited to the instructions stored in the computer-readable medium 2106, or any other suitable apparatus or means described in any of FIGS. 1, 2, 3, 4, 7, 11, 12, 13, 15, 16, 17, 18, 19, 20, and 21, and utilizing, for example, the methods and/or algorithms described herein in relation to FIG. 22.

FIG. 23 is a conceptual diagram illustrating an example of a hardware implementation for an apparatus 2300 employing a processing system 2314. In some examples, the apparatus 2300 may be a wireless node (e.g., a network entity). In some implementations, the apparatus 2300 may correspond to any of the network entities, CUs, DUs, RUs, base stations, or scheduling entities shown in any of FIGS. 1, 2, 3, 4, 7, 11, 12, 13, 15, 16, 17, 18, 19, and 20. In some implementations, the apparatus 2300 may correspond to any of the UEs or scheduled entities shown in any of FIGS. 1, 2, 3, 4, 7, 11, 12, 13, 15, 16, 17, 18, 19, 20, and 21 (e.g., to implement the techniques described herein in a peer-to-peer configuration in conjunction with the apparatus 2100, where the DCI referred to herein may be instead referred to as control information (CI)).

In accordance with various aspects of the disclosure, an element, or any portion of an element, or any combination of elements may be implemented with the processing system 2314. The processing system may include one or more processors (referred to herein as the processor 2304, for convenience). The processing system 2314 may be substantially the same as the processing system 2114 illustrated in FIG. 21, including a bus interface 2308, a bus 2302, one or more memories (referred to herein as the memory 2305, for convenience), a processor 2304, a computer-readable medium 2306, a transceiver 2310, and an antenna array 2320. The memory 2305 may store control information (CI) 2315 (e.g., DCI format configuration information) used by the processor 2304 in cooperation with the transceiver 2310 for communication operations as described herein. Furthermore, the apparatus 2300 may include an interface 2330 (e.g., a network interface) that provides a means for communicating with at least one other apparatus within a core network and with at least one radio access network.

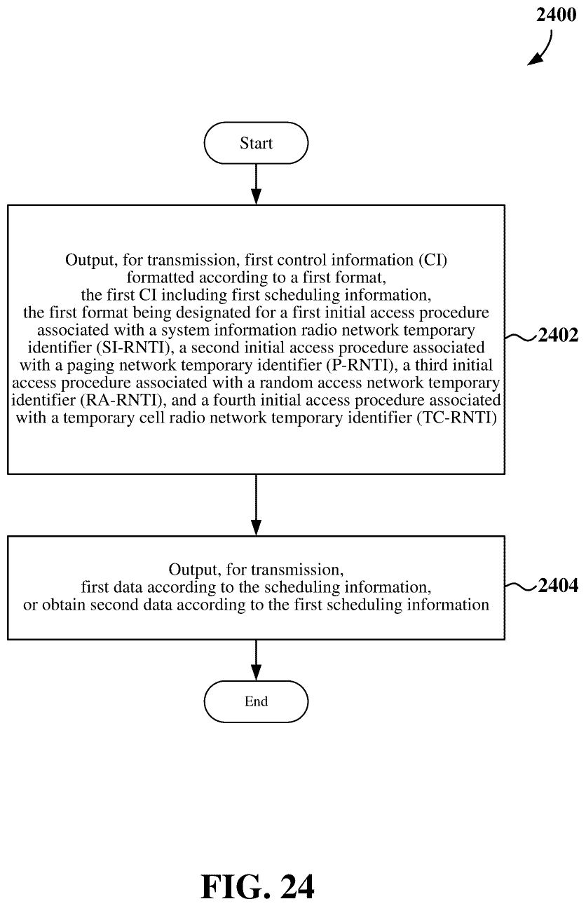

The apparatus 2300 may be configured to perform any one or more of the operations described herein (e.g., as described above in conjunction with FIGS. 1-20 and as described below in conjunction with FIG. 24). In some aspects of the disclosure, the processor 2304, as utilized in the apparatus 2300, may include circuitry configured for various functions.

The processor 2304 may be configured to generate, schedule, and modify a resource assignment or grant of time-frequency resources (e.g., a set of one or more resource elements). For example, the processor 2304 may schedule time-frequency resources within a plurality of time division duplex (TDD) and/or frequency division duplex (FDD) subframes, slots, and/or mini-slots to carry user data traffic and/or control information to and/or from multiple UEs.

The processor 2304 may be configured to schedule resources for the transmission of sidelink signals, downlink signals, or uplink signals. The processor 2304 may be configured to schedule resources for control information (e.g., DCI) operations.

In some aspects of the disclosure, the processor 2304 may include communication and processing circuitry 2341. The communication and processing circuitry 2341 may be configured to communicate with UEs and/or network entities. The communication and processing circuitry 2341 may include one or more hardware components that provide the physical structure that performs various processes related to communication (e.g., signal reception and/or signal transmission) as described herein. The communication and processing circuitry 2341 may further include one or more hardware components that provide the physical structure that performs various processes related to signal processing (e.g., processing a received signal and/or processing a signal for transmission) as described herein. The communication and processing circuitry 2341 may further be configured to execute communication and processing software 2351 included on the computer-readable medium 2306 to implement one or more functions described herein.

In some implementations wherein the communication involves receiving information, the communication and processing circuitry 2341 may obtain information from a component of the apparatus 2300 (e.g., from the transceiver 2310 that receives the information via radio frequency signaling or some other type of signaling suitable for the applicable communication medium), process (e.g., decode) the information, and output the processed information. For example, the communication and processing circuitry 2341 may output the information to another component of the processor 2304, to the memory 2305, or to the bus interface 2308. In some examples, the communication and processing circuitry 2341 may receive one or more of signals, messages, other information, or any combination thereof. In some examples, the communication and processing circuitry 2341 may receive information via one or more channels. In some examples, the communication and processing circuitry 2341 and/or the transceiver 2310 may include functionality for a means for receiving (e.g., means for receiving an uplink transmission, means for receiving a symbol, etc.). In some examples, the communication and processing circuitry 2341 may include functionality for a means for obtaining. In some examples, the communication and processing circuitry 2341 may include functionality for a means for decoding. In some examples, the communication and processing circuitry 2341 may include functionality for a means for receiving information from a UE.

In some implementations wherein the communication involves sending (e.g., transmitting) information, the communication and processing circuitry 2341 may obtain information (e.g., from another component of the processor 2304, the memory 2305, or the bus interface 2308), process (e.g., encode) the information, and output the processed information. For example, the communication and processing circuitry 2341 may output the information to the transceiver 2310 (e.g., that transmits the information via radio frequency signaling or some other type of signaling suitable for the applicable communication medium). In some examples, the communication and processing circuitry 2341 may send one or more of signals, messages, other information, or any combination thereof. In some examples, the communication and processing circuitry 2341 may send information via one or more channels. In some examples, the communication and processing circuitry 2341 and/or the transceiver 2310 may include functionality for a means for transmitting (e.g., means for transmitting a downlink transmission, means for transmitting a configuration, etc.). In some examples, the communication and processing circuitry 2341 may include functionality for a means for outputting. In some examples, the communication and processing circuitry 2341 may include functionality for a means for encoding. In some examples, the communication and processing circuitry 2341 may include functionality for a means for transmitting information to a UE.

The processor 2304 may include CI processing circuitry 2342 configured to perform CI processing-related operations as discussed herein (e.g., one or more of the operations described above in conjunction with FIGS. 1-20). The CI processing circuitry 2342 may be configured to execute CI processing software 2352 included on the computer-readable medium 2306 to implement one or more functions described herein.

The CI processing circuitry 2342 may include functionality for a means for outputting (e.g., as described above in conjunction with FIGS. 1-20). For example, the CI processing circuitry 2342 may output information to another component of the apparatus 2300. As another example, the CI processing circuitry 2342 may output information to be transmitted to a UE (e.g., via a PDSCH, a PDCCH, etc.).

The CI processing circuitry 2342 may include functionality for a means for generating (e.g., as described above in conjunction with FIGS. 1-20). For example, the CI processing circuitry 2342 may generate a CI (e.g., a DCI) based on an RNTI and/or other information.

The CI processing circuitry 2342 may include functionality for a means for obtaining (e.g., as described above in conjunction with FIGS. 1-20). For example, the CI processing circuitry 2342 may obtain information from another component of the apparatus 2300. As another example, the CI processing circuitry 2342 may obtain a signal or message originating from a UE (e.g., via a PUSCH, a PUCCH, etc.).

The CI processing circuitry 2342 may include functionality for a means for selecting (e.g., as described above in conjunction with FIGS. 1-20). For example, the CI processing circuitry 2342 may select a type of SI to be included in a DCI.

The CI processing circuitry 2342 may include functionality for a means for including (e.g., as described above in conjunction with FIGS. 1-20). For example, the CI processing circuitry 2342 may include a short message in a DCI.

The processor 2304 may include data processing circuitry 2343 configured to perform data processing-related operations as discussed herein (e.g., one or more of the operations described above in conjunction with FIGS. 1-20). The data processing circuitry 2343 may be configured to execute data processing software 2353 included on the computer-readable medium 2306 to implement one or more functions described herein.

The data processing circuitry 2343 may include functionality for a means for outputting (e.g., as described above in conjunction with FIGS. 1-20). For example, the data processing circuitry 2343 may output information to another component of the apparatus 2300. As another example, the data processing circuitry 2343 may output a message (e.g., including data, etc.) for transmission to at least one UE (e.g., via a PDCCH, a PDSCH, etc.) or to at least one network entity.

The data processing circuitry 2343 may include functionality for a means for obtaining (e.g., as described above in conjunction with FIGS. 1-20). For example, the data processing circuitry 2343 may obtain information from another component of the apparatus 2300. As another example, the data processing circuitry 2343 may obtain data originating from a UE (e.g., via a PUSCH).

The data processing circuitry 2343 may include functionality for a means for performing (e.g., as described above in conjunction with FIGS. 1-20). For example, the data processing circuitry 2343 may perform a connected mode procedure independent of the use of a particular format (e.g., a CI format such as a DCI format).

In some examples, the apparatus 2300 shown and described above in connection with FIG. 23 may be a disaggregated base station. For example, the apparatus 2300 shown in FIG. 23 may include the CU and optionally one or more DUs/RUs of the disaggregated base station. Other DUs/RUs associated with the apparatus 2300 may be distributed throughout the network. In some examples, the DUs/RUs may correspond to TRPs associated with the network entity. In some examples, the CU and/or DU/RU of the disaggregated base station (e.g., within the apparatus 2300) may generate information and send the information to a UE.

FIG. 24 is a flow chart illustrating an example method 2400 for wireless communication in accordance with some aspects of the present disclosure. As described below, some or all illustrated features may be omitted in a particular implementation within the scope of the present disclosure, and some illustrated features may not be required for implementation of all examples. In some examples, the method 2400 (e.g., a method for wireless communication) may be carried out by the apparatus 2300 illustrated in FIG. 23, the apparatus 302 illustrated in FIG. 3, or a wireless node (e.g., a network entity). In some examples, the method 2400 may be carried out by any suitable apparatus or means for carrying out the functions or algorithm described below.

At block 2402, a first apparatus may output, for transmission, first control information (CI) formatted according to a first format, the first CI including first scheduling information, the first format being designated for: a first initial access procedure associated with a system information radio network temporary identifier (SI-RNTI), a second initial access procedure associated with a paging radio network temporary identifier (P-RNTI), a third initial access procedure associated with a random access radio network temporary identifier (RA-RNTI), and a fourth initial access procedure associated with a first temporary cell radio network temporary identifier (TC-RNTI). In some examples, the CI processing circuitry 2342 and/or the communication and processing circuitry 2341 and/or the transceiver 2310, shown and described in FIG. 23, may provide a means to output, for transmission, first control information (CI) formatted according to a first format, the first CI including first scheduling information, the first DCI format being designated for: a first initial access procedure associated with a system information radio network temporary identifier (SI-RNTI), a second initial access procedure associated with a paging radio network temporary identifier (P-RNTI), a third initial access procedure associated with a random access radio network temporary identifier (RA-RNTI), and a fourth initial access procedure associated with a first temporary cell radio network temporary identifier (TC-RNTI).

At block 2404, the first apparatus may output, for transmission, first data according to the first scheduling information, or obtain second data according to the first scheduling information. In some examples, the data processing circuitry 2343 and/or the communication and processing circuitry 2341 and/or the transceiver 2310, shown and described in FIG. 23, may provide a means to output, for transmission, first data according to the first scheduling information, or obtain second data according to the first scheduling information.

In some examples, the first CI is a first DCI or a first SCI. In some examples, the first format is a first DCI format or a first SCI format.

In some examples, the first initial access procedure may include a first idle mode procedure or a first inactive mode procedure. In some examples, the second initial access procedure may include a second idle mode procedure or a second inactive mode procedure. In some examples, the third initial access procedure may include a third idle mode procedure or a third inactive mode procedure. In some examples, the fourth initial access procedure may include a fourth idle mode procedure or a fourth inactive mode procedure.

In some examples, the first apparatus may output, for transmission during the first initial access procedure, system information according to the first scheduling information, the first CI further including a first cyclic redundancy check (CRC) encoded (e.g., scrambled) with the SI-RNTI. In some examples, the first apparatus may output, for transmission during the second initial access procedure, paging information according to the first scheduling information, the first CI further including a second CRC encoded (e.g., scrambled) with the P-RNTI. In some examples, the first apparatus may output, for transmission during the third initial access procedure, random access information according to the first scheduling information, the first CI further including a third CRC encoded (e.g., scrambled) with the RA-RNTI. In some examples, the first apparatus may output for transmission or obtain, during the fourth initial access procedure, random access information according to the first scheduling information, the first CI further including a fourth CRC encoded (e.g., scrambled) with the first TC-RNTI.

In some examples, the first CI is downlink control information (DCI) output, for transmission, via a common search space.

In some examples, the first apparatus may output, for transmission, second CI formatted according to a second downlink control information (DCI) format, the second DCI format being designated for a connected mode procedure associated with a cell radio network temporary identifier (C-RNTI). In some examples, the first format is a first DCI associated with a first size. In some examples, the second DCI format is associated with a second size that is larger than the first size.

In some examples, the first apparatus may output, for transmission, second CI formatted according to a second format, the second CI including second scheduling information, the second format being designated for a fifth initial access procedure associated with a second TC-RNTI. In some examples, the first apparatus may output, for transmission, third data according to the second scheduling information.

In some examples, a first size associated with the second format is larger than a second size associated with the first format. In some examples, the fifth initial access procedure is to output, for transmission, a Msg4 of a random access procedure according to the second scheduling information, the second CI further including a first cyclic redundancy check (CRC) encoded (e.g., scrambled) with the second TC-RNTI. In some examples, the fourth initial access procedure is to obtain a retransmission of a Msg3 of a random access procedure according to the first scheduling information, the first CI further including a second CRC encoded (e.g., scrambled) with the first TC-RNTI.

In some examples, the first apparatus may perform connected mode procedures independent of using the second format.

In some examples, the first apparatus may output, for transmission, third CI formatted according to a third format, the third format being designated for a connected mode procedure associated with a cell radio network temporary identifier (C-RNTI). In some examples, the first format is associated with a first size. In some examples, the second format is associated with a second size that is different from the first size. In some examples, the third format is associated with a third size that is larger than each of the first size and the second size.

In some examples, the first apparatus may output, for transmission, the first CI via a first common search space (CSS) according to a first downlink control information (DCI) size. In some examples, the first apparatus may output, for transmission, fallback downlink or uplink CI associated with a cell radio network temporary identifier (C-RNTI) via a second CSS according to a second DCI size. In some examples, the first apparatus may output, for transmission, non-fallback downlink CI associated with the C-RNTI via a user equipment-specific search space (USS) according to a third DCI size. In some examples, the first apparatus may output, for transmission, non-fallback uplink CI associated with the C-RNTI via a third CSS according to the third DCI size. In some examples, the first apparatus may output, for transmission, non-scheduling CI associated with a plurality of other radio network temporary identifiers (RNTIs) via a fourth CSS according to a fourth DCI size.

In some examples, the first apparatus may output, for transmission, downlink control information (DCI) via search spaces according to five DCI sizes. In some examples, a first DCI size of the five DCI sizes is associated with the first format. In some examples, second, third, and fourth DCI sizes of the five DCI sizes are associated with formats with a cyclic redundancy check (CRC) encoded with a cell radio network temporary identifier (C-RNTI). In some examples, a fifth DCI size of the five DCI sizes is associated with formats in at least one common search space (CSS) that is not associated with an initial access procedure.

In some examples, the fifth DCI size is designated for non-scheduling formats in the at least one CSS. In some examples, the fifth DCI size is associated with both fallback scheduling formats with CRC scrambled with C-RNTI in the at least one CSS and non-scheduling formats in the at least one CSS.

In some examples, the first apparatus may output, for transmission, system information (SI) based on a time division resource allocation (TDRA), wherein the TDRA is based on a synchronization signal block location associated with the SI and a time domain location of the first CI. In some examples, the TDRA is based on a single bit in a TDRA field of the first CI.

In some examples, the first scheduling information identifies resources for outputting system information (SI) for transmission. In some examples, the first CI may include downlink control information (DCI) that excludes an SI indicator. In some examples, the first apparatus may select a type of the SI based on a physical downlink shared channel (PDSCH) transmission scheduled by the first scheduling information. In some examples, the first apparatus may select a type of the SI based on a radio network temporary identifier (RNTI) type of the SI-RNTI.

In some examples, the first scheduling information identifies resources for outputting system information (SI) for transmission or outputting a Msg4 of a random access procedure for transmission. In some examples, a joint field of the first CI indicates both a redundancy version (RV) and a code rate. In some examples, the first apparatus may output, for transmission, the SI or the Msg4 based on the indicated RV and code rate.

In some examples, the first scheduling information identifies resources for outputting paging information for transmission. In some examples, the first CI may include a first downlink control information (DCI) that excludes at least one of a short messages indicator field or a short messages field. In some examples, the first apparatus may include the short message in the first DCI according to information in a frequency division resource allocation (FDRA) field included in the first DCI. In some examples, the first apparatus may include the short message in at least one of a time division resource allocation (TDRA) field included in the first DCI, a modulation and coding scheme (MCS) field included in the first DCI, or a virtual resource block to physical resource block (VRB-PRB) mapping field included in the first DCI.

In some examples, the first scheduling information identifies resources for outputting, for transmission, paging information or first random access information. In some examples, the first CI may include a first downlink control information (DCI) that excludes a transport block (TB) scaling field.

In some examples, the first apparatus may output, for transmission, the paging information or the first random access information based on a modulation and coding scheme (MCS) field of the first DCI that specifies a code rate according to a table selected based at least in part on an RNTI associated with the first DCI being a P-RNTI or RA-RNTI.

In some examples, the first scheduling information identifies resources for obtaining a retransmission of an initial random access transmission. In some examples, the first CI may include a first downlink control information (DCI) that excludes a modulation and coding scheme (MCS) field. In some examples, the first apparatus may obtain the retransmission of the initial random access transmission based on a transport block size (TBS) associated with the initial random access transmission.

In some examples, the first apparatus may transmit the first CI and the first data and receive the second data. In some examples, the first apparatus is configured as a network entity.

Referring again to FIG. 23, in one configuration, the apparatus 2300 includes means for outputting, for transmission, first control information (CI) formatted according to a first format, the first CI including first scheduling information, the first format being designated for: a first initial access procedure associated with a system information radio network temporary identifier (SI-RNTI), a second initial access procedure associated with a paging radio network temporary identifier (P-RNTI), a third initial access procedure associated with a random access radio network temporary identifier (RA-RNTI), and a fourth initial access procedure associated with a first temporary cell radio network temporary identifier (TC-RNTI), and means for outputting, for transmission, first data according to the first scheduling information, or obtaining second data according to the first scheduling information. In one aspect, the aforementioned means may be the processor 2304 shown in FIG. 23 configured to perform the functions recited by the aforementioned means (e.g., as discussed above). In another aspect, the aforementioned means may be a circuit or any apparatus configured to perform the functions recited by the aforementioned means.

Of course, in the above examples, the circuitry included in the processor 2304 is merely provided as an example, and other means for carrying out the described functions may be included within various aspects of the present disclosure, including but not limited to the instructions stored in the computer-readable medium 2306, or any other suitable apparatus or means described in any of FIGS. 1, 2, 3, 4, 7, 11, 12, 13, 15, 16, 17, 18, 19, 20, and 23, and utilizing, for example, the methods and/or algorithms described herein in relation to FIG. 24.

The methods shown in FIGS. 22 and 24 may include additional aspects, such as any single aspect or any combination of aspects described below and/or in connection with one or more other processes described elsewhere herein. The following provides an overview of several aspects of the present disclosure.

Aspect 1: A method for communication at a first apparatus (e.g., a method for communication at a wireless node, a user equipment, and so on), the method comprising: obtaining first control information (CI) formatted according to a first format, the first CI including first scheduling information, the first format being designated for: a first initial access procedure associated with a system information radio network temporary identifier (SI-RNTI), a second initial access procedure associated with a paging radio network temporary identifier (P-RNTI), a third initial access procedure associated with a random access radio network temporary identifier (RA-RNTI), and a fourth initial access procedure associated with a first temporary cell radio network temporary identifier (TC-RNTI); and obtaining first data according to the first scheduling information or outputting second data, for transmission, according to the first scheduling information.

Aspect 2: The method of aspect 1, wherein at least one of: the first initial access procedure comprises a first idle mode procedure or a first inactive mode procedure; the second initial access procedure comprises a second idle mode procedure or a second inactive mode procedure; the third initial access procedure comprises a third idle mode procedure or a third inactive mode procedure; or the fourth initial access procedure comprises a fourth idle mode procedure or a fourth inactive mode procedure.

Aspect 3: The method of any of aspects 1 through 2, further comprising at least one of: obtaining, during the first initial access procedure, system information according to the first scheduling information, the first CI further including a first cyclic redundancy check (CRC) encoded with the SI-RNTI; obtaining, during the second initial access procedure, paging information according to the first scheduling information, the first CI further including a second CRC encoded with the P-RNTI; obtaining, during the third initial access procedure, random access information according to the first scheduling information, the first CI further including a third CRC encoded with the RA-RNTI; or obtaining or outputting, during the fourth initial access procedure, random access information according to the first scheduling information, the first CI further including a fourth CRC encoded with the first TC-RNTI.

Aspect 4: The method of any of aspects 1 through 3, wherein the first CI is downlink control information (DCI) obtained via a common search space.

Aspect 5: The method of any of aspects 1 through 4, wherein: the method further comprises obtaining second CI formatted according to a second downlink control information (DCI) format, the second DCI format being designated for a connected mode procedure associated with a cell radio network temporary identifier (C-RNTI); the first format is a first DCI associated with a first size; and the second DCI format is associated with a second size that is larger than the first size.

Aspect 6: The method of any of aspects 1 through 5, further comprising: obtaining second CI formatted according to a second format, the second CI including second scheduling information, the second format being designated for a fifth initial access procedure associated with a second TC-RNTI; and obtaining third data according to the second scheduling information.

Aspect 7: The method of aspect 6, wherein at least one of: a first size associated with the second format is larger than a second size associated with the first format; the fifth initial access procedure is to obtain a Msg4 of a random access procedure according to the second scheduling information, the second CI further including a first cyclic redundancy check (CRC) encoded with the second TC-RNTI; or the fourth initial access procedure is to output a retransmission of a Msg3 of the random access procedure according to the first scheduling information, the first CI further including a second CRC encoded with the first TC-RNTI.

Aspect 8: The method of any of aspects 6 through 7, further comprising: performing connected mode procedures independent of using the second format.

Aspect 9: The method of any of aspects 6 through 8, wherein: the method further comprises obtaining third CI formatted according to a third format, the third format being designated for a connected mode procedure associated with a cell radio network temporary identifier (C-RNTI); the first format is associated with a first size; the second format is associated with a second size that is different from the first size; and the third format is associated with a third size that is larger than each of the first size and the second size.

Aspect 10: The method of any of aspects 1 through 9, further comprising at least one of: obtaining the first CI via a first common search space (CSS) according to a first downlink control information (DCI) size; obtaining fallback downlink or uplink CI associated with a cell radio network temporary identifier (C-RNTI) via a second CSS according to a second DCI size; obtaining non-fallback downlink CI associated with the C-RNTI via a user equipment-specific search space (USS) according to a third DCI size; obtaining non-fallback uplink CI associated with the C-RNTI via a third CSS according to the third DCI size; or obtaining non-scheduling CI associated with a plurality of other radio network temporary identifiers (RNTIs) via a fourth CSS according to a fourth DCI size.

Aspect 11: The method of any of aspects 1 through 10, wherein the method further comprises obtaining downlink control information (DCI) via search spaces according to five DCI sizes, wherein at least one of: a first DCI size of the five DCI sizes is associated with the first format; second, third, and fourth DCI sizes of the five DCI sizes are associated with formats with a cyclic redundancy check (CRC) encoded with a cell radio network temporary identifier (C-RNTI); or a fifth DCI size of the five DCI sizes is associated with formats in at least one common search space (CSS) that is not associated with an initial access procedure.

Aspect 12: The method of aspect 11, wherein at least one of: the fifth DCI size is designated for non-scheduling formats in the at least one CSS; or the fifth DCI size is associated with both fallback scheduling formats with CRC scrambled with C-RNTI in the at least one CSS and the non-scheduling formats in the at least one CSS.

Aspect 13: The method of any of aspects 1 through 12, further comprising obtaining system information (SI) based on a time division resource allocation (TDRA), wherein the TDRA is based on a synchronization signal block location associated with the SI and a time domain location of the first CI.

Aspect 14: The method of aspect 13, wherein the TDRA is based on a single bit in a TDRA field of the first CI.

Aspect 15: The method of any of aspects 1 through 14, wherein: the first scheduling information identifies resources for obtaining system information (SI); and the first CI comprises downlink control information (DCI) that excludes an SI indicator.

Aspect 16: The method of aspect 15, further comprising: identifying a type of the SI based on at least one of: a physical downlink shared channel (PDSCH) transmission scheduled by the first scheduling information; or a radio network temporary identifier (RNTI) type of the SI-RNTI.

Aspect 17: The method of any of aspects 1 through 16, wherein at least one of: the first scheduling information identifies resources for obtaining system information (SI) or obtaining a Msg4 of a random access procedure; a joint field of the first CI indicates both a redundancy version (RV) and a code rate; or the processing system is further configured to obtain the SI or the Msg4 based on the indicated RV and code rate.

Aspect 18: The method of any of aspects 1 through 17, wherein: the first scheduling information identifies resources for obtaining paging information; and the first CI comprises a first downlink control information (DCI) that excludes at least one of: a short messages indicator field or a short messages field.

Aspect 19: The method of aspect 18, further comprising: extracting a short message from the first DCI based on information in a frequency division resource allocation (FDRA) field included in the first DCI, the short message being extracted from at least one of: a time division resource allocation (TDRA) field included in the first DCI, a modulation and coding scheme (MCS) field included in the first DCI, or a virtual resource block to physical resource block (VRB-PRB) mapping field included in the first DCI.

Aspect 20: The method of any of aspects 1 through 19, wherein: the first scheduling information identifies resources for obtaining paging information or first random access information; and the first CI comprises a first downlink control information (DCI) that excludes a transport block (TB) scaling field.

Aspect 21: The method of aspect 20, further comprising: decoding the paging information or the first random access information based on a modulation and coding scheme (MCS) field of the first DCI that specifies a code rate according to a table selected based at least in part on an RNTI associated with the first DCI being a P-RNTI or RA-RNTI.

Aspect 22: The method of any of aspects 1 through 21, wherein: the first scheduling information identifies resources for outputting a retransmission of an initial random access transmission; and the first CI comprises a first downlink control information (DCI) that excludes a modulation and coding scheme (MCS) field.

Aspect 23: The method of aspect 22, further comprising: outputting the retransmission of the initial random access transmission based on a transport block size (TBS) associated with the initial random access transmission.

Aspect 24: The method of any of aspects 1 through 23, further comprising: receiving the first CI, and receiving the first data or transmitting the second data, wherein the first apparatus is configured as user equipment (UE).

Aspect 25: A method for communication at a first apparatus (e.g., a method for communication at a wireless node, a network entity, and so on), the method comprising: outputting, for transmission, first control information (CI) formatted according to a first format, the first CI including first scheduling information, the first format being designated for: a first initial access procedure associated with a system information radio network temporary identifier (SI-RNTI), a second initial access procedure associated with a paging radio network temporary identifier (P-RNTI), a third initial access procedure associated with a random access radio network temporary identifier (RA-RNTI), and a fourth initial access procedure associated with a first temporary cell radio network temporary identifier (TC-RNTI); and outputting, for transmission, first data according to the first scheduling information, or obtaining second data according to the first scheduling information.

Aspect 26: The method of aspect 25, further comprising at least one of: outputting, for transmission during the first initial access procedure, system information according to the first scheduling information, the first CI further including first cyclic redundancy check (CRC) encoded with the SI-RNTI; outputting, for transmission during the second initial access procedure, paging information according to the first scheduling information, the first CI further including second CRC encoded with the P-RNTI; outputting, for transmission during the third initial access procedure, random access information according to the first scheduling information, the first CI further including third CRC encoded with the RA-RNTI; or outputting for transmission or obtaining, during the fourth initial access procedure, random access information according to the first scheduling information, the first CI further including fourth CRC encoded with the first TC-RNTI.

Aspect 27: The method of any of aspects 25 through 26, wherein: the method further comprises outputting, for transmission, second CI formatted according to a second format, the second format being designated for a connected mode procedure associated with a cell radio network temporary identifier (C-RNTI); the first format is associated with a first size; and the second format is associated with a second size that is larger than the first size.

Aspect 28: The method of any of aspects 25 through 27, further comprising: outputting, for transmission, second CI formatted according to a second format, the second CI including second scheduling information, the second format being designated for a fifth initial access procedure associated with a second TC-RNTI; and outputting, for transmission, third data according to the second scheduling information.

Aspect 29: The method of aspect 28, wherein at least one of: a first size associated with the second format is larger than a second size associated with the first format; the fifth initial access procedure is to output, for transmission, a Msg4 of a random access procedure according to the second scheduling information, the second CI further including a first cyclic redundancy check (CRC) encoded with the second TC-RNTI; or the fourth initial access procedure is to obtain a retransmission of a Msg3 of the random access procedure according to the first scheduling information, the first CI further including a second CRC encoded with the first TC-RNTI.

Aspect 30: The method of any of aspects 28 through 29, further comprising: performing connected mode procedures independent of using the second format.

Aspect 31: The method of any of aspects 28 and 30, wherein: the method further comprises outputting, for transmission, third CI formatted according to a third format, the third format being designated for a connected mode procedure associated with a cell radio network temporary identifier (C-RNTI); the first format is associated with a first size; the second format is associated with a second size that is different from the first size; and the third format is associated with a third size that is larger than each of the first size and the second size.

Aspect 32: The method of any of aspects 25 through 31, wherein at least one of: the first initial access procedure comprises a first idle mode procedure or a first inactive mode procedure; the second initial access procedure comprises a second idle mode procedure or a second inactive mode procedure; the third initial access procedure comprises a third idle mode procedure or a third inactive mode procedure; or the fourth initial access procedure comprises a fourth idle mode procedure or a fourth inactive mode procedure.

Aspect 33: The method of any of aspects 25 through 32, wherein the first CI is downlink control information (DCI) output, for transmission, via a common search space.

Aspect 34: The method of any of aspects 25 through 32, further comprising at least one of: outputting, for transmission, the first CI via a first common search space (CSS) according to a first downlink control information (DCI) size; outputting, for transmission, fallback downlink or uplink CI associated with a cell radio network temporary identifier (C-RNTI) via a second CSS according to a second DCI size; outputting, for transmission, non-fallback downlink CI associated with the C-RNTI via a user equipment-specific search space (USS) according to a third DCI size; outputting, for transmission, non-fallback uplink CI associated with the C-RNTI via a third CSS according to the third DCI size; or outputting, for transmission, non-scheduling CI associated with a plurality of other radio network temporary identifiers (RNTIs) via a fourth CSS according to a fourth DCI size.

Aspect 35: The method of any of aspects 25 through 33, further comprising outputting, for transmission, downlink control information (DCI) via search spaces according to five DCI sizes, wherein at least one of: a first DCI size of the five DCI sizes is associated with the first format; second, third, and fourth DCI sizes of the five DCI sizes are associated with formats with a cyclic redundancy check (CRC) encoded with a cell radio network temporary identifier (C-RNTI); or a fifth DCI size of the five DCI sizes is associated with formats in at least one common search space (CSS) that is not associated with an initial access procedure.

Aspect 36: The method of aspect 35, wherein at least one of: the fifth DCI size is designated for non-scheduling formats in the at least one CSS; or the fifth DCI size is associated with both fallback scheduling formats with CRC scrambled with C-RNTI in the at least one CSS and the non-scheduling formats in the at least one CSS.

Aspect 37: The method of any of aspects 25 through 36, further comprising: outputting, for transmission, system information (SI) based on a time division resource allocation (TDRA), wherein the TDRA is based on a synchronization signal block location associated with the SI and a time domain location of the first CI.

Aspect 38: The method of aspect 37, wherein the TDRA is based on a single bit in a TDRA field of the first CI.

Aspect 39: The method of any of aspects 25 through 38, wherein: the first scheduling information identifies resources for outputting system information (SI) for transmission; and the first CI comprises downlink control information (DCI) that excludes an SI indicator.

Aspect 40: The method of aspect 39, further comprising selecting a type of the SI based on at least one of: a physical downlink shared channel (PDSCH) transmission scheduled by the first scheduling information; or a radio network temporary identifier (RNTI) type of the SI-RNTI.

Aspect 41: The method of any of aspects 25 through 40, wherein at least one of: the first scheduling information identifies resources for outputting system information (SI) for transmission or outputting a Msg4 of a random access procedure for transmission; a joint field of the first CI indicates both a redundancy version (RV) and a code rate; or the method further comprises outputting, for transmission, the SI or the Msg4 based on the indicated RV and code rate.

Aspect 42: The method of any of aspects 25 through 41, wherein: the first scheduling information identifies resources for outputting paging information for transmission; and the first CI comprises a first downlink control information (DCI) that excludes at least one of: a short messages indicator field or a short messages field.

Aspect 43: The method of aspect 42, further comprising: including the short message in the first DCI according to information in a frequency division resource allocation (FDRA) field included in the first DCI, the short message being included in at least one of: a time division resource allocation (TDRA) field included in the first DCI, a modulation and coding scheme (MCS) field included in the first DCI, or a virtual resource block to physical resource block (VRB-PRB) mapping field included in the first DCI.

Aspect 44: The method of any of aspects 25 through 43, wherein: the first scheduling information identifies resources for outputting, for transmission, paging information or first random access information; and the first CI comprises a first downlink control information (DCI) that excludes a transport block (TB) scaling field.

Aspect 45: The method of aspect 44, further comprising: outputting the paging information or the first random access information according to a modulation and coding scheme (MCS) field of the first DCI that specifies a code rate according to a table selected based at least in part on an RNTI associated with the first DCI being a P-RNTI or RA-RNTI.

Aspect 46: The method of any of aspects 25 through 45, wherein: the first scheduling information identifies resources for obtaining a retransmission of an initial random access transmission; and the first CI comprises a first downlink control information (DCI) that excludes a modulation and coding scheme (MCS) field.

Aspect 47: The method of aspect 46, further comprising: obtain the retransmission of the initial random access transmission according to a transport block size (TBS) associated with the initial random access transmission.

Aspect 48: The method of any of aspects 25 through 47, further comprising: transmitting the first CI, and transmitting the first data or receiving the second data, wherein the first apparatus is configured as a network entity.

Aspect 49: A wireless node, comprising: one or more transceivers; one or more memories that store processor-executable code; and one or more processors configured to execute the processor-executable code and cause the wireless node to perform a method in accordance with any one or more of aspects 1 through 23, wherein the one or more transceivers are configured to transmit the first CI, receive the first data, and transmit the second data.

Aspect 50: A first apparatus configured for communication comprising at least one means for performing any one or more of aspects 1 through 24.

Aspect 51: A non-transitory computer-readable medium storing computer-executable code, comprising code for causing a first apparatus to perform any one or more of aspects 1 through 24.

Aspect 52: A first apparatus, comprising: one or more memories that store processor-executable code; and one or more processors configured to execute the processor-executable code and cause the first apparatus to perform a method in accordance with any one or more of aspects 1 through 23.

Aspect 53: A wireless node, comprising: one or more transceivers; one or more memories that store processor-executable code; and one or more processors configured to execute the processor-executable code and cause the wireless node to perform a method in accordance with any one or more of aspects 25 through 47, wherein the one or more transceivers are configured to transmit the first CI, receive the first data, and transmit the second data.

Aspect 54: A first apparatus configured for communication comprising at least one means for performing any one or more of aspects 25 through 48.

Aspect 55: A non-transitory computer-readable medium storing computer-executable code, comprising code for causing a first apparatus to perform any one or more of aspects 25 through 48.

Aspect 56: A first apparatus, comprising: one or more memories that store processor-executable code; and one or more processors configured to execute the processor-executable code and cause the first apparatus to perform a method in accordance with any one or more of aspects 25 through 47.

Several aspects of a wireless communication network have been presented with reference to an example implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing Institute of Electrical and Electronics Engineers (IEEE) 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure. As used herein, the term “determining” may include, for example, ascertaining, resolving, selecting, choosing, establishing, calculating, computing, processing, deriving, investigating, looking up (e.g., looking up in a table, a database or another data structure), and the like. Also, “determining” may include receiving (e.g., receiving information), accessing (e.g., accessing data in a memory), and the like.

One or more of the components, steps, features and/or functions illustrated in FIGS. 1-24 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1, 2, 4, 7, 11, 12, 13, 15, 16, 17, 18, 19, 20, 21, and 23 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of example processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b, and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A first apparatus for communication, comprising:
a processing system configured to:
obtain first control information (CI) formatted according to a first format, the first CI including first scheduling information, the first format being designated for:
a first initial access procedure associated with a system information radio network temporary identifier (SI-RNTI),
a second initial access procedure associated with a paging radio network temporary identifier (P-RNTI),
a third initial access procedure associated with a random access radio network temporary identifier (RA-RNTI), and
a fourth initial access procedure associated with a first temporary cell radio network temporary identifier (TC-RNTI); and
obtain first data according to the first scheduling information or output second data, for transmission, according to the first scheduling information.

2. The first apparatus of claim 1, wherein at least one of:
the first initial access procedure comprises a first idle mode procedure or a first inactive mode procedure;
the second initial access procedure comprises a second idle mode procedure or a second inactive mode procedure;
the third initial access procedure comprises a third idle mode procedure or a third inactive mode procedure; or
the fourth initial access procedure comprises a fourth idle mode procedure or a fourth inactive mode procedure.

3. The first apparatus of claim 1, wherein the processing system is further configured to at least one of:
obtain, during the first initial access procedure, system information according to the first scheduling information, the first CI further including a first cyclic redundancy check (CRC) encoded with the SI-RNTI;
obtain, during the second initial access procedure, paging information according to the first scheduling information, the first CI further including a second CRC encoded with the P-RNTI;
obtain, during the third initial access procedure, random access information according to the first scheduling information, the first CI further including a third CRC encoded with the RA-RNTI; or
output for transmission or obtain, during the fourth initial access procedure, random access information according to the first scheduling information, the first CI further including a fourth CRC encoded with the first TC-RNTI.

4. The first apparatus of claim 1, wherein the first CI is downlink control information (DCI) obtained via a common search space.

5. The first apparatus of claim 1, wherein:
the processing system is further configured to obtain second CI formatted according to a second downlink control information (DCI) format, the second DCI format being designated for a connected mode procedure associated with a cell radio network temporary identifier (C-RNTI);
the first format is a first DCI associated with a first size; and
the second DCI format is associated with a second size that is larger than the first size.

6. The first apparatus of claim 1, wherein the processing system is further configured to:
obtain second CI formatted according to a second format, the second CI including second scheduling information, the second format being designated for a fifth initial access procedure associated with a second TC-RNTI; and
obtain third data according to the second scheduling information.

7. The first apparatus of claim 6, wherein at least one of:
a first size associated with the second format is larger than a second size associated with the first format;
the fifth initial access procedure is to obtain a Msg4 of a random access procedure according to the second scheduling information, the second CI further including a first cyclic redundancy check (CRC) encoded with the second TC-RNTI; or
the fourth initial access procedure is to output a retransmission of a Msg3 of the random access procedure according to the first scheduling information, the first CI further including a second CRC encoded with the first TC-RNTI.

8. The first apparatus of claim 6, wherein the processing system is further configured to:
perform connected mode procedures independent of using the second format.

9. The first apparatus of claim 6, wherein:
the processing system is further configured to obtain third CI formatted according to a third format, the third format being designated for a connected mode procedure associated with a cell radio network temporary identifier (C-RNTI);
the first format is associated with a first size;
the second format is associated with a second size that is different from the first size; and
the third format is associated with a third size that is larger than each of the first size and the second size.

10. The first apparatus of claim 1, wherein the processing system is further configured to at least one of:
obtain the first CI via a first common search space (CSS) according to a first downlink control information (DCI) size;
obtain fallback downlink or uplink CI associated with a cell radio network temporary identifier (C-RNTI) via a second CSS according to a second DCI size;
obtain non-fallback downlink CI associated with the C-RNTI via a user equipment-specific search space (USS) according to a third DCI size;
obtain non-fallback uplink CI associated with the C-RNTI via a third CSS according to the third DCI size; or
obtain non-scheduling CI associated with a plurality of other radio network temporary identifiers (RNTIs) via a fourth CSS according to a fourth DCI size.

11. The first apparatus of claim 1, wherein the processing system is further configured to obtain downlink control information (DCI) via search spaces according to five DCI sizes, wherein at least one of:
a first DCI size of the five DCI sizes is associated with the first format;
second, third, and fourth DCI sizes of the five DCI sizes are associated with formats with a cyclic redundancy check (CRC) encoded with a cell radio network temporary identifier (C-RNTI); or
a fifth DCI size of the five DCI sizes is associated with formats in at least one common search space (CSS) that is not associated with an initial access procedure.

12. The first apparatus of claim 11, wherein at least one of:
the fifth DCI size is designated for non-scheduling formats in the at least one CSS; or
the fifth DCI size is associated with both fallback scheduling formats with CRC scrambled with C-RNTI in the at least one CSS and the non-scheduling formats in the at least one CSS.

13. The first apparatus of claim 1, wherein the processing system is further configured to:
obtain system information (SI) based on a time division resource allocation (TDRA), wherein the TDRA is based on a synchronization signal block location associated with the SI and a time domain location of the first CI.

14. The first apparatus of claim 13, wherein the TDRA is based on a single bit in a TDRA field of the first CI.

15. The first apparatus of claim 1, wherein:
the first scheduling information identifies resources for obtaining system information (SI); and
the first CI comprises downlink control information (DCI) that excludes an SI indicator.

16. The first apparatus of claim 15, wherein the processing system is further configured to identify a type of the SI based on at least one of:
a physical downlink shared channel (PDSCH) transmission scheduled by the first scheduling information; or
a radio network temporary identifier (RNTI) type of the SI-RNTI.

17. The first apparatus of claim 1, wherein at least one of:
the first scheduling information identifies resources for obtaining system information (SI) or obtaining a Msg4 of a random access procedure;
a joint field of the first CI indicates both a redundancy version (RV) and a code rate; or
the processing system is further configured to obtain the SI or the Msg4 based on the indicated RV and code rate.

18. The first apparatus of claim 1, wherein:
the first scheduling information identifies resources for obtaining paging information; and
the first CI comprises a first downlink control information (DCI) that excludes at least one of: a short messages indicator field or a short messages field.

19. The first apparatus of claim 18, wherein the processing system is further configured to:
extract a short message from the first DCI based on information in a frequency division resource allocation (FDRA) field included in the first DCI, the short message being extracted from at least one of: a time division resource allocation (TDRA) field included in the first DCI, a modulation and coding scheme (MCS) field included in the first DCI, or a virtual resource block to physical resource block (VRB-PRB) mapping field included in the first DCI.

20. The first apparatus of claim 1, wherein:
the first scheduling information identifies resources for obtaining paging information or first random access information; and
the first CI comprises a first downlink control information (DCI) that excludes a transport block (TB) scaling field.

21. The first apparatus of claim 20, wherein the processing system is further configured to:
decode the paging information or the first random access information based on a modulation and coding scheme (MCS) field of the first DCI that specifies a code rate according to a table selected based at least in part on an RNTI associated with the first DCI being a P-RNTI or RA-RNTI.

22. The first apparatus of claim 1, wherein:
the first scheduling information identifies resources for outputting a retransmission of an initial random access transmission; and
the first CI comprises a first downlink control information (DCI) that excludes a modulation and coding scheme (MCS) field.

23. The first apparatus of claim 22, wherein the processing system is further configured to:
output the retransmission of the initial random access transmission based on a transport block size (TBS) associated with the initial random access transmission.

24. The first apparatus of claim 1, further comprising:
a transceiver configured to receive the first CI and the first data and to transmit the second data,
wherein the first apparatus is configured as a user equipment (UE).

25. A method for communication at a wireless node, the method comprising:
obtaining first control information (CI) formatted according to a first format, the first CI including first scheduling information, the first format being designated for:
a first initial access procedure associated with a system information radio network temporary identifier (SI-RNTI),
a second initial access procedure associated with a paging radio network temporary identifier (P-RNTI),
a third initial access procedure associated with a random access radio network temporary identifier (RA-RNTI), and
a fourth initial access procedure associated with a first temporary cell radio network temporary identifier (TC-RNTI); and
obtaining first data according to the first scheduling information or outputting second data, for transmission, according to the first scheduling information.

26. A first apparatus for communication, comprising:
a processing system configured to:
output, for transmission, first control information (CI) formatted according to a first format, the first CI including first scheduling information, the first format being designated for:
a first initial access procedure associated with a system information radio network temporary identifier (SI-RNTI),
a second initial access procedure associated with a paging radio network temporary identifier (P-RNTI),
a third initial access procedure associated with a random access radio network temporary identifier (RA-RNTI), and
a fourth initial access procedure associated with a first temporary cell radio network temporary identifier (TC-RNTI); and
output, for transmission, first data according to the first scheduling information, or obtain second data according to the first scheduling information.

27. The first apparatus of claim 26, wherein the processing system is further configured to at least one of:
output, for transmission during the first initial access procedure, system information according to the first scheduling information, the first CI further including first cyclic redundancy check (CRC) encoded with the SI-RNTI;
output, for transmission during the second initial access procedure, paging information according to the first scheduling information, the first CI further including second CRC encoded with the P-RNTI;
output, for transmission during the third initial access procedure, random access information according to the first scheduling information, the first CI further including third CRC encoded with the RA-RNTI; or
output for transmission or obtain, during the fourth initial access procedure, random access information according to the first scheduling information, the first CI further including fourth CRC encoded with the first TC-RNTI.

28. The first apparatus of claim 26, wherein:
the processing system is further configured to output, for transmission, second CI formatted according to a second format, the second format being designated for a connected mode procedure associated with a cell radio network temporary identifier (C-RNTI);
the first format is associated with a first size; and
the second format is associated with a second size that is larger than the first size.

29. The first apparatus of claim 26, wherein the processing system is further configured to:
output, for transmission, second CI formatted according to a second format, the second CI including second scheduling information, the second format being designated for a fifth initial access procedure associated with a second TC-RNTI; and
output, for transmission, third data according to the second scheduling information.

30. The first apparatus of claim 26, further comprising:
a transceiver configured to transmit the first CI and the first data and receive the second data,
wherein the first apparatus is configured as a network entity.
